(19) United States
(12) Patent Application Publication
(10) Pub. No.: US 2012/0256951 A1
(43) Pub. Date: Oct. 11, 2012

(54) IMAGE DATA TRANSMISSION DEVICE, IMAGE DATA TRANSMISSION METHOD, IMAGE DATA RECEPTION DEVICE, AND IMAGE DATA RECEPTION METHOD

(75) Inventor: Ikuo Tsukagoshi, Tokyo (JP)

(73) Assignee: Sony Corporation, Tokyo (JP)

(21) Appl. No.: 13/517,174

(22) PCT Filed: Oct. 27, 2011
(86) PCT No.: PCT/JP2011/006010

§ 371 Date: Jun. 19, 2012

(30) Foreign Application Priority Data
Nov. 10, 2010 (JP) 2010-252322
Dec. 28, 2010 (JP) 2010-293675

(51) Int. Cl. G09G 5/00

(52) U.S. Cl. 345/629

(57) ABSTRACT

To reduce, at the time of transmitting disparity information sequentially updated within a period during which superimposing information is displayed, the data amount of the disparity information. A segment including disparity information sequentially updated during a subtitle display period is transmitted. At the reception side, disparity to be provided between a left eye subtitle and right eye subtitle can be dynamically changed in conjunction with change in the contents of the image. This disparity information is updated based on a disparity information value of a first frame, and a disparity information value at a predetermined timing where an interval period has been multiplied by a multiple value. The amount of transmitted data can be reduced, and also at the reception side, the amount of memory for holding the disparity information can be greatly conserved.

### TECHNICAL FIELD

The present invention relates to an image data transmission device, an image data transmission method, an image data reception device, and an image data reception method, and more particularly relates to an image data transmission device and the like-transmitting superimposed information data such as captions, along with left eye image data and right eye image data.

### BACKGROUND ART

For example, proposed in PTL 1 is a transmission method of stereoscopic image data using television broadcast airwaves. With this transmission method, stereoscopic image data having image data for the left eye and image data for the right eye is transmitted, and stereoscopic image display using binocular disparity is performed.

FIG. 95 illustrates relationship between the display positions of left and right images of an object on a screen, and the playback position of the stereoscopic image thereof. For example, with regard to an object A displayed with a left image La being shifted to the right side and a right image Ra being shifted to the left side on the screen as illustrated in the drawing, the left and right visual lines intersect in front of the screen surface, so the playback position of the stereoscopic image thereof is in front of the screen surface. DPa represents a disparity vector in the horizontal direction relating to the object A.

Also, for example, as illustrated on the screen, with regard to an object B where a left image Lb and a right image Rb are displayed on the same position, the left and right visual lines intersect on the screen surface, so the playback position of the stereoscopic image thereof is on the screen surface. Further, for example, with regard to an object C with a left image Lc being shifted to the left side and a right image Ra being shifted to the right side on the screen as illustrated in the drawing, the left and right visual lines intersect in the back from the screen surface, so the playback position of the stereoscopic image is in the back from the screen surface. DPc represents a disparity vector in the horizontal direction relating to the object C.

### CITATION LIST

### Patent Literature

PTL 1: Japanese Unexamined Patent Application Publication No. 2005-6114

### SUMMARY OF INVENTION

### Technical Problem

With the stereoscopic image display such as described above, the viewer will normally sense perspective of the stereoscopic image taking advantage of binocular disparity. It is anticipated that superimposed information superimposed on the image, such as captions and the like for example, will be rendered not only in two-dimensional space but further in conjunction with the stereoscopic image display with a three-dimensional sense of depth. For example, in the event of performing superimposed display (overlay display) of captions on an image, the viewer may sense inconsistency in perspective unless the display is made closer to the viewer than the closest object (object) within the image in terms of perspective.

Accordingly, it can be conceived to transmit disparity information between the left eye image and right eye image along with the data of the superimposed information, and to apply the disparity between the left eye image and right eye image at the reception side. At this time, in order to allow disparity to be applied between the left eye image and right eye image to be changed in a dynamic manner in accordance with change in the superimposed image, there is the need to send disparity which is sequentially updated within a period of a predetermined number of frames in which the superimposed information is to be displayed.

It is an object of this invention to reduce, at the time of transmitting disparity information sequentially updated within a period of a predetermined number of frames during which superimposing information is displayed, the data amount of the disparity-information.

### Solution to Problem

A concept of this invention is an image data transmission device including:

an image data output unit configured to output left eye image data and right eye image data;

a superimposing information data output unit configured to output data of superimposing information to be superimposed on the left eye image data and the right eye image data;

a disparity information output unit configured to output disparity information to be added to the superimposing information; and

a data transmission unit configured to transmit the left eye image data, the right eye image data, the superimposing information data, and the disparity information;

the image data transmission device further including a disparity information updating unit configured to update the disparity information, based on a disparity information initial value of a first frame where the superimposing information is displayed, and a disparity information value at a predetermined timing where an interval period has been multiplied by a multiple value.

With this invention, left eye image data and right eye image data are output from the image data output unit. Transmission formats for the left eye image data and right eye image data includes a side by side (Side by Side) format, top and bottom (Top & Bottom) format, and so forth.

Superimposing information data to be superimposed on the left eye image data and right eye image data is output from the superimposing information data output unit. Now, superimposing information is information such as caption, graphics, text, and so forth, to be superimposed on an image. The superimposing information data output unit outputs disparity information to be added to the superimposing information. For example, this disparity information is disparity information corresponding to particular superimposing information displayed in the same screen, and/or disparity information corresponding in common to a plurality of superimposing information displayed in the same screen. Also, for example, the disparity information may have sub-pixel precision. Also, for example, the image data transmission device may include multiple regions spatially independent.

The disparity information output unit outputs the left eye image data, right eye image data, superimposing image data, and disparity information. Subsequently, the disparity information updating unit updates the disparity information, based on a disparity information initial value of a first frame where the superimposing information is displayed, and a disparity information value at a predetermined timing where an interval period has been multiplied by a multiple value. In this case, the disparity information added to the superimposing information during the display period of the superimposing information is transmitted before this display period starts. This enables disparity to be added to superimposing information which is suitable in accordance with the display period thereof.

For example, the data of the superimposing information is DVD format subtitle data, and at the data transmission unit, the disparity information is transmitted included in a subtitle data stream in which the subtitle data is included. For example, disparity information is disparity information in increments of a region or increments of a subregion included in the region. Also, for example, the disparity information is disparity information in increments of a page including all regions.

Also, for example, the data of the superimposing information is ARIB format caption data, and at the data transmission unit, the disparity information is transmitted included in a caption data stream in which the caption data is included. Also, for example, the data of the superimposing information is CEA format closed caption data, and at the data transmission unit, the disparity information is transmitted included in a user data area of a video data stream in which the closed caption data is included.

In this way, with this information, disparity information to be added to the superimposing information is transmitted along with the left eye image data, right eye image data, and superimposing information data. This disparity information is updated based on a disparity information initial value of a first frame where the superimposing information is displayed, and a disparity information value at a predetermined timing where an interval period has been multiplied by a multiple value. This enables disparity to be applied between the left eye superimposing information and right eye superimposing information to be dynamically changed in conjunction with changes in the contents of the stereoscopic image. In this case, not all disparity information of each frame is transmitted, so the amount of data of the disparity information can be reduced.

Note that with this invention, there may be provided an adjusting unit to change the predetermined timing where an interval period has been multiplied by a multiple value, for example. Thus, the predetermined timing can be optionally adjusted in the direction of being shorter or in the direction of being longer, and the receiving side can be accurately notified of change in the temporal direction of the disparity information.

Also, with this invention, disparity information may have added thereto information of unit periods for calculating the predetermined timing where an interval period has been multiplied by a multiple value, and information of the number of the unit periods. The predetermined timing spacings can be set to spacings in accordance with a disparity information curve, rather than being fixed. Also, the predetermined timing spacings can be easily obtained at the receiving side by calculating “increment period*number”.

For example, the information of these increment periods is information in which a value obtained by measuring the increment period with a 90 KHz clock is expressed in 24-bit length. The reason why a PTS inserted in a PES header portion is 33 bits long but this is 24 bits long is as follows. That is to say, time exceeding 24 hours worth can be expressed with a 33-bit length, but this is an unnecessary length for a display period of superimposing information such as caption. Also, using 24 bits makes the data size smaller, enabling compact transmission. Further, 24 bits is 8*3 bits, facilitating byte alignment. Also, the information of increment periods may be information expressing the increment periods with the frame count number, for example.

Also, with this invention, the disparity information may have added thereto flag information indicating whether or not there is updating of said disparity information, with regard to each frame corresponding to the predetermined timing where an interval period has been multiplied by a multiple value. In this case, in the event a period will continue where change of the disparity information in the temporal direction is the same, transmission of disparity information within this period can be omitted by using this flag information, and the amount of data of the disparity information can be suppressed.

Also, with this invention, for example, the disparity information may have inserted therein information for specifying frame cycle. Accordingly, updating frame spacings which the transmission side intends can be correctly communicated to the reception side. In the event that this information is not added, a video frame cycle, for example, is referenced.

Also, with this invention, for example, the disparity information may have added thereto information indicating a level of correspondence as to the disparity information, which is essential at the time of displaying the superimposing information. In this case, this information enables control corresponding to the disparity information at the reception side.

Another concept of this invention is an image data reception device including:

a data reception unit configured to receive left eye image data and right eye image data, superimposing information data to be superimposed on the left eye image data and the right eye image data, and disparity information to be added to the superimposing information,

the disparity information being updated based on a disparity information initial value of a first frame where the superimposing information is displayed, and a disparity information value at a predetermined timing where an interval period has been multiplied by a multiple value; and further including

an image data processing unit configured to obtain left eye image data upon which the superimposing information has been superimposed and right eye image data upon which the superimposing information has been superimposed, based on the left eye image data, the right eye image data, the superimposing information data, and the disparity information.

With this invention, left eye image data and right eye image data, superimposing information data to be superimposed on the left eye image data and the right eye image data, and disparity information to be added to the superimposing information, are received. Here, superimposing information is information such as caption, graphics, text, and so forth, to be superimposed on an image. This disparity information is updated based on a disparity information initial value of a first frame where the superimposing information is displayed, and a disparity information value at a predetermined timing where an interval period has been multiplied by a multiple value.

The image data processing unit then obtains left eye image data upon which the superimposing information has been superimposed and right eye image data upon which the superimposing information has been superimposed, based on the left eye image data, right eye image data, superimposing information data, and disparity information.

In this way, with this invention, disparity information to be added to the superimposing information is transmitted along with the left eye image data, right eye image data, and superimposing information data. This disparity information is updated based on a disparity information initial value of a first frame where the superimposing information is displayed, and a disparity information value at a predetermined timing where an interval period has been multiplied by a multiple value. Accordingly, the disparity to be added between the left eye superimposing information and right eye superimposing information can be dynamically changed in accordance with change in the stereoscopic image. Also, not all disparity information of each frame is transmitted, so the amount of memory for holding the disparity information can be greatly conserved.

Note that with this invention, for example, the image data processing unit may subject disparity information to interpolation processing, and generate and use disparity information of an arbitrary frame spacing. In this case, even in the event of disparity information being transmitted from the transmission side every predetermined timing, the disparity provided to the superimposing information can be controlled with fine spacings, e.g., every frame.

In this case, the interpolation processing may be linear interpolation, or may involve low-band filter processing in the temporal direction (frame direction). Accordingly, even in the event of disparity information being transmitted from the transmission side at each predetermined timing, change of the disparity information following interpolation processing in the temporal direction can be made smooth, and an unnatural sensation of the transition of disparity applied to the superimposing information becoming discontinuous at each predetermined timing can be suppressed.

Also, with this invention, the disparity information may have added thereto, for example, information of increment periods to calculate a predetermined timing where an interval period has been multiplied by a multiple value, and the number of the increment periods, with the image data processing unit obtaining the predetermined timing based on the information of increment periods and information of the number, with a display start point-in-time of the superimposing information as a reference.

In this case, the image data processing unit can sequentially obtain predetermined timings from the display starting point-in-time of the superimposing information. For example, from a certain predetermined timing, the next predetermined timing can be easily obtained by adding the time of increment period*number to the certain predetermined timing-time, using information of the increment period which is information of the next predetermined timing, and information of the number. Note that the display start point-in-time of the superimposing information is provided as a PTS inserted in a header portion of a PES stream including the disparity information.

### Advantageous Effects of Invention

According to this invention, at the transmission side, not all disparity information of each frame is transmitted, so the transmission data amount can be reduced, and at the reception side, the amount of memory for holding the disparity information can be greatly conserved.

### BRIEF DESCRIPTION OF DRAWINGS

FIG. 1 is a block diagram illustrating a configuration example of an image transmission/reception system as an embodiment of the present invention.

FIG. 2 is a block diagram illustrating a configuration example of a transmission data generating unit at a broadcasting station.

FIG. 3 is a diagram illustrating image data of a 1920*1080 pixel format.

FIG. 4 is a diagram for describing a “Top & Bottom” format, a “Side by Side” format, and a “Frame Sequential” format, which are transmission formats of stereoscopic image data (3D image data).

FIG. 5 is a diagram for describing an example of detecting disparity vectors in a right eye image as to a left eye image.

FIG. 6 is a diagram for describing obtaining disparity vectors by block matching.

FIG. 7 is a diagram illustrating an example of an image in a case of using values of disparity vectors for each pixel (pixel) as luminance values of each pixel (each pixel).

FIG. 8 is a diagram illustrating an example of disparity vectors for each block (Block).

FIG. 9 is a diagram for describing downsizing processing performed at a disparity information creating unit of the transmission data generating unit.

FIG. 10 is a diagram illustrating a configuration example of a transport stream (bit stream data) including a video elementary stream, subtitle elementary stream, and audio elementary stream.

FIG. 11 is a diagram illustrating the structure of a PCS (page_composition_segment) configuring subtitle data.

FIG. 12 is a diagram illustrating the correlation between the values of “segment_type” and segment types.

FIG. 13 is a diagram for describing information indicating the format of a newly-defined subtitle for 3D (Component_type=0x15, 0x25).

FIG. 14 is a diagram conceptually illustrating a method for creating subtitle data for stereoscopic images in a case that the stereoscopic image data transmission format is the side by side format.

FIG. 15 is a diagram conceptually illustrating a method for creating subtitle data for stereoscopic images in a case that the stereoscopic image data transmission format is the top & bottom format.

FIG. 16 is a diagram conceptually illustrating a method for creating subtitle data for stereoscopic images in a case that the stereoscopic image data transmission format is the frame sequential format.

FIG. 17 is a diagram illustrating a structure example (syntax) of an SCS (Subregion composition segment)

FIG. 18 is a diagram illustrating a structure example (syntax) of “Subregion_payload( )” included in an SCS.

FIG. 19 is a diagram illustrating principal data stipulations (semantics) of an SCS.

FIG. 20 is a diagram illustrating an example of updating disparity information for each base segment period (BSP).

FIG. 21 is a diagram illustrating a structure example (syntax) of “disparity_temporal_extension( )”.

FIG. 22 is a diagram illustrating principal data stipulations (semantics) in a structure example of “disparity_temporal_extension( )”.

FIG. 23 is a diagram illustrating an example of updating disparity information for each base segment period (BSP).

FIG. 24 is a diagram schematically illustrating the flow of stereoscopic image data and subtitle data (including display control information) from a broadcasting station to a television receiver via a set top box, or directly from a broadcasting station to a television receiver.

FIG. 25 is a diagram schematically illustrating the flow of stereoscopic image data and subtitle data (including display control information) from a broadcasting station to a television receiver via a set top box, or directly from a broadcasting station to a television receiver.

FIG. 26 is a diagram schematically illustrating the flow of stereoscopic image data and subtitle data (including display control information) from a broadcasting station to a television receiver via a set top box, or directly from a broadcasting station to a television receiver.

FIG. 27 is a diagram illustrating a display example of captions (graphics information) on an image, and perspective of background, closeup view object, and caption.

FIG. 28 is a diagram illustrating a display example of caption on a screen, and a display example of a left eye caption LGI and right eye caption RGI for displaying caption.

FIG. 29 is a block diagram illustrating a configuration example of a set top box configuring a stereoscopic image display system.

FIG. 30 is a block diagram illustrating a configuration example of a bit stream processing unit configuring a set top box.

FIG. 31 is a diagram illustrating an example of generating disparity information between arbitrary frames (interpolated disparity information), by performing interpolation processing involving low-pass filter processing on multiple frames of disparity information making up disparity information which is sequentially updated within a caption display period.

FIG. 32 is a block diagram illustrating a configuration example of a television receiver configuring a stereoscopic image display system.

FIG. 33 is a block diagram illustrating a configuration example of a transmission data generating unit at a broadcasting station.

FIG. 34 is a diagram illustrating a configuration example of a caption data stream and a display example of caption units (caption).

FIG. 35 is a diagram illustrating a configuration example of a caption data stream generated at a caption encoder and a creation example of disparity vectors in this case.

FIG. 36 is a diagram illustrating another configuration example of a caption data stream generated at a caption encoder and a creation example of disparity vectors in this case.

FIG. 37 is a diagram illustrating a configuration example of a caption data stream generated at a caption encoder and a creation example of disparity vectors in this case.

FIG. 38 is a diagram illustrating another configuration example of a caption data stream generated at a caption encoder and a creation example of disparity vectors in this case.

FIG. 39 is a diagram for describing a case of shifting the position of each caption unit superimposed on a first and a second view.

FIG. 40 is a diagram illustrating a packet structure of control code included in a PES stream of a caption text data group.”

FIG. 41 is a diagram illustrating a packet structure of caption code included in a PES stream of a caption management data group.”

FIG. 42 is a diagram illustrating the structure of a data group within a caption data stream (PES stream).

FIG. 43 is a diagram schematically illustrating the structure of caption management data in a case of a disparity vector (disparity information) being inserted within a PES stream of a caption management data group.

FIG. 44 is a diagram schematically illustrating the structure of caption data in a case of a disparity vector (disparity information) being inserted within a PES stream of a caption management data group.

FIG. 45 is a diagram schematically illustrating the structure of caption data in a case of a disparity vector (disparity information) being inserted within a PES stream of a caption text data group.

FIG. 46 is a diagram schematically illustrating the structure of caption management data in a case of a disparity vector (disparity information) being inserted within a PES stream of a caption text data group.

FIG. 47 is a diagram illustrating the structure (Syntax) of a data unit (data_unit) included in a caption data stream.

FIG. 48 is a diagram illustrating the types of data units, and the data unit parameters and functions thereof.

FIG. 49 is a diagram illustrating the structure (Syntax) of a data unit (data_unit) for extended display control.

FIG. 50 is a diagram illustrating the structure (Syntax) of“Advanced_Rendering_Control” in a data unit of extended display control which a PES stream of a caption management data group has.

FIG. 51 is a diagram illustrating the structure (Syntax) of“Advanced_Rendering_Control” in a data unit of extended display control which a PES stream of a caption text data group has.

FIG. 52 is a diagram illustrating principal data stipulations in the structure of “Advanced_Rendering_Control” and“disparity information”.

FIG. 53 is a diagram illustrating a structure (Syntax) of “disparity information” in “Advanced_Rendering_Control” within a extended display control data unit (data_unit) within a caption text data group.

FIG. 54 is a diagram illustrating a structure of “disparity information”.

FIG. 55 is a diagram illustrating a configuration example of a general transport stream (multiplexed data stream) including a video elementary stream, audio elementary stream, and caption elementary stream.

FIG. 56 is a diagram illustrating a structure example (Syntax) of a data content descriptor.

FIG. 57 is a diagram illustrating a structure example (Syntax) of “arib_caption_info”.

FIG. 58 is a diagram illustrating a configuration example of a transport stream (multiplexed data stream) in a case of inserting flag information beneath a PMT.

FIG. 59 is a diagram illustrating a structure example (Syntax) of a data encoding format descriptor.

FIG. 60 is a diagram illustrating a structure example (Syntax) of “additional_arib_caption_info”.

FIG. 61 is a block diagram illustrating a configuration example of a bit stream processing unit of a set top box.

FIG. 62 is a block diagram illustrating a configuration example of a transmission data generating unit at a broadcasting station.

FIG. 63 is a diagram illustrating that a sequence header portion including parameters in increments of sequences is situated at the head of a video elementary stream.

FIG. 64 is a diagram schematically illustrating a CEA table.

FIG. 65 is a diagram illustrating a configuration example of a 3-byte field of “Byte1”, “Byte2”, and Byte3”, configuring an extended command.

FIG. 66 is a diagram illustrating an example of updating disparity information for each base segment period (BSP).

FIG. 67 is a diagram schematically illustrating a CEA table.

FIG. 68 is a diagram illustrating a configuration example of a 4-byte field of “Header (Byte1)”, “Byte2”, “Byte3”, and “Byte4”.

FIG. 69 is a diagram illustrating a structure example (Syntax) of conventional closed caption data (CC data).

FIG. 70 is a diagram illustrating a structure example (Syntax) of conventional closed caption data (CC data) corrected to be compatible with disparity information (disparity).

FIG. 71 is a diagram for describing a 2-bit field “extended_control” which controls the two fields of “cc_data_{—}1” and “cc_data_{—}2”.

FIG. 72 is a diagram illustrating a structure example (syntax) of “caption_disparity_data( )”.

FIG. 73 is a diagram illustrating a structure example (syntax) of “disparity_temporal_extension( )”.

FIG. 74 is a diagram illustrating principal data stipulations (semantics) in the structure example of “caption_disparity_data( )”.

FIG. 75 is a diagram illustrating a configuration example of a general transport stream (multiplexed data stream) including a video elementary stream, audio elementary stream, and caption elementary stream.

FIG. 76 is a block diagram illustrating a configuration example of a bit stream processing unit configuring a set top box.

FIG. 77 is a diagram illustrating another structure example (syntax) of “disparity_temporal_extension( )”.

FIG. 78 is a diagram illustrating principal data stipulations (semantics) in the structure example of “disparity_temporal_extension( )”.

FIG. 79 is a diagram illustrating an example of updating disparity information in a case of using another structure example of “disparity_temporal_extension( )”.

FIG. 80 is a diagram illustrating an example of updating disparity information in a case of using another structure example of “disparity_temporal_extension( )”.

FIG. 81 is a diagram illustrating a configuration example of a subtitle data stream.

FIG. 82 is a diagram illustrating an example of updating disparity information in a case of sequentially transmitting SCS segments.

FIG. 83 is a diagram illustrating an example of updating disparity information (disparity) represented as multiples of interval periods (ID: Interval Duration) with updating frame spacings serving as increment periods.

FIG. 84 is a diagram illustrating a configuration example of a subtitle data stream including DDS, PCS, RCS, CDS, ODS, DSS, and EOS segments are PES payload data.

FIG. 85 is a diagram illustrating a display example of subtitles in which two regions (Region) serving as caption display areas are included in a page area (Area for Page_default).

FIG. 86 is a diagram illustrating an example of disparity information curves of regions and a page, in a case wherein both disparity information in increments of regions, and disparity information in page increment including all regions, are included in a DSS segment as disparity information (Disparity) sequentially updated during a caption display period.

FIG. 87 is a diagram illustrating what sort of structure that disparity information of a page and the regions are sent with.

FIG. 88 is a diagram (1/4) illustrating a structure example (syntax) of a DSS.

FIG. 89 is a diagram (2/4) illustrating a structure example of a DSS.

FIG. 90 is a diagram (3/4) illustrating a structure example of a DSS.

FIG. 91 is a diagram (4/4) illustrating a structure example of a DSS.

FIG. 92 is a diagram (1/2) illustrating principal data stipulations (semantics) of a DSS.

FIG. 93 is a diagram (2/2) illustrating principal data stipulations of a DSS.

FIG. 94 is a block diagram illustrating another configuration example of an image transmission/reception system.

FIG. 95 is a diagram for describing the relation between the display position of left and right images of an object on a screen and the playing position of the stereoscopic image thereof, in stereoscopic image display using binocular disparity.

### DESCRIPTION OF EMBODIMENTS

A mode for implementing the present invention (hereafter, referred to as “embodiment”) will now be described. Note that description will be made in the following sequence.

1. Embodiment

2. Modifications

### 1. Embodiment

“Configuration Example of Image Transmission/Reception System”

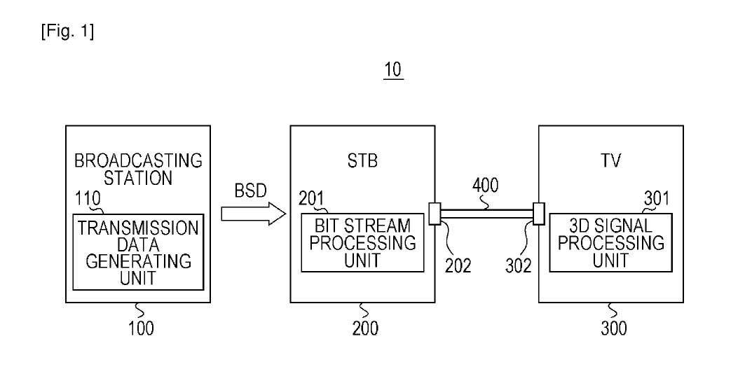

FIG. 1 illustrates a configuration example of an image transmission/reception system 10 as an embodiment. This image transmission/reception system 10 includes a broadcasting station 100, a set top box (STB) 200, and a television receiver (TV) 300.

The set top box 200 and the television receiver 300 are connected via an HDMI (High Definition Multimedia Interface) digital interface. The set top box 200 and the television receiver 300 are connected using an HDMI cable 400. With the set top box 200, an HDMI terminal 202 is provided. With the television receiver 300, an HDMI terminal 302 is provided. One end of the HDMI cable 400 is connected to the HDMI terminal 202 of the set top box 200, and the other end of this HDMI cable 400 is connected to the HDMI terminal 302 of the television receiver 300.

“Description of Broadcasting Station”

The broadcasting station 100 transmits bit stream data BSD by carrying this on broadcast waves. The broadcasting station 100 has a transmission data generating unit 110 which generates bit stream data BSD. This bit stream data BSD includes image data, audio data, superposition information data, disparity information, and so forth. Now, image data (hereinafter referred to “stereoscopic image data” as appropriate) includes left eye image data and right eye image data configuring a stereoscopic image. Stereoscopic image data has a predetermined transmission format. The superposition information generally includes captions, graphics information, text information, and so forth, but in this embodiment is captions.

“Configuration Example of Transmission Data Generating Unit”

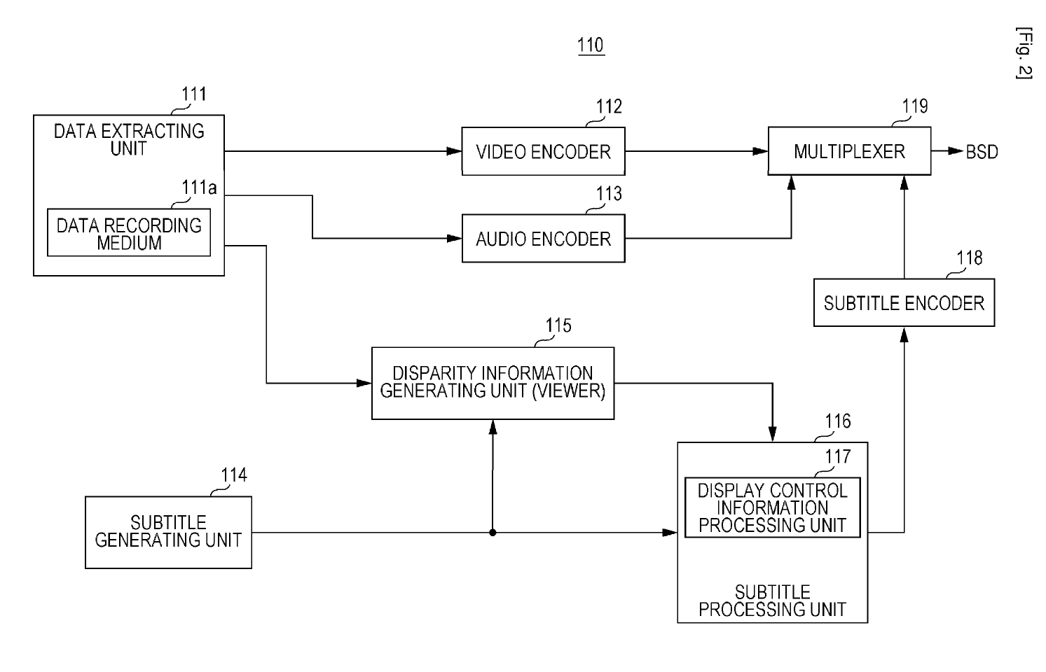

FIG. 2 illustrates a configuration example of the transmission data generating unit 110 of the broadcasting station 100. This transmission data generating unit 110 transmits-disparity information (disparity vectors) in a data structure which is readily compatible with the DVB (Digital Video Broadcasting) format which is an existing broadcasting standard. The transmission data generating unit 110 includes a data extracting unit (archiving unit) 111, a video encoder 112, and an audio encoder 113. The transmission data generating unit 110 also has a subtitle generating unit 114, a disparity information creating unit 115, a subtitle processing unit 116, a subtitle encoder 118, and a multiplexer 119.

A data recording medium 111a is, for example detachably mounted to the data extracting unit 111. This data recording medium 111a has recorded therein, along with stereoscopic image data including left eye image data and right eye image data, audio data and disparity information, in a correlated manner. The data extracting unit 111 extracts, from the data recording medium 111a, the stereoscopic image data, audio data, disparity information, and so forth, and outputs this. The data recording medium 111a is a disc-shaped recording medium, semiconductor memory, or the like.

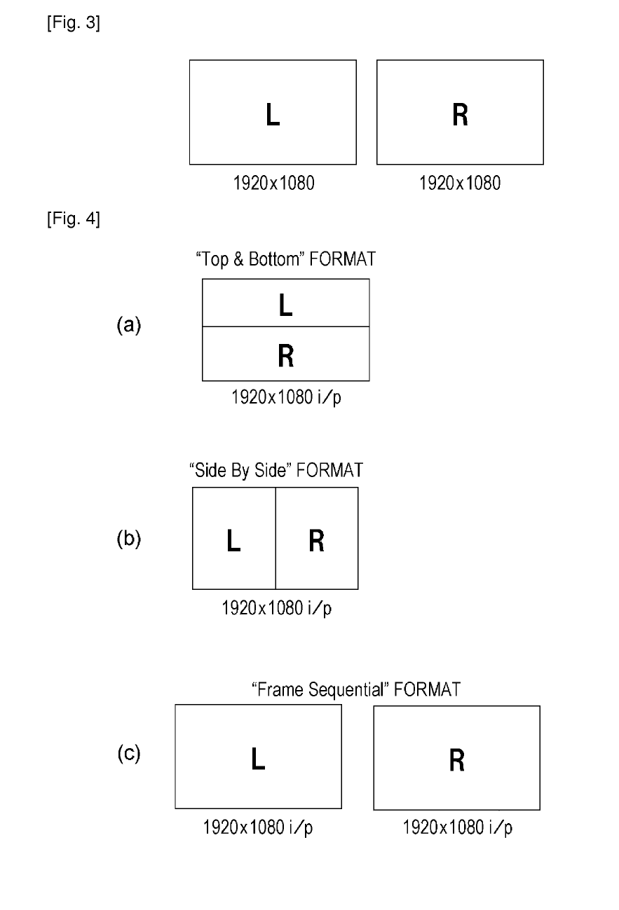

The stereoscopic image data recorded in the data recording medium 111a is stereoscopic image data of a predetermined transmission format. An example of the transmission format of stereoscopic image data (3D image data) will be described. While the following first through third methods are given as transmission methods, transmission methods other than these may be used. Here, as illustrated in FIG. 3, description will be made regarding a case where each piece of image data of the left eye (L) and the right eye (R) is image data with determined resolution, e.g., a pixel format of 1920*1080, as an example.

The first transmission method is a top & bottom (Top & Bottom) format, and is, as illustrated in FIG. 4(a), a format for transmitting the data of each line of left eye image data in the first half of the vertical direction, and transmitting the data of each line of right eye image data in the second half of the vertical direction. In this case, the lines of the left eye image data and right eye image data are thinned out to ½, so the vertical resolution is reduced to half as to the original signal.

The second transmission method is a side by side (Side By Side) format, and is, as illustrated in FIG. 4(b), a format for transmitting pixel data of the left eye image data in the first half of the horizontal direction, and transmitting pixel data of the right eye image data in the second half of the horizontal direction. In this case, the left eye image data and right eye image data each have the pixel data thereof in the horizontal direction thinned out to ½, so the horizontal resolution is reduced to half as to the original signal.

The third transmission method is a frame sequential (Frame Sequential) format, and is, as illustrated in FIG. 4(c), a format for transmitting left eye image data and right eye image data by sequentially switching these for each frame. This frame sequential format is also sometimes called full frame (Full Frame) or backward compatible (Backward Compatible) format.

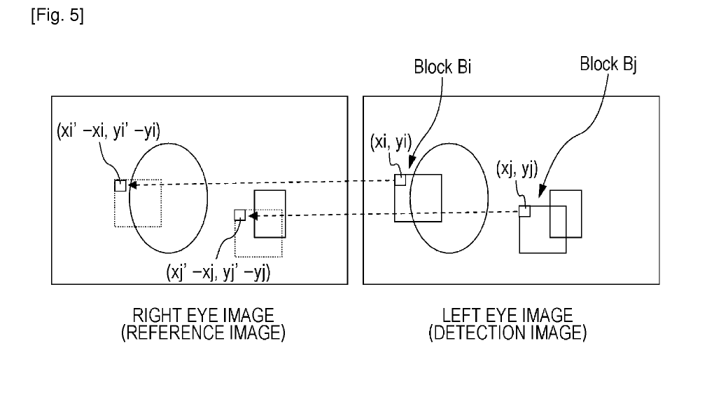

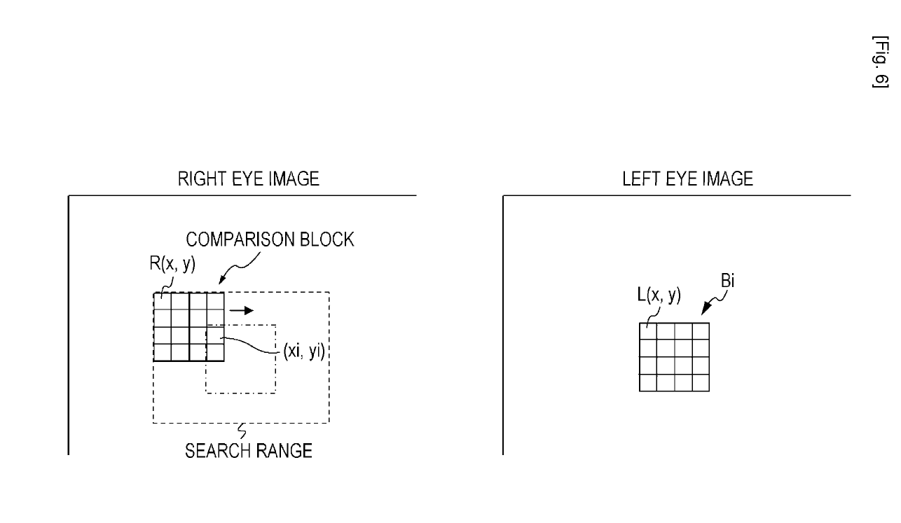

The disparity information recorded in the data recording medium 111a is disparity vectors for each of pixels (pixels) configuring an image, for example. A detection example of disparity vectors will be described. Here, an example of detecting a disparity vector of a right eye image as to a left eye image will be described. As illustrated in FIG. 5, the left eye image will be taken as a detection image, and the right eye image will be taken as a reference image. With this example, disparity vectors in the positions of (xi, yi) and (xj, yj) will be detected.

Description will be made regarding a case where the disparity vector in the position of (xi, yi) is detected, as an example. In this case, a pixel block (disparity detection block) Bi of, for example, 4*4, 8*8, or 16*16 with the pixel position of (xi, yi) as upper left is set to the left eye image. Subsequently, with the right eye image, a pixel block matched with the pixel block Bi is searched.

In this case, a search range with the position of (xi, yi) as the center is set to the right eye image, and comparison blocks of, for example, 4*4, 8*8, or 16*16 as with the above pixel block Bi are sequentially set with each pixel within the search range sequentially being taken as the pixel of interest.

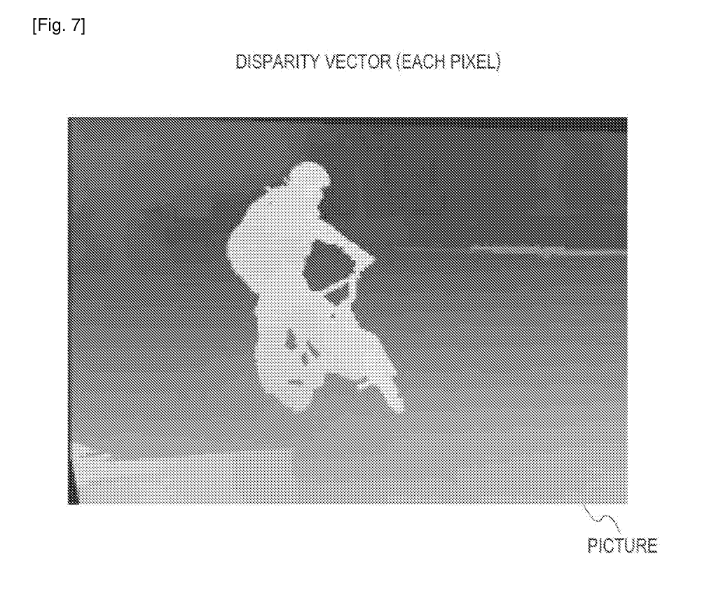

Summation of the absolute value of difference for each of the corresponding pixels between the pixel block Bi and a comparison block sequentially set is obtained. Here, as illustrated in FIG. 6, if we say that the pixel value of the pixel block Bi is L(x, y), and the pixel value of a comparison block is R(x, y), the summation of the difference absolute value between the pixel block Bi and the certain comparison block is represented with S|L(x, y)-R(x, y)|.

When n pixels are included in the search range set to the right eye image, finally, n summations S1 through Sn are obtained, of which the minimum summation 5 min is selected. Subsequently, the position (xi′, yi′) of an upper left pixel is obtained from the comparison block from which the summation 5 min has been obtained. Thus, the disparity vector in the position of (xi, yi) is detected as (xi′-xi, yi′-yi) in the position of (xi, yi). Though detailed description will be omitted, with regard to the disparity vector in the position (xj, yj) as well, a pixel block Bj of, for example, 4*4, 8*8, or 16*16 with the pixel position of (xj, yj) as upper left is set to the left eye image, and detection is made in the same process.

The video encoder 112 subjects the stereoscopic image data extracted by the data extracting unit 111 to encoding such as MPEG4-AVC, MPEG2, VC-1, or the like, and generates a video data stream (video elementary stream). The audio encoder 113 subjects the audio data extracted by the data extracting unit 111 to encoding such as AC3, AAC, or the like, and generates an audio data stream (audio elementary stream).

The subtitle generating unit 114 generates subtitle data which is DVB (Digital Video Broadcasting) format caption data. This subtitle data is subtitle data for two-dimensional images. The subtitle generating unit 114 configures a superimposed information data output unit.

The disparity information creating unit 115 subjects the disparity vector (horizontal direction disparity vector) for each pixel (pixel) extracted by the data extracting unit 111 to downsizing processing, and creates disparity information (horizontal direction disparity vector) to be applied to the subtitle. This disparity information creating unit 115 configures a disparity information output unit. Note that the disparity information to be applied to the subtitle can be applied in increments of pages, increments of regions, or increments of objects. Also, the disparity information does not necessarily have to be generated at the disparity information creating unit 115, and a configuration where this is externally supplied may be made.

FIG. 7 illustrates an example of data in the relative depth direction to be given such as the luminance value of each pixel (pixel). Here, the data in the relative depth direction can be handled as a disparity vector for each pixel by predetermined conversion. With this example, the luminance values of a person portion are high. This means that the value of a disparity vector of the person portion is great, and accordingly, with stereoscopic image display, this means that this person portion is perceived to be in a state of being closer. Also, with this example, the luminance values of a background portion are low. This means that the value of a disparity vector of the background portion is small, and accordingly, with stereoscopic image display, this means that this background portion is perceived to be in a state of being farther away.

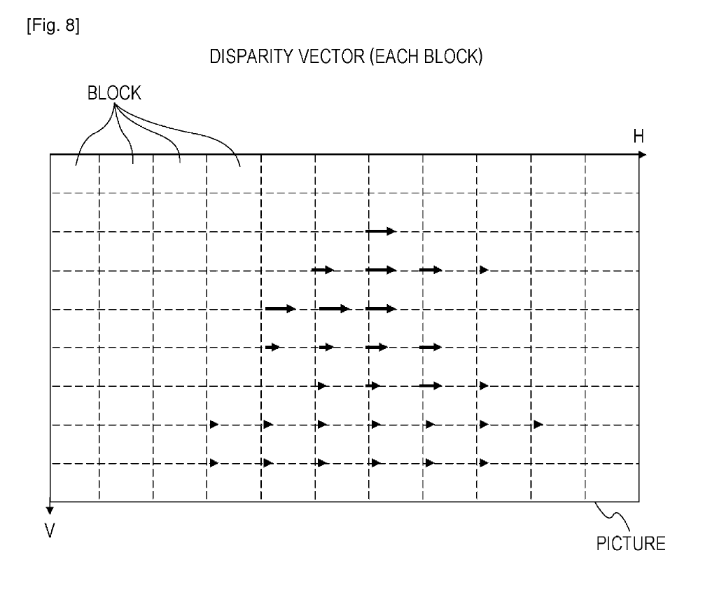

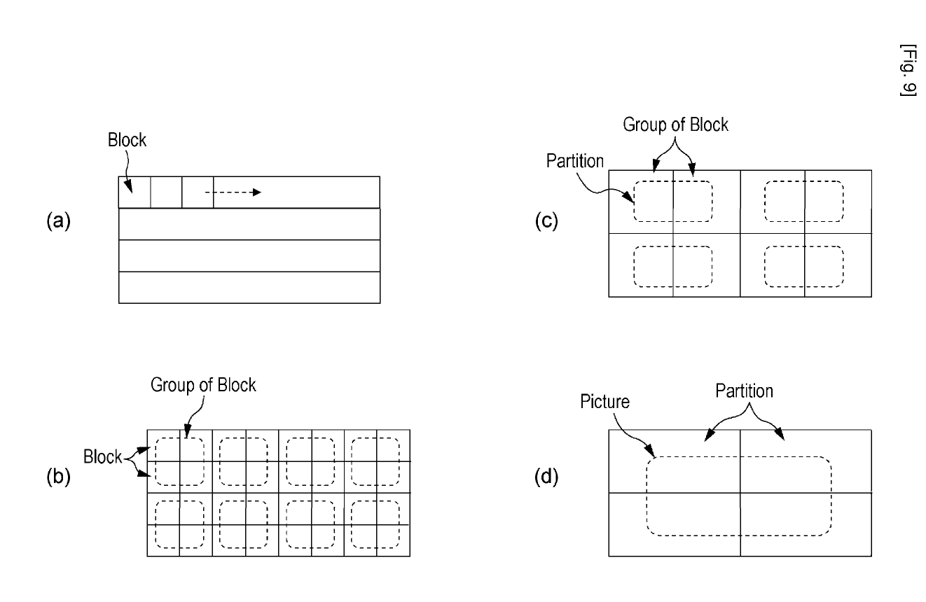

FIG. 8 illustrates an example of the disparity vector for each block (Block). The block is equivalent to the upper layer of pixels (pixels) positioned in the lowermost layer. This block is configured by an image (picture) area being divided with predetermined sizes in the horizontal direction and the vertical direction. The disparity vector of each block is obtained, for example, by a disparity vector of which the value is the greatest being selected out of the disparity vectors of all the pixels (pixels) existing within the block thereof. With this example, the disparity vector of each block is illustrated by an arrow, and the length of the arrow corresponds to the size of the disparity vector.

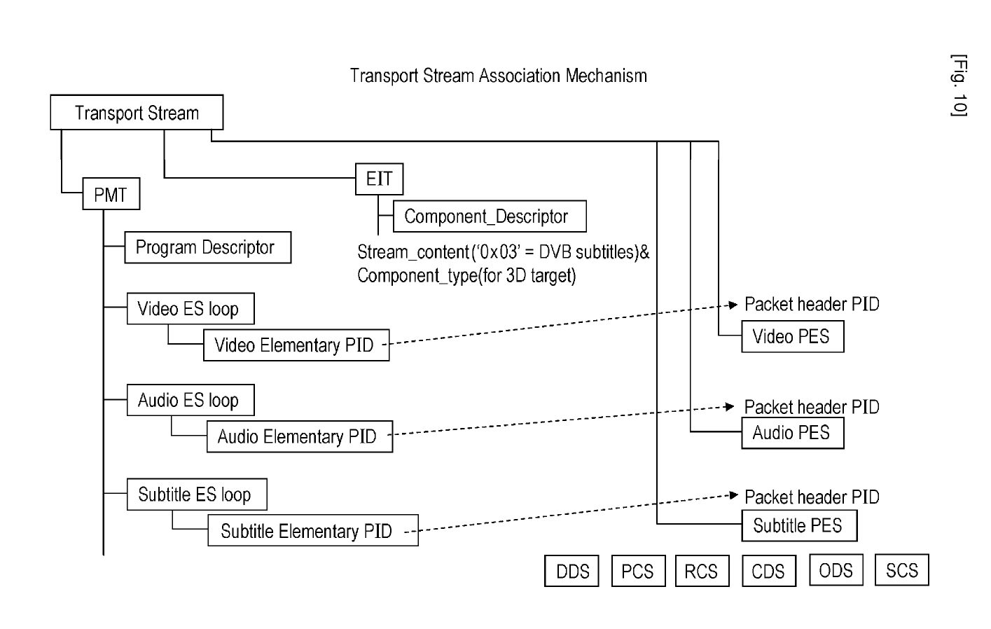

FIG. 9 illustrates an example of the downsizing processing to be performed at the disparity information creating unit 115. First, the disparity information creating unit 115 uses, as illustrated in (a) in FIG. 9, the disparity vector for each pixel (pixel) to obtain the disparity vector for each block. As described above, the block is equivalent to the upper layer of pixels (pixels) positioned in the lowermost layer, and is configured by an image (picture) area being divided with predetermined sizes in the horizontal direction and the vertical direction. The disparity vector of each block is obtained, for example, by a disparity vector of which the value is the greatest being selected out of the disparity vectors of all the pixels (pixels) existing within the block thereof.

Next, the disparity information creating unit 115 uses, as illustrated in (b) in FIG. 9, the disparity vector for each block to obtain the disparity vector for each group (Group Of Block). The group is equivalent to the upper layer of blocks, and is obtained by collectively grouping multiple adjacent blocks. With the example in (b) in FIG. 9, each group is made up of four blocks bundled with a dashed-line frame. Subsequently, the disparity vector of each group is obtained, for example, by a disparity vector of which the value is the greatest being selected out of the disparity vectors of all the blocks within the group thereof.

Next, the disparity information creating unit 115 uses, as illustrated in (c) in FIG. 9, the disparity vector for each group to obtain the disparity vector for each partition (Partition). The partition is equivalent to the upper layer of groups, and is obtained by collectively grouping multiple adjacent groups. With the example in (c) in FIG. 9, each partition is made up of two groups bundled with a dashed-line frame. Subsequently, the disparity vector of each partition is obtained, for example, by a disparity vector of which the value is the greatest being selected out of the disparity vectors of all the groups within the partition thereof.

Next, the disparity information creating unit 115 uses, as illustrated in (d) in FIG. 9, the disparity vector for each partition to obtain the disparity vector of the entire picture (entire image) positioned in the uppermost layer. With the example in (d) in FIG. 9, the entire picture includes four partitions bundled with a dashed-line frame. Subsequently, the disparity vector of the entire picture is obtained, for example, by a disparity vector having the greatest value being selected out of the disparity vectors of all the partitions included in the entire picture.

In this way, the disparity information creating unit 115 subjects the disparity vector for each pixel (pixel) positioned in the lowermost layer to downsizing processing, whereby the disparity vector of each area of each hierarchy of a block, group, partition, and the entire picture can be obtained. Note that, with an example of- downsizing processing illustrated in FIG. 9, eventually, in addition to the hierarchy of pixels (pixels), the disparity vectors of the four hierarchies of a block, group, partition, and the entire picture are obtained, but the number of hierarchies, how to partition the area of each hierarchy, and the number of areas are not restricted to this example.

Returning to FIG. 2, the subtitle processing unit 116 converts the subtitle data generated at the subtitle generating unit 114 into subtitle data for stereoscopic images (for three-dimensional images) corresponding to the transmission format of the stereoscopic image data extracted by the data extracting unit 111. The subtitle processing unit 116 configures a superimposed information data processing unit, and the subtitle data for stereoscopic images following conversion configures superimposing information data for transmission.

This subtitle data for stereoscopic images has left eye subtitle data and right eye subtitle data. Now, the left eye subtitle data is data corresponding to the left eye data included in the aforementioned stereoscopic image data, and is data for generating display data of the left eye subtitle to be superimposed on the left eye image data which the stereoscopic image data has at the reception side. Also, the right eye subtitle data is data corresponding to the right eye image data included in the aforementioned stereoscopic image data, and is data for generating display data of the right eye subtitle to be superimposed on the right eye image data which the stereoscopic image data has at the reception side.

In this case, the subtitle processing unit 116 may shift at least the left eye subtitle or right eye subtitle based on the disparity information (horizontal direction disparity vector) from the disparity information creating unit 115 to be applied to the subtitle. By applying disparity between the left eye subtitle and right eye subtitle, the reception side can maintain the consistency of perspective between the objects within the image when displaying subtitles (caption) at an optimal state, even without performing processing to provide disparity.

The subtitle processing unit 116 has a display control information generating unit 117. This display control information generating unit 117 generates display control information relating to subregions (Subregion). Now, a subregion is an area defined just within a region. Subregions include left eye subregion (left eye (SR) and right eye subregion (right eye SR). Hereinafter, left eye subregions will be referred to as left eye SR as appropriate, and right eye subregions as right eye SR.

A left eye subregion is a region which is set corresponding to the display position of a left eye subtitle, within a region which is a display area for superimposing information data for transmission. Also, a right eye subregion is a region which is set corresponding to the display position of a right eye subtitle, within a region which is a display area for superimposing information data for transmission. For example, the left eye subregion configures a first display area, and a right eye subregion configures a second display area. The areas of the left eye SR and right eye SR are set for each subtitle data generated at the subtitle processing unit 116, based on user operations, for example, or automatically. Note that in this case, the left eye SR and right eye SR areas are set such that the left eye subtitle within the left eye SR and the right eye subtitle within the right eye SR correspond.

Display control information includes left eye SR area information and right eye SR area information. Also, the display control information includes target frame information to which the left eye subtitle included in the left eye SR is to be displayed, and target frame information to which the right eye subtitle included in the right eye SR is to be displayed. Now, the target frame information to which the left eye subtitle included in the left eye SR is to be displayed indicates the frame of the left eye image, and the target frame information to which the right eye subtitle included in the right eye SR is to be displayed indicates the frame of the right eye image.

Also, this display control information includes disparity information (disparity) for performing shift adjustment of the display position of the left eye subtitle included in the left eye SR, and disparity information for performing shift adjustment of the display position of the right eye subtitle included in the right eye SR. These disparity information are for providing disparity between the left eye subtitle included in the left eye SR and the right eye subtitle included in the right eye SR.

In this case, the based on the disparity information (horizontal direction disparity vector) to be applied to the subtitle created at the disparity information creating unit 115 for example, the display control information generating unit 117 obtains disparity-information for the shift adjustment to be included in the above-described display control information. Now, the disparity information for the left eye SR “Disparity1” and the disparity information for the right eye SR “Disparity2” are determined having absolute values that are equal, and further, such that the difference thereof is a value corresponding to the disparity information (Disparity) to be applied to the subtitle. For example, in the event that the transmission format of the stereoscopic image data is the side by side format, the value corresponding to the disparity information (Disparity) is “Disparity/2”. Also, in the event that the transmission format of the stereoscopic image data is the top & bottom (Top & Bottom) format, the value corresponding to the disparity information (Disparity) is “Disparity”.

Note that the subtitle data has segments such as DDS, PCS, RSC, CDS, and ODS. DDS (display definition segment) instructs the size of display for HDTV (display). PCS (page composition segment) instructs the position of a region (region) within a page (page). RCS (region composition segment) instructs the size of the region (Region) and the encoding mode of an object (object), and also instructs the start position of the object (object). CDS (CLUT definition segment) instructs the content of a CLUT. ODS (object data segment) includes encoded pixel data (Pixel data).

With this embodiment, a segment of SCS (Subregion composition segment) is newly defined. The display control information generated at the display control information generating unit 117 as described above is inserted into this SCS segment. Details of processing at the subtitle processing unit 116 will be described later.

Returning to FIG. 2, the subtitle encoder 118 generates a subtitle data stream (subtitle elementary stream) including the subtitle data and display control information for displaying stereoscopic images, output from the subtitle processing unit 116. The multiplexer 119 multiplexes the data streams from the video encoder 112, audioencoder 113, and subtitle encoder 118, and obtains a multiplexed data stream as bit stream data (transport stream) BSD.

Note that with this embodiment, the multiplexer 119 inserts identification information identifying that subtitle data for stereoscopic image display is included, in the subtitle datastream. Specifically, Stream_content(‘0x03’=DVBsubtitles) & Component_type (for 3D target) are described in a component descriptor (Component_Descriptor) inserted beneath an EIT (Event Information Table). The Component_type (for 3D target) is newly defined for indicating subtitle data for stereoscopic images.

The operations of the transmission data generating unit 110 shown in FIG. 2 will be briefly described. The stereoscopic image data extracted by the data extracting unit 111 is supplied to the video encoder 112. At this video encoder 112, encoding is performed on the stereoscopic image data such as MPEG4-AVC, MPEG2, VC-1, or the like, and a video data stream including the encoded video data is generated. The video data stream is supplied to the multiplexer 119.

The audio data extracted at the data extracting unit 111 is supplied to the audio encoder 113. This audioencoder 113 subjects the audio data to encoding such as MPEG-2 Audio AAC, or MPEG-4 AAC or the like, generating an audio data stream—including the encoded audio data. The audio data stream is supplied to the multiplexer 119.

At the subtitle generating unit 114, subtitle data (for two-dimensional images) which is DVB caption data is generated. This subtitle data is supplied to the disparity information creating unit 115 and the subtitle processing unit 116.

Disparity vectors for each pixel (pixel) extracted by the data extracting unit 111 are supplied to the disparity information creating unit 115. At the disparity information creating unit 115, downsizing processing is performed on the disparity vector of each pixel, and disparity information (horizontal direction disparity vector=Disparity) to be applied to the subtitle is created. This disparity information is supplied to the subtitle processing unit 116.

At the subtitle processing unit 116, the subtitle data for two-dimensional images generated at the subtitle generating unit 114 is converted into subtitle data for stereoscopic image display corresponding to the transmission format of the stereoscopic image data extracted by the data extracting unit 111 as described above. This subtitle data for stereoscopic image display has data for left eye subtitle and data for right eye subtitle. In this case, the subtitle processing unit 116 may shift at least the left eye subtitle or right eye subtitle to provide disparity between the left eye subtitle and right eye subtitle, based on the disparity information from the disparity information creating unit 115 to be applied to the subtitle.

At the display control information generating unit 117 of the subtitle processing unit 116, display control information (area information, target frame information, disparity information) relating to subregions (Subregion) is generated. A subregion includes a left eye subregion (left eye SR) and a right eye subregion (right eye SR) as described above. Accordingly, the area information for each of the left eye SR and right eye SR, target frame information, and disparity information, are generated as display control information.

As described above, the left eye SR is set within a region which is a display area of superimposing information data for transmission based on user operations for example, or automatically, in a manner corresponding to the display position of the left eye-subtitle. In the same way, the right eye SR is set within a region which is a display area of superimposing information data for transmission based on user operations for example, or automatically, in a manner corresponding to the display position of the right eye subtitle.

The subtitle data for stereoscopic images and display control information obtained at the subtitle processing unit 116 is supplied to the subtitle encoder 118. This subtitle encoder 118 generates a subtitle data stream including subtitle data for stereoscopic images and display control information. The subtitle data stream includes, along with segments such as DDS, PCS, RCS, CDS, ODS, and so forth, with subtitle data for stereoscopic images inserted, a newly defined SCS segment that includes display control information.

As described above, the multiplexer 119 is supplied with the data streams from the video encoder 112, audio encoder 113, and subtitle encoder 118, as described above. At this multiplexer 119, the data streams are Packetized and multiplexed, thereby obtaining a multiplexed data stream as bit stream data (transport stream) BSD.

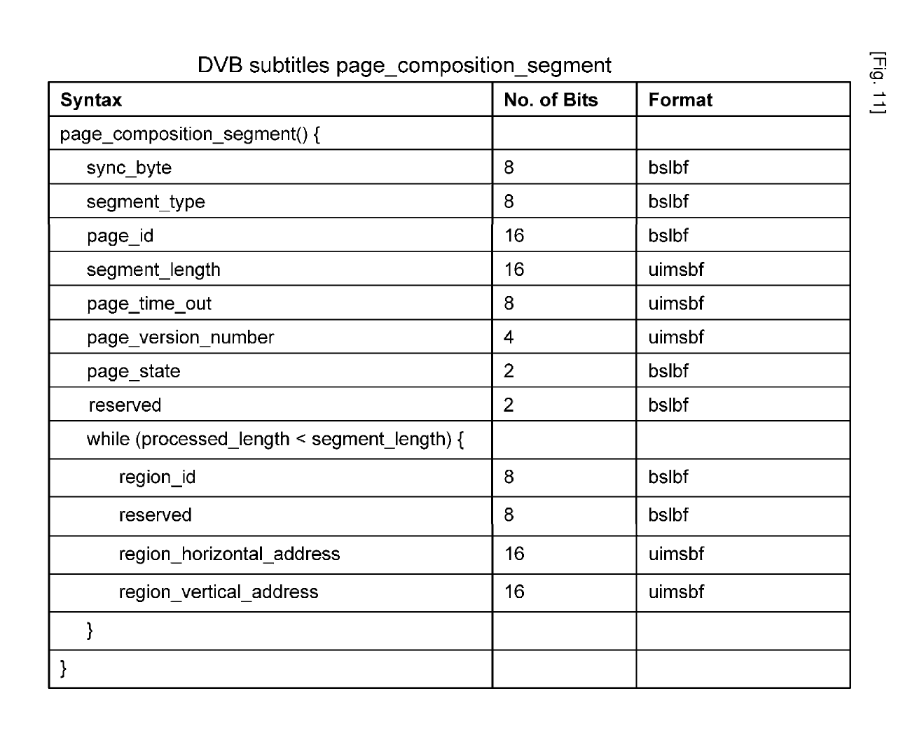

FIG. 10 illustrates a configuration example of a transport stream (bit stream data). This transport stream includes PES packets obtained by packetizing the elementary streams. With this configuration example, included are a video elementary stream PES packet “Video PES”, an audio elementary stream PES packet“Audio PES”, and a subtitle elementary stream PES packet“Subtitle PES”.

With this embodiment, subtitle data for stereoscopic images and display control information are included in the subtitle elementary stream (subtitle data stream) includes, along with conventionally-known segments such as DDS, PCS, RCS, CDS, ODS, and so forth, a newly defined SCS segment that includes display control information.

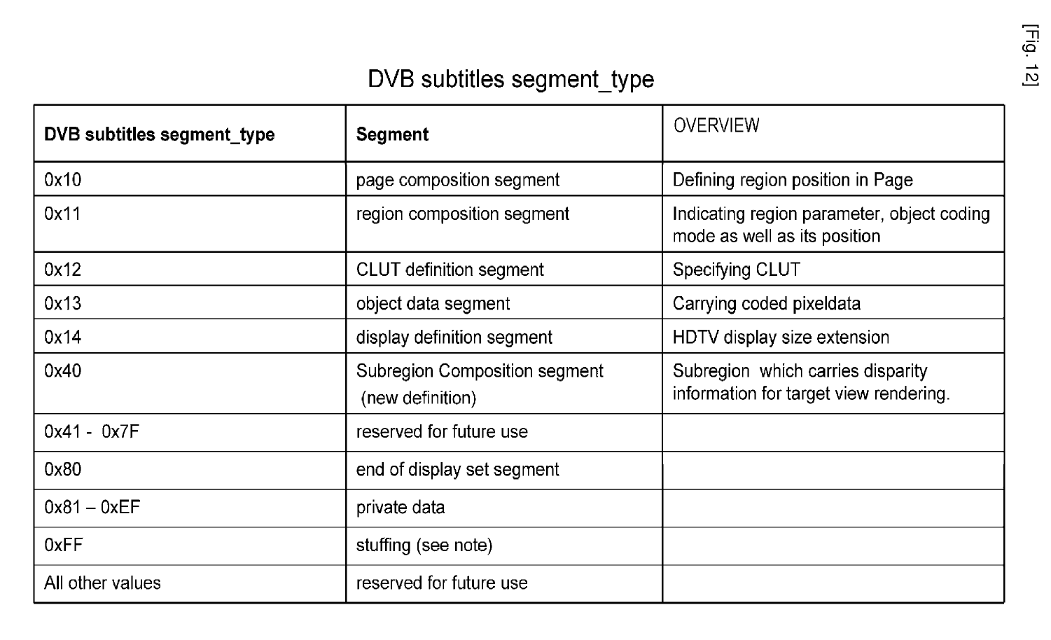

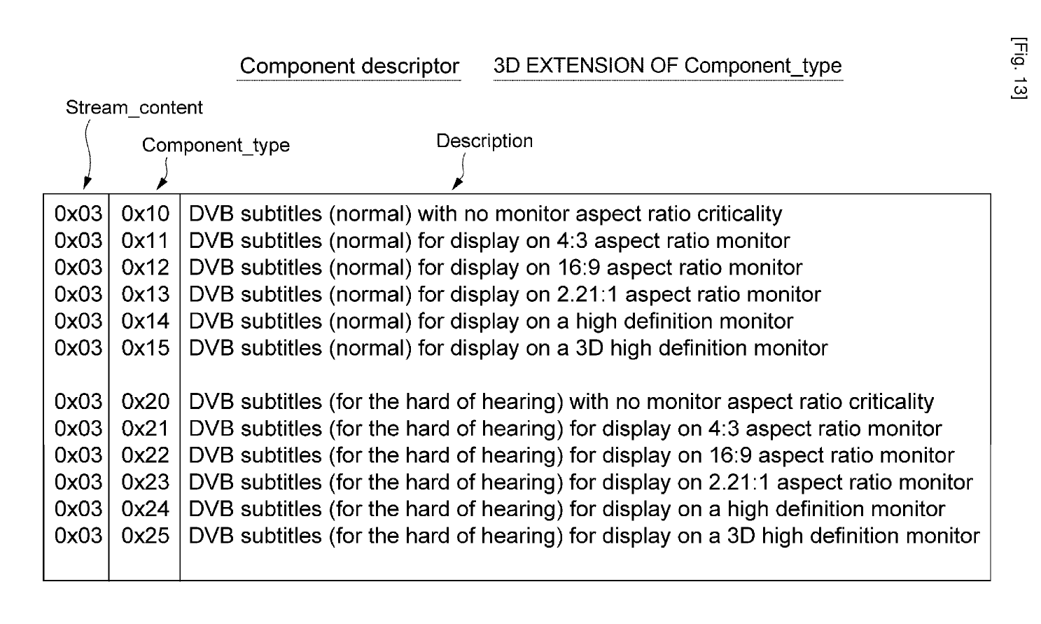

FIG. 11 illustrates the structure of a PCS (page composition segment). As shown in FIG. 12, the segment type of this PCS segment is“0x10”. “region_horizontal_address” and “region_vertical_address” indicate the start position of a region (region). Note that illustration of the structure of other segments such as DDS, RSC, ODS, and so forth, will be omitted from the drawings. As shown in FIG. 12, the segment type of DDS is“0x14”, the segment type of RCS is “0x11”, the segment type of CDS is “0x12”, and the segment type of ODS is “0x13”. For example, as shown in FIG. 12, the segment type of SCS is“0x40”. The detailed structure of this SCS segment will be described later.

Returning to FIG. 10, the transport stream includes a PMT (Program Map Table) as PSI (Program Specific Information). This PSI is information describing to which program each elementary stream included in the transport stream belongs. Also, the transport stream includes an EIT (Event Information Table) as SI (Services Information) regarding which management is performed in increments of events. Metadata in increments of programs is described in the EIT.

A program descriptor (Program Descriptor) describing information relating to the entire program exists in the PMT. Also an elementary loop having information relating to each elementary stream exists in this PMT. With this configuration example, there exists a video elementary loop, an audio elementary loop, and a subtitle elementary loop. Each elementary loop has disposed therein information such as packet identifier (PID) and the like for each stream, and also while not shown in the drawings, a descriptor (descriptor) describing information relating to the elementary stream is also disposed therein.

A component descriptor (Component_Descriptor) is inserted beneath the EIT. With this embodiment, Stream_content (‘0x03’=DVB subtitles) & Component_type (for 3D target) are described in this component descriptor. Accordingly, the fact that the subtitle data stream includes subtitle data for stereoscopic images can be identified. With this embodiment, as shown in FIG. 13, in the event that the “stream content” of “component descriptor” indicating the contents being distributed indicate a subtitle (subtitle) information indicating the format of the 3D subtitle (Component_type=0x15, 0x25) is newly defined.

“Processing at Subtitle Processing Unit”

The details of processing at the subtitle processing unit 116 of the transmission data generating unit 110 shown in FIG. 2 will be described. As described above, the subtitle processing unit 116 converts the subtitle data for two-dimensional images into subtitle data for stereoscopic images. Also, as described above, the subtitle processing unit 116 generates display control information (including left eye SR and right eye SR area information, target frame information, and disparity information) at the display control information generating unit 117.

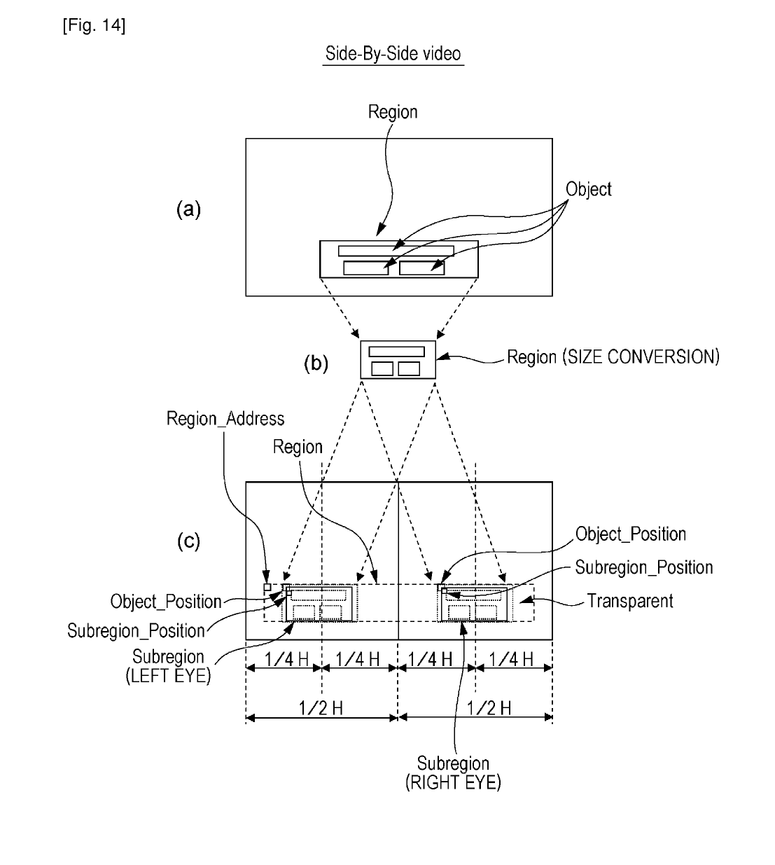

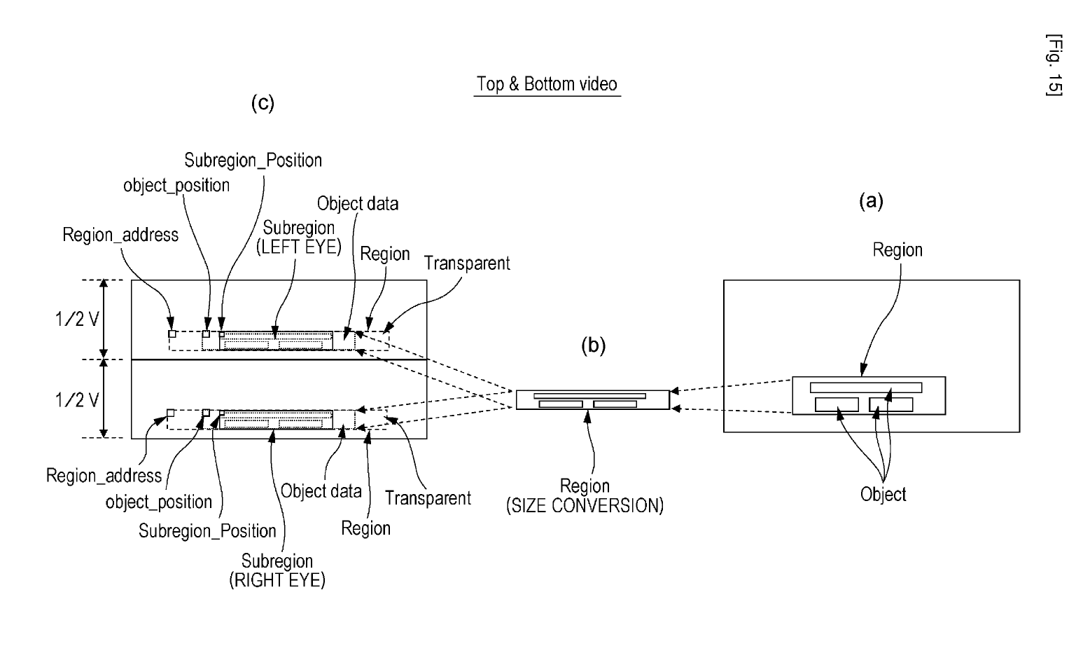

FIG. 14 conceptually illustrates a method for creating subtitle data for stereoscopic images in a case wherein the transmission format of the stereoscopic image data is the side by side format. FIG. 14(a) illustrates a region (region) according to subtitle data for two-dimensional images. Note that with this example, three objects (object) are included in the region.

First, the subtitle processing unit 116 converts the size of the region (region) according to the subtitle data for two-dimensional images described above into a size appropriate for side by side format as shown in FIG. 14(b), and generates bitmap data for that size.

Next, as shown in FIG. 14(c), the subtitle processing unit 116 takes the bitmap data following size conversion as a component of the region (region) in the subtitle data for stereoscopic images. That is to say, the bitmap data following size conversion is an object corresponding to the left eye subtitles within the region, and also is an object corresponding to the right eye subtitles within the region.

As described above, the subtitle processing unit 116 converts the subtitle data for two-dimensional images into subtitle data for stereoscopic images, and creates segments such as DDS, PCS, RCS, CDS, OCS, and so forth, corresponding to this subtitle data for stereoscopic images.

Next, based on user operations, or automatically, the subtitle processing unit 116 sets a left eye SR and right eye SR on the area of the region (region) in the subtitle data for stereoscopic images, as shown in FIG. 14(c). The left eye SR is set in an area including the object corresponding to the left eye subtitle. The right eye SR is set in an area including the object corresponding to the right eye subtitle.

The subtitle processing unit 116 creates an SCS segment including region in formation of the left eye SR and right eye SR set as described above, target frame information, and disparity information. For example, the subtitle processing unit 116 creates an SCS segment including in common region information of the left eye SR and right eye SR, target frame information, and disparity information, or creates an SCS segment including each of region information of the left eye SR and right eye SR, target frame information, and disparity information.

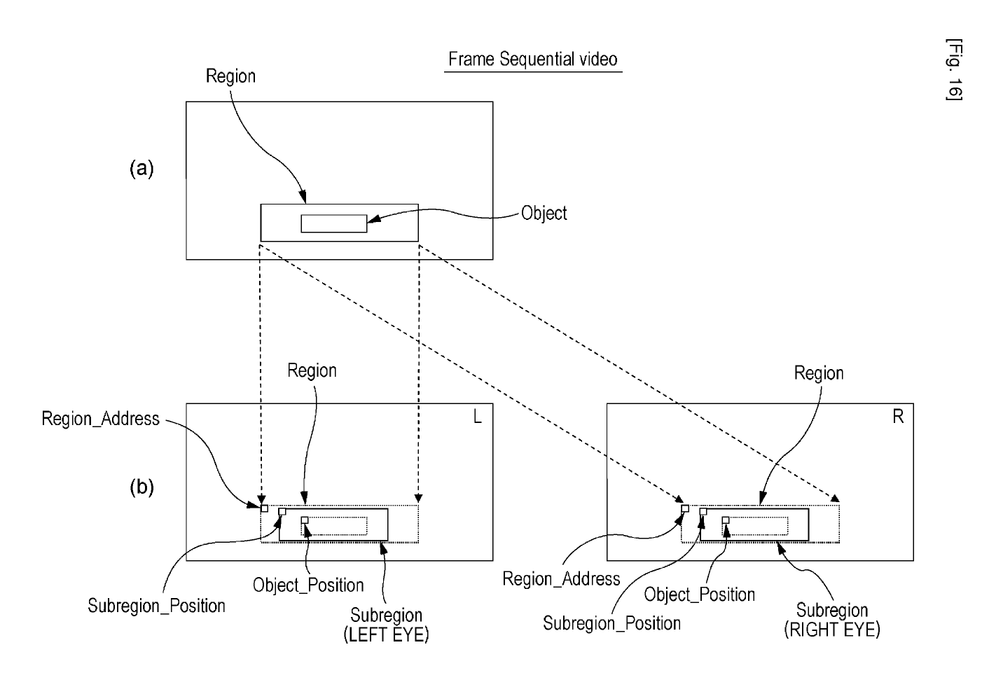

FIG. 15 conceptually illustrates a method for creating subtitle data for stereoscopic images in a case wherein the transmission format of the stereoscopic image data is the top and bottom format. FIG. 15(a) illustrates a region (region) according to subtitle data for two-dimensional images. Note that with this example, three objects (object) are included in the region.

First, the subtitle processing unit 116 converts the size of the region (region) according to the subtitle data for two-dimensional images described above into a size appropriate for top and bottom format as shown in FIG. 15(b), and generates bitmap data for that size.

Next, as shown in FIG. 15(c), the subtitle processing unit 116 takes the bitmap data following size conversion as a component of the region (region) in the subtitle data for stereoscopic images. That is to say, the bitmap data following size conversion is an object of a region of the left eye image (left view) side, and also is an object of a region of the right eye image (right view) side.

As described above, the subtitle processing unit 116 converts the subtitle data for two-dimensional images into subtitle data for stereoscopic images, and creates segments such as PCS, RCS, CDS, OCS, and so forth, corresponding to this subtitle data for stereoscopic images.

Next, based on user operations, or automatically, the subtitle processing unit 116 sets a left eye SR and right eye SR on the area of the region (region) in the subtitle data for stereoscopic images, as shown in FIG. 15(c). The left eye SR is set in an area including the object within the region of the left eye image side. The right eye SR is set in an area including the object within the region of the right eye image side.

The subtitle processing unit 116 creates an SCS segment including are information of the left eye SR and right eye SR set as described above, target frame information, and disparity information. For example, the subtitle processing unit 116 creates an SCS segment including in common region information of the left eye SR and right eye SR, target frame information, and disparity information, or creates an SCS segment including each of region information of the left eye SR and right eye SR, target frame information, and disparity information.

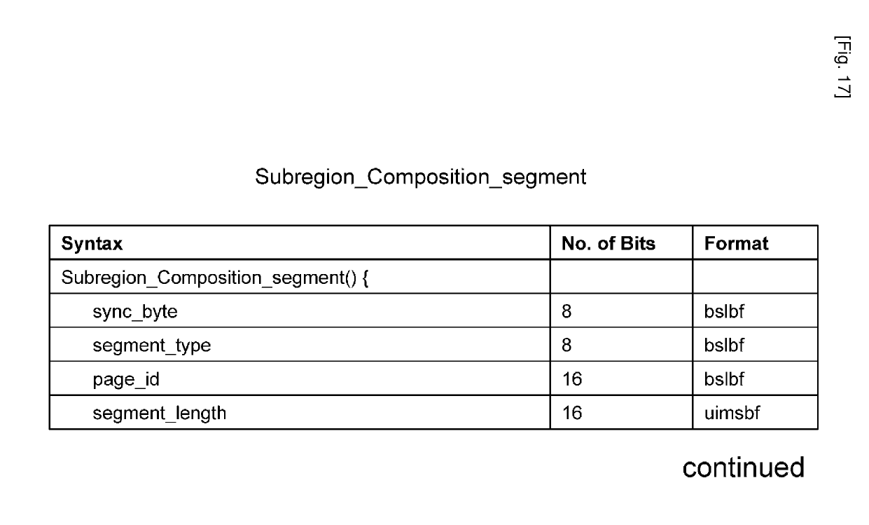

FIG. 16 conceptually illustrates a method for creating subtitle data for stereoscopic images in a case wherein the transmission format of the stereoscopic image data is the frame sequential format. FIG. 16(a) illustrates a region (region) according to subtitle data for two-dimensional images. Note that with this example, one object (object) is included in the region. In the event that the transmission format of the stereoscopic image data is the frame sequential format, the subtitle data for two-dimensional images is used as it is as subtitle data for stereoscopic images. In this case, the segments such as DDS, PCS, RCS, ODS, and so forth, corresponding to the subtitle data for two-dimensional images serve as segments such as DDS, PCS, RCS, ODS, and so forth, corresponding to subtitle data for stereoscopic images, without change.

Next, based on user operations, or automatically, the subtitle processing unit 116 sets a left eye SR and right eye SR on the area of the region (region) in the subtitle data for stereoscopic images, as shown in FIG. 16(d). The left eye SR is set in an area including the object corresponding to the left eye subtitle. The right eye SR is set in an area including the object corresponding to the right eye subtitle.

The subtitle processing unit 116 creates an SCS segment including area information of the left eye SR and right eye SR set as described above, target frame information, and disparity information. For example, the subtitle processing unit 116 creates an SCS segment including in common region information of the left eye SR and right eye SR, target frame information, and disparity information, or creates an SCS segment including each of region information of the left eye SR and right eye SR, target frame information, and disparity information.

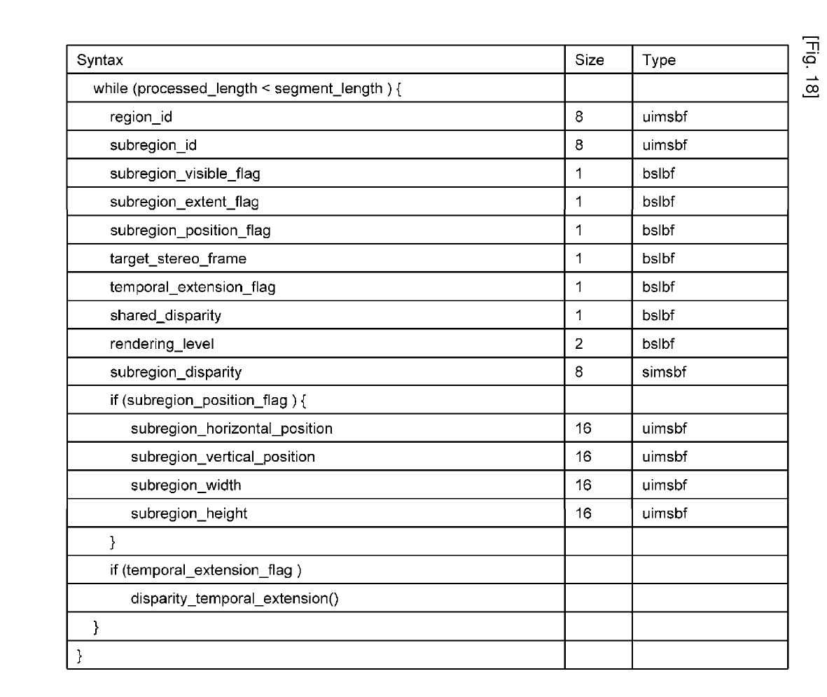

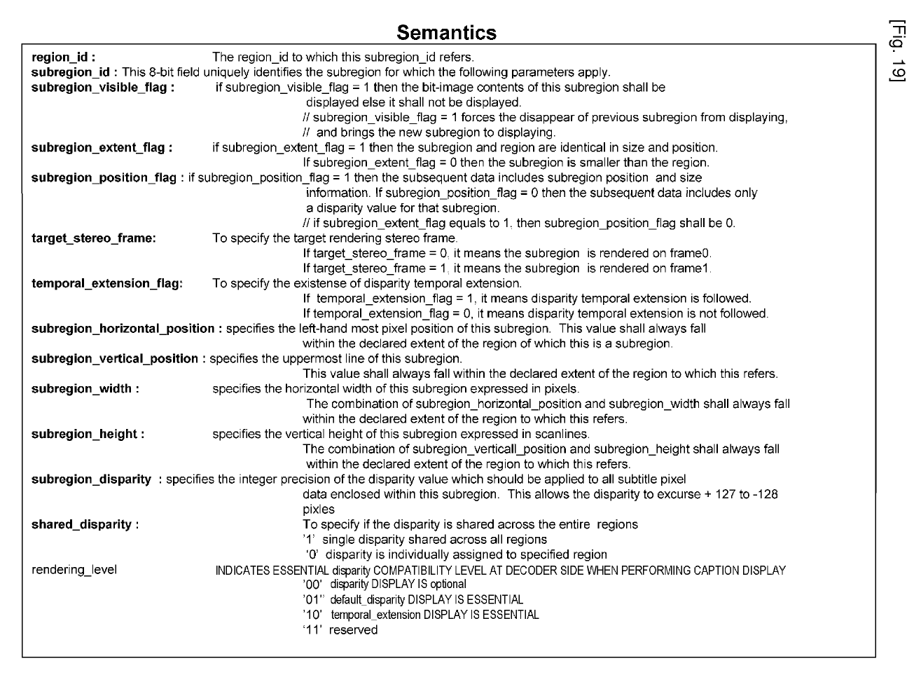

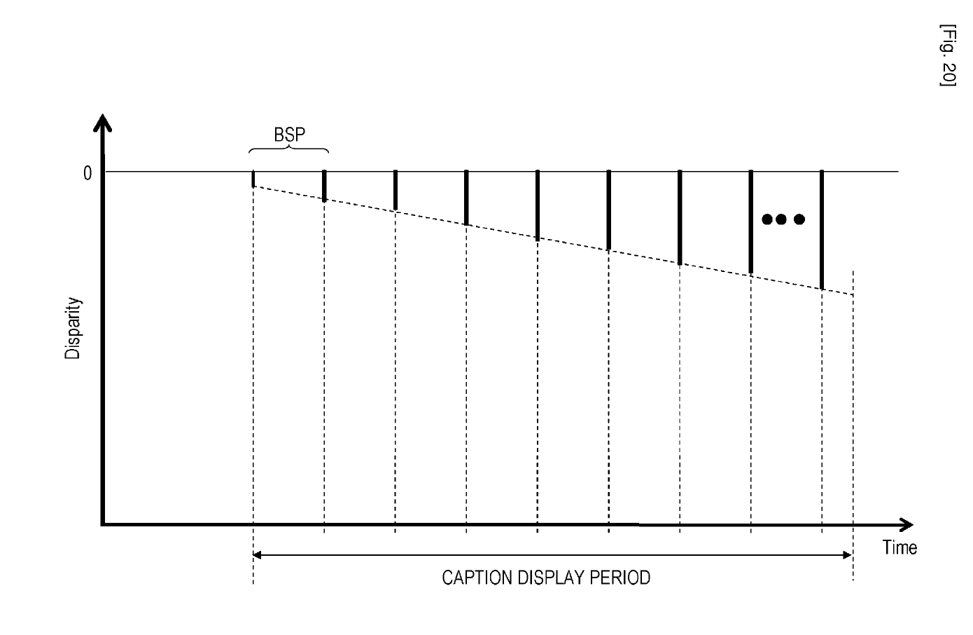

FIG. 17 and FIG. 18 illustrate a structure example (syntax) of a SCS (Subregion Composition segment). FIG. 19 illustrates principal data stipulations (semantics) of an SCS. This structure includes the information of “Sync_byte”, “segment_type”, “page_id”, and “segment_length”. “segment_type” is 8-bit data indicating the segment type, and is “0x40” indicating SCS (see FIG. 12). “segment_length” is 8-bit data indicating the segment length (size).

FIG. 18 illustrates a portion including the substantial information of the SCS. With this configuration example, display control information of left eye SR and right eye SR, i.e., area information of left eye SR and right eye SR, target frame information, disparity information, and display on/off command information, can be transmitted. Note that with the structure example, display control information of an arbitrary number of subregions can be held.

“region_id” is 8-bit information illustrating the identifier of the region (region). “subregion_id” is 8-bit information illustrating the identifier of the subregion (Subregion). “subregion_visible_flag” is 1-bit flag information (command information) controlling on/off of display (superimposing) of the corresponding subregion. “subregion_visible_flag=1” indicates that the display of the corresponding subregion is on, and indicates that the display of the corresponding subregion displayed before that is off.

“subregion_extent_flag” is 1-bit flag information indicating whether or not the subregion and region are the same with regard to the size and position. “subregion_extent_flag=1” indicates that the subregion and region are the same with regard to the size and position. “subregion_extent_flag=0” indicates that the subregion is smaller than the region.

“subregion_position_flag” is 1-bit flag information indicating whether or not the following data includes subregion area (position and size) information.

“subregion_position_flag=1” indicates that the following data includes subregion area (position and size) information. On the other hand, “subregion_position_flag=0” indicates that the following data does not include subregion area (position and size) information.

“target_stereo_frame” is 1-bit information specifying the target frame (frame to be displayed) for the corresponding subregion. This “target_stereo_frame” configures target frame information. “target_stereo_frame=0” indicates that the corresponding subregion is to be displayed in frame 0 (e.g., a left eye frame, or base view frame or the like). On the other hand, “target_stereo_frame=1” indicates that the corresponding subregion is to be displayed in frame 1 (e.g., a right eye frame, or non-base view frame or the like).

“rendering_level” indicates essential disparity information (disparity) at the reception side (decoder side) at the time of displaying the caption. “00” indicates that three-dimensional display of captions using disparity information is optional (optional). “01” indicates that three-dimensional display of captions using disparity information (default_disparity) shared within the caption display period is essential. “10” indicates that three-dimensional display of captions using disparity information (disparity_update) sequentially updated within the caption display period is essential.

“temporal_extension_flag” is 1-bit flag information indicating whether or not disparity information sequentially updated within the caption display period (disparity_update) exists. In this case, “1” indicates existence, and“0” indicates non-existence. “shared_disparity” indicates whether or not to perform common disparity information (disparity) control for all regions (region). “1” indicates that one common disparity information (disparity) is to be applied to all subsequent regions. “0” indicates that the disparity information (disparity) is to be applied to just one region.

The 8-bit field “subregion_disparity” indicates the default disparity information. This disparity information is disparity information used if not updated, i.e., used in common throughout the caption display period. When “subregion_position_flag=1”, the following subregion area (position and size) information is included.

“subregion_horizontal_position” is 16-bit information indicating the position of the left edge of the subregion which is a rectangular area. “subregion_vertical_position” is 16-bit information indicating the position of the top edge of the subregion which is a rectangular area. “subregion_width” is 16-bit information indicating the direction-direction size (in number of pixels) of the subregion which is a rectangular area. “subregion_height” is 16-bit information indicating the vertical-direction size (in number of pixels) of the subregion which is a rectangular area. These positions and size information make up area information of the subregion.

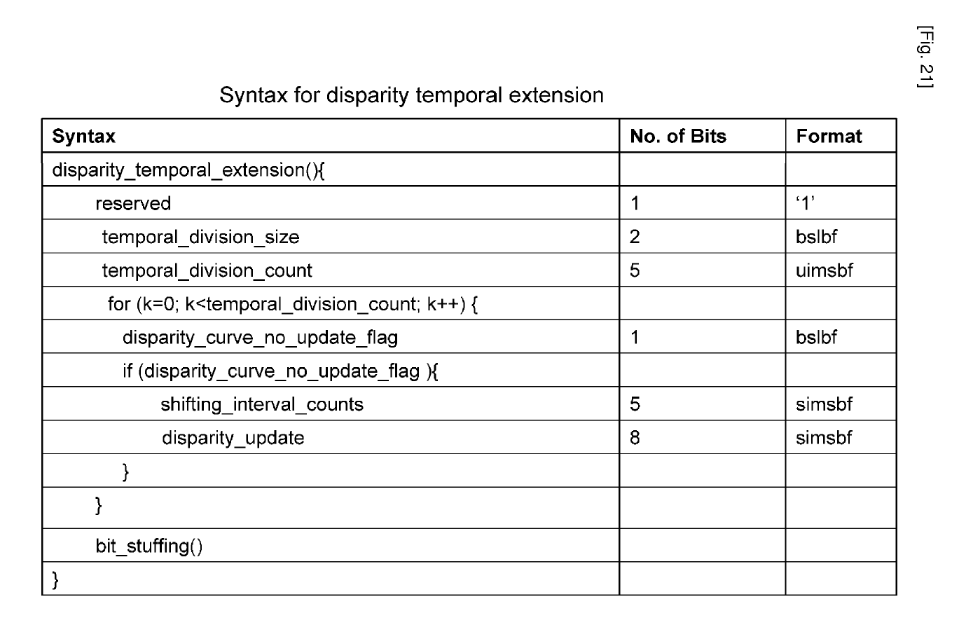

In the event that “temporal_extension_flag” is “1”, this means that a “disparity_temporal_extension( )” is had. Basically, disparity information to be updated each base segment period (BSP:Base Segment Period) is stored here. FIG. 20 illustrates an example of updating disparity information of each base segment period (BSP). Here, a base segment period means updating frame spacings. As can be clearly understood from this drawing, the disparity information that is sequentially updated within the caption display period is made up from the disparity information of the first frame in the caption display period, and disparity information of each subsequent base segment period (updating frame spacing).

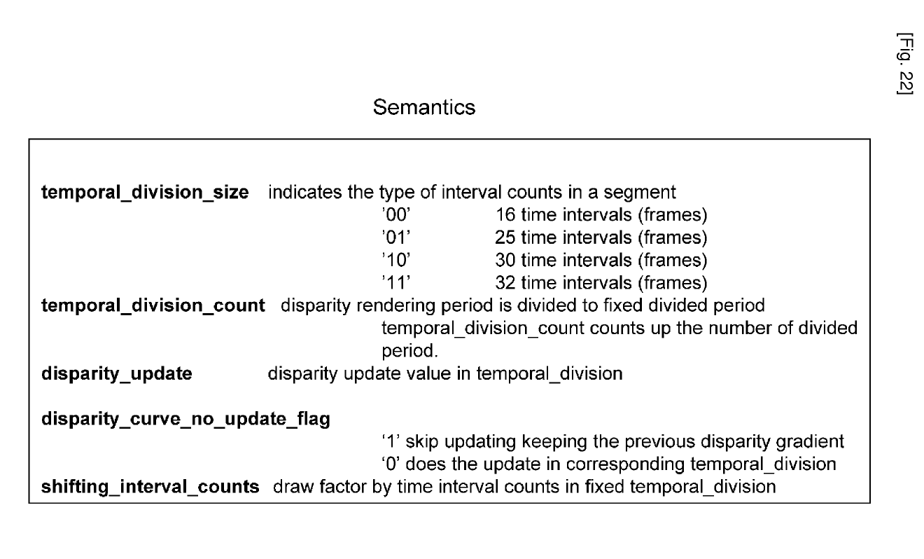

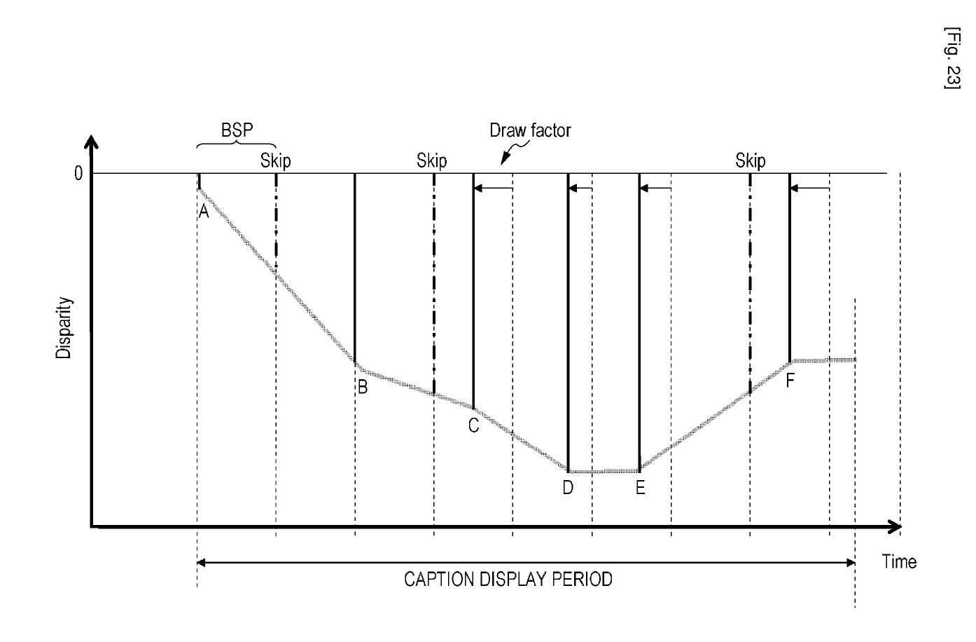

Note that FIG. 21 illustrates a structure example (syntax) of “disparity_temporal_extension( )”. FIG. 22 illustrates principal data stipulations (semantics) thereof. The 2-bit field of “temporal_division_size” indicates the number of frames included in the base segment period (updating frame spacings). “00” indicates that this is 16 frames. “01” indicates that this is 25 frames. “10” indicates that this is 30 frames. Further, “11” indicates that this is 32 frames.

The 5-bit field “temporal_division_count” indicates the number of base segments included in the caption display period. “disparity_curve_no_update_flag” is 1-bit flag information indicating whether or not there is updating of disparity information. “1” indicates that updating of disparity information at the edge of the corresponding base segment is not to be performed, i.e., is to be skipped, and “0” indicates that updating of disparity information at the edge of the corresponding base segment is to be performed.

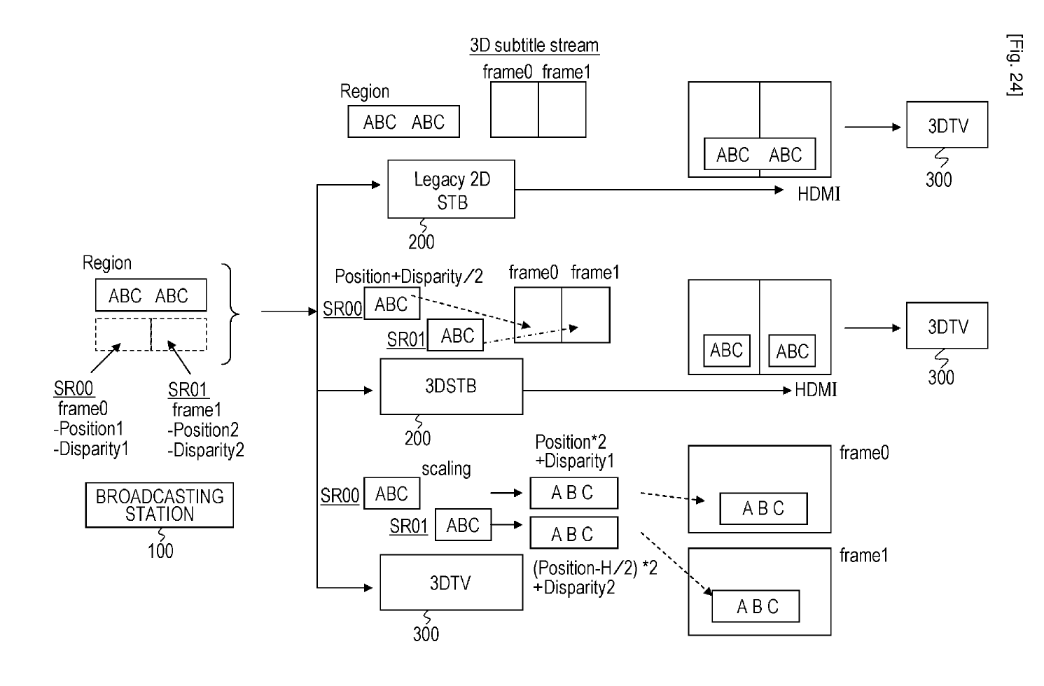

FIG. 23 illustrates a configuration example of disparity information for each base segment period (BSP). In the drawing, updating of disparity information at the edge of a base segment where “skip” has been appended is not performed. Due to the presence of this flag information, in the event that the period where change of disparity information in the frame direction is the same continues for a long time, transmission of the disparity information within the period can be omitted by not updating the disparity information, thereby enabling the data amount of disparity information to be suppressed.

In the event that “disparity_curve_no_update_flag” is“0” and updating of disparity information is to be performed, “shifting_interval_counts” of the corresponding segment is included. On the other hand, in the event that “disparity_curve_no_update_flag” is “1” and updating of disparity information is not to be performed, “disparity_update” of the corresponding segment is not included. The 6-bit field of“shifting_interval_counts” indicates the draw factor (Draw factor) for adjusting the base segment period (updating frame spacings), i.e., the number of subtracted frames.

In the updating example of disparity information for each base segment period (BSP) in FIG. 23, the base segment period is adjusted for the updating timings for the disparity information at points-in-time C through F, by the draw factor (Draw factor). Due to the presence of this adjusting information, the base segment period (updating frame spacings) can be adjusted, and the change in the temporal direction (frame direction) of the disparity information can be informed to the reception side more accurately.

Note that for adjusting the base segment period (updating frame spacings), adjusting in the direction of lengthening by adding frames, besides adjusting in the direction of shortening by the number of subtracting frames as described above. For example, adjusting in both directions can be performed by making the 5-bit field of “shifting_interval_counts” to be an integer with a sign.

The 8-bit field of “disparity_update” indicates disparity information of the corresponding base segment. Note that “disparity_update” where k=0 is the initial value of disparity information sequentially updated at updating frame spacings in the caption display period, i.e., the disparity information of the first frame in the caption display period.

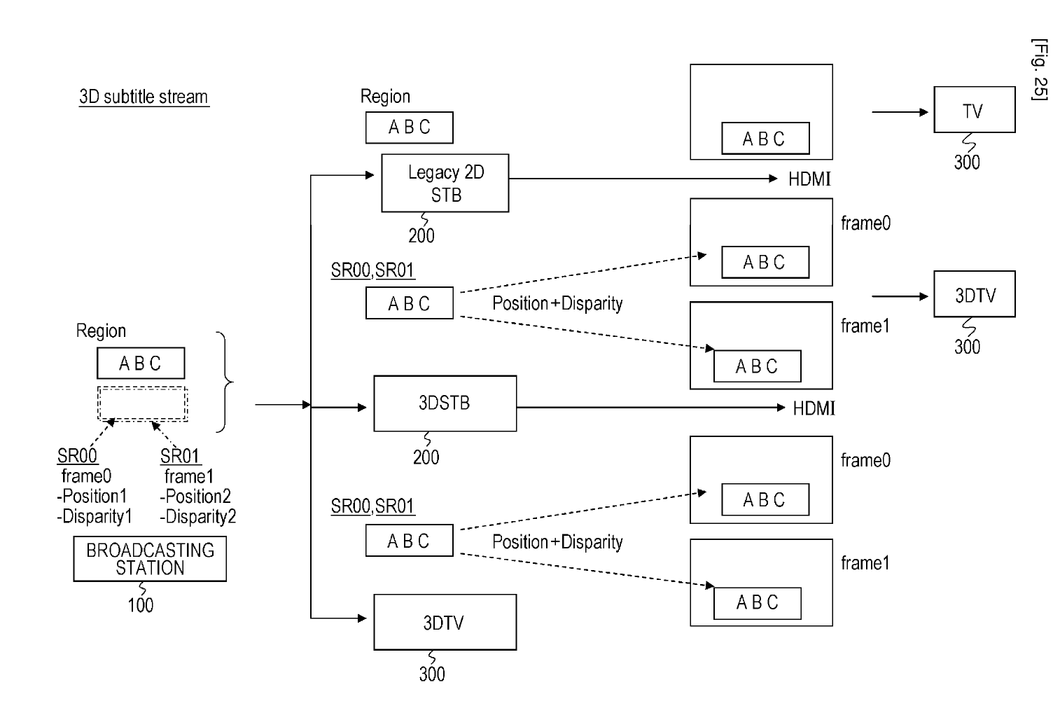

FIG. 24 is a diagram schematically illustrating the flow of stereoscopic image data and subtitle data (including display control information) from the broadcasting station 100 to the television receiver 300 via the set top box 200, or directly from the broadcasting station 100 to the television receiver 300. In this case, subtitle data for stereoscopic images is generated for the side by side (Side-by-Side) format at the broadcasting station 100. The stereoscopic image data is transmitted included in the video data stream, and the subtitle data for stereoscopic images is transmitted included in the subtitle datastream.

First, a case will be described where the stereoscopic image data and subtitle data (including display control information) is sent from the broadcasting station 100 to the set top box 200, and the set top box 200 is a legacy 2D-compatible device (Legacy 2D STB). The set top box 200 generates display data for the region to display the left eye subtitle and right eye subtitle, based on the subtitle data (excluding subregion display control information), superimposes this display data on the stereoscopic image data, and obtains output stereoscopic image data. The superimposing position in this case in the position of the region.

The set top box 200 transmits this output stereoscopic image data to the television receiver 300 via an HDMI digital interface, for example. In this case, the transmission format of the stereoscopic image data from the set top box 200 to the television receiver 300 is the side by side (Side-by-Side) format, for example.

In the event that the television receiver 300 is a 3D-compatible device (3D TV), the television receiver 300 subjects the side by side format stereoscopic image data sent from the set top box 200 to 3D signal processing, and generates left eye image and right eye image data upon which the subtitle is superimposed. The television receiver 300 then displays a binocular disparity image (left eye image and right eye image) on a display panel such as an LCD or the like, for the user to recognize a stereoscopic image.

Next, a case will be described where the stereoscopic image data and subtitle data (including display control information) is sent from the broadcasting station 100 to the set top box 200, and the set top box 200 is a 3D-compatible device (3D STB). The set top box 200 generates display data for the region to display the left eye subtitle and right eye subtitle, based on the subtitle data (excluding subregion display control information). The set top box 200 then extracts display data corresponding to the left eye SR and display data corresponding to the right eye SR from the display data of this region.

The set top box 200 then superimposes this display data corresponding to the left eye SR and right eye SR on the stereoscopic image data, and obtains output stereoscopic image data. In this case, the display data corresponding to the left eye SR is superimposed on the frame portion indicated by frame0 (left eye image frame portion) which is the target frame information of the left eye SR. Also, the display data corresponding to the right eye SR is superimposed on the frame portion indicated by frame1 (right eye image frame portion) which is the target frame information of the right eye SR.

In this case, the display data corresponding to the left eye SR is superimposed at a position obtained by shifting the position of the side by side format stereoscopic image data indicated by Position1 which is the area information of the left eye SR, by half of Disparity1 which is the disparity information of the left eye SR. Also, the display data corresponding to the right eye SR is superimposed at a position obtained by shifting the position of the side by side format stereoscopic image data indicated by Position2 which is the area information of the right eye SR, by half of Disparity2 which is the disparity information of the left eye SR.

The set top box 200 then transmits the output stereoscopic image data thus obtained to the television receiver 300 via an HDMI digital interface, for example. In this case, the transmission format of the stereoscopic image data from the set top box 200 to the television receiver 300 is the side by side (Side-by-Side) format, for example.

In the event that the television receiver 300 is a 3D-compatible device (3D TV), the television receiver 300 subjects the side by side format stereoscopic image data sent from the set top box 200 to 3D signal processing, and generates left eye image and right eye image data upon which the subtitle is superimposed. The television receiver 300 then displays a binocular disparity image (left eye image and right eye image data) on a display panel such as an LCD or the like, for the user to recognize a stereoscopic image.

Next, a case will be described where the stereoscopic image data and subtitle data (including display control information) is sent from the broadcasting station 100 to the television receiver 300, and the television receiver 300 is a 3D-compatible device (3DTV). The television receiver 300 generates display data for the region to display the left eye subtitle and right eye subtitle, based on the subtitle data (excluding subregion display control information). The television receiver 300 then extracts display data corresponding to the left eye SR and display data corresponding to the right eye SR (right eye display data) from the display data of this region.

The television receiver 300 performs double scaling of the display data corresponding to the left eye SR in the horizontal direction to obtain left eye display data corresponding to full resolution. The television receiver 300 then superimposes the full-resolution left eye image data on the frame0 which is the target frame information of the left eye SR. That is to say, the television receiver 300 superimposes the left eye display data on the full resolution left eye image data obtained by scaling the left eye image portion of the side by side format stereoscopic image data to double in the horizontal direction, thereby generating left eye image data on which the subtitle has been superimposed.

The television receiver 300 performs double scaling of the display data corresponding to the right eye SR in the horizontal direction to obtain right eye display data corresponding to full resolution. The television receiver 300 then superimposes the full-resolution right eye image data on the frame1 which is the target frame information of the right eye SR. That is to say, the television receiver 300 superimposes the right eye display data on the full resolution right eye image data obtained by scaling the right eye image portion of the side by side format stereoscopic image data to double in the horizontal direction, thereby generating right eye image data on which the subtitle has been superimposed.

In this case, the left eye display data is superimposed at a position obtained by shifting the position of the full resolution left eye image data of which the Position1 which is region information of the left eye SR is double, by Disparity1 which is the disparity information of the left eye SR. Also, in this case, the right eye display data is- superimposed at a position obtained by shifting the position of the full resolution right eye image data of which the Position2 which is region information of the right eye SR is lessened by H/2 and doubled, by Disparity2 which is the disparity information of the left eye SR.

The television receiver 300 displays a binocular disparity image (left eye image and right eye image data) on a display panel such as an LCD or the like, for the user to recognize a stereoscopic image, based on the left eye image data and right eye image data upon which the generated subtitle has been superimposed, as described above.

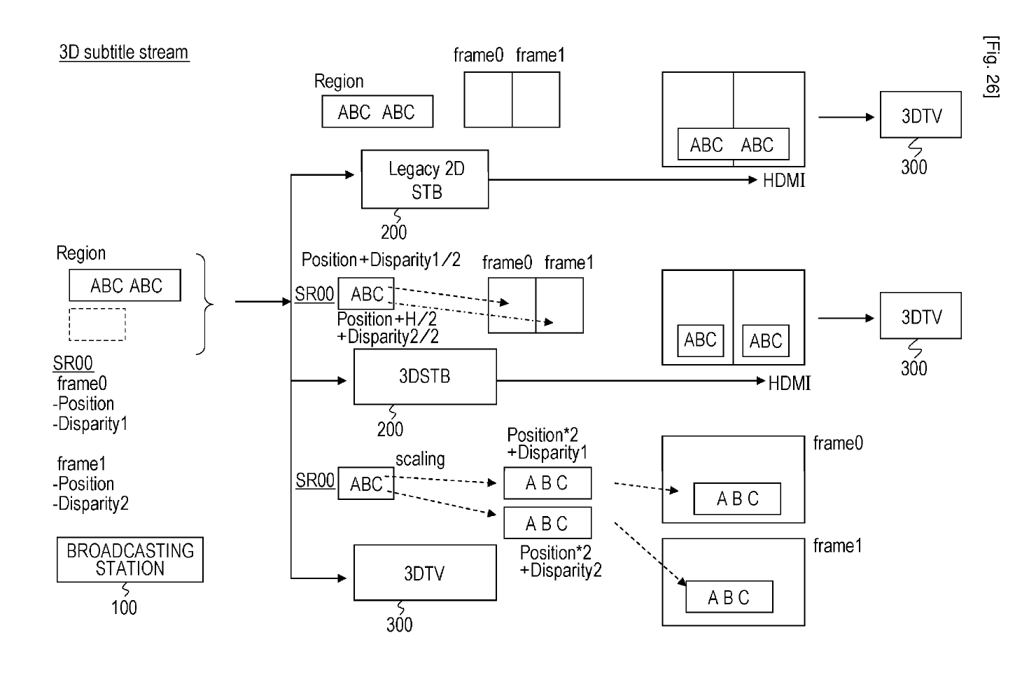

FIG. 25 is a diagram schematically illustrating the flow of stereoscopic image data and subtitle data (including display control information) from the broadcasting station 100 to the television receiver 300 via the set top box 200, or directly from the broadcasting station 100 to the television receiver 300. In this case, subtitle data for stereoscopic images is generated for the MVC (Multi-view Video Coding) format at the broadcasting station 100. In this case, stereoscopic image data is configured of base view image data (left eye image data) and non-base view image data (right eye image data). The stereoscopic image data is transmitted included in the video data stream, and the subtitle data for stereoscopic images is transmitted included in the subtitle data stream.

First, a case will be described where the stereoscopic image data and subtitle data (including display control information) is sent from the broadcasting station 100 to the set top box 200, and the set top box 200 is a legacy 2D-compatible device (Legacy 2D STB). The set top box 200 generates display data for the region to display the left eye subtitle and right eye subtitle, based on the subtitle data (excluding subregion display control information), superimposes this display data on a base view (left eye image data), and obtains output image data. The superimposing position in this case in the position of the region.

The set top box 200 transmits this output image data to the television receiver 300 via an HDMI digital interface, for example. The television receiver 300 displays a 2D image on the display panel regardless of whether a 2D-compatible device (2D TV) or 3D-compatible device (3D TV).

Next, a case will be described where the stereoscopic image data and subtitle data (including display control information) is sent from the broadcasting station 100 to the set top box 200, and the set top box 200 is a 3D-compatible device (3D STB). The set top box 200 generates display data for the region to display the left eye subtitle and right eye subtitle, based on the subtitle data (excluding subregion display control information). The set top box 200 then extracts display data corresponding to the left eye SR and display data corresponding to the right eye SR from the display data of this region.

The set top box 200 then superimposes this display data corresponding to the left eye SR on the image data of the base view (left eye image) indicated by frame0 which is the target frame information of the left eye SR, and obtains output image data of the base view (left eye image) on which the left eye subtitle has been superimposed. In this case, the display data corresponding to the left eye SR is superimposed at a position obtained by shifting the position of the base view (left eye image) image data indicated by Position1 which is the area information of the left eye SR, by Disparity1 which is the disparity information of the left eye SR.

The set top box 200 then superimposes this display data corresponding to the right eye SR on the image data of the non-base view (right eye image) indicated by frame1 which is the target frame information of the right eye SR, and obtains output image data of the non-base view (right eye image) on which the right eye subtitle has been superimposed. In this case, the display data corresponding to the right eye SR is superimposed at a position obtained by shifting the position of the non-base view (right eye image) image data indicated by Position2 which is the area information of the right eye SR, by Disparity2 which is the disparity information of the right eye SR.

The set top box 200 then transmits the image data of the base view (left eye image) and non-base view (right eye image) thus obtained, to the television receiver 300 via an HDMI digital interface, for example. In this case, the transmission format of the stereoscopic image data from the set top box 200 to the television receiver 300 is the frame packing (Frame Packing) format, for example.

In the event that the television receiver 300 is a 3D-compatible device (3D TV), the television receiver 300 subjects the side by side format stereoscopic image data sent from the set top box 200 to 3D signal processing, and generates left eye image and right eye image data upon which the subtitle is superimposed. The television receiver 300 then displays a binocular disparity image (left eye image and right eye image data) on a display panel such as an LCD or the like, for the user to recognize a stereoscopic image.

Next, a case will be described where the stereoscopic image data and subtitle data (including display control information) is sent from the broadcasting station 100 to the television receiver 300, and the television receiver 300 is a 3D-compatible device (3DTV). The television receiver 300 generates display data for the region to display the left eye subtitle and right eye subtitle, based on the subtitle data (excluding subregion display control information). The television receiver 300 then extracts display data corresponding to the left eye SR and display data corresponding to the right eye SR from the display data of this region.

The television receiver 300 superimposes the display data corresponding to the left eye SR on the base view (left eye image) image data indicated by frame0 which is the target frame information of the left eye SR, and obtains base view (left eye image) output image data on which the left eye subtitle has been superimposed. In this case, the display data corresponding to the left eye SR is superimposed at a position where the position of the base view (left eye image) image data indicated by Position1 which is left eye SR area information is shifted by Disparity1 which is disparity information of the left eye SR.

The television receiver 300 superimposes the display data corresponding to the right eye SR on the non-baseview (right eye image) image data indicated by frame1 which is the target frame information of the right eye SR, and obtains non-base view (right eye image) output image data on which the right eye subtitle has been superimposed. In this case, the display data corresponding to the right eye SR is superimposed at a position where the position of the non-base view (right eye image) image data indicated by Position2 which is right eye SR area information is shifted by Disparity2 which is disparity information of the right eye SR.

The television receiver 300 displays a binocular disparity image (left eye image and right eye image data) on a display panel such as an LCD or the like, for the user to recognize a stereoscopic image, based on the base view (left eye image) and non-base view (right eye image) image data upon which the generated subtitle has been superimposed, as described above.

Note that with the above-described, an example has been illustrated in which the display control information of the left eye SR and right eye SR (area information, target frame information, disparity information) are individually created. However, it can be conceived to create display control information for one of the left eye SR and right eye SR, the left eye SR for example. In this case, of the area information, target frame information, and disparity information of the right eye SR area information, the display control information for the left eye SR does not include the area information but includes the target frame information and disparity information.

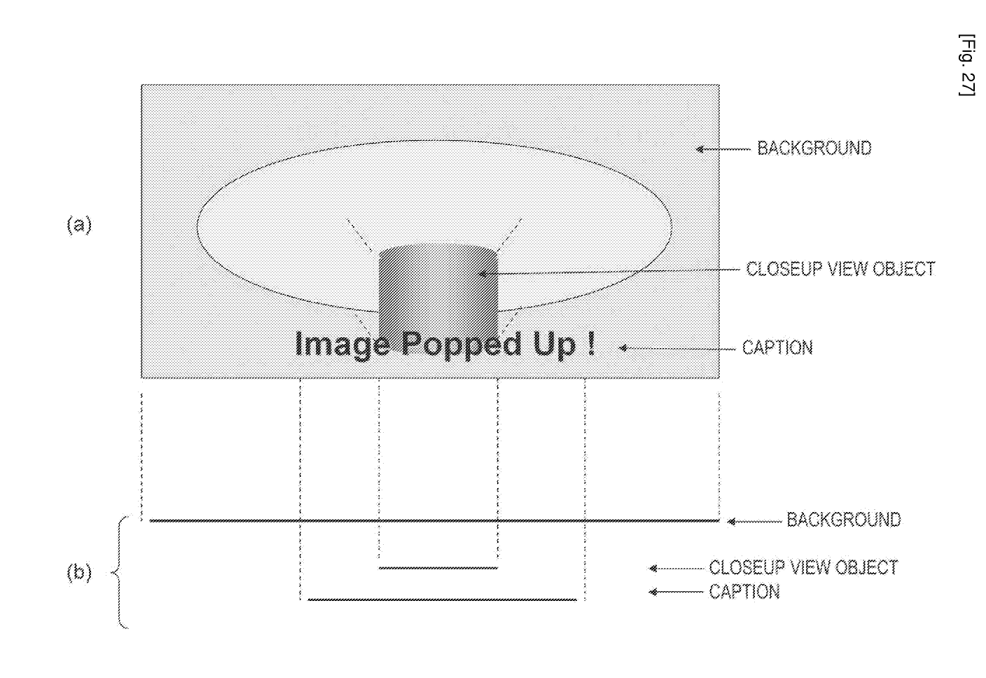

FIG. 26 is a diagram schematically illustrating the flow of stereoscopic image data and subtitle data (including display control information) from the broadcasting station 100 to the television receiver 300 via the set top box 200, or directly from the broadcasting station 100 to the television receiver 300 in this case. In this case, subtitle data for stereoscopic images is generated for the side by side (Side-by-Side) format at the broadcasting station 100. The stereoscopic image data is transmitted included in the video data stream, and the subtitle data for stereoscopic images is transmitted included in the subtitle data stream.

First, a case will be described where the stereoscopic image data and subtitle data (including display control information) is sent from the broadcasting station 100 to the set top box 200, and the set top box 200 is a legacy 2D-compatible device (Legacy 2D STB). The set top box 200 generates display data for the region to display the left eye subtitle and right eye subtitle, based on the subtitle data (excluding subregion display control information), superimposes this display data on the stereoscopic image data, and obtains output stereoscopic image data. The superimposing position in this case in the position of the region.

The set top box 200 transmits this output stereoscopic image data to the television receiver 300 via an HDMI digital interface, for example. In this case, the transmission format of the stereoscopic image data from the set top box 200 to the television receiver 300 is the side by side (Side-by-Side) format, for example.

In the event that the television receiver 300 is a 3D-compatible device (3D TV), the television receiver 300 subjects the side by side format stereoscopic image data sent from the set top box 200 to 3D signal processing, and generates left eye image and right eye image data upon which the subtitle is superimposed. The television receiver 300 then displays a binocular disparity image (left eye image and right eye image data) on a display panel such as an LCD or the like, for the user to recognize a stereoscopic image.

Next, a case will be described where the stereoscopic image data and subtitle data (including display control information) is sent from the broadcasting station 100 to the set top box 200, and the set top box 200 is a 3D-compatible device (3D STB). The set top box 200 generates display data for the region to display the left eye subtitle and right eye subtitle, based on the subtitle data (excluding subregion display control information). The set top box 200 then extracts display data corresponding to the left eye

SR from the display data of this region.

The set top box 200 then superimposes this display data corresponding to the left eye SR on the stereoscopic image data, and obtains output stereoscopic image data. In this case, the display data corresponding to the left eye SR is superimposed on the frame portion indicated by frame0 (left eye frame portion) which is the target frame information of the left eye SR. Also, the display data corresponding to the left eye SR is superimposed on the frame portion indicated by frame1 (right eye frame portion) which is the target frame information of the right eye SR.

In this case, the display data corresponding to the left eye SR is superimposed at a position obtained by shifting the position of the side by side format stereoscopic image data indicated by Position which is the area information of the left eye SR, by half of Disparity1 which is the disparity information of the left eye SR. Also, the display data corresponding to the left eye SR is superimposed at a position obtained by shifting the position of the side by side format stereoscopic image data indicated by Position+H/2 which is area information thereof, by half of Disparity2 which is the disparity information of the right eye SR.

The set top box 200 then transmits the output stereoscopic image data thus obtained to the television receiver 300 via an HDMI digital interface, for example. In this case, the transmission format of the stereoscopic image data from the set top box 200 to the television receiver 300 is the side by side (Side-by-Side) format, for example.

In the event that the television receiver 300 is a 3D-compatible device (3D TV), the television receiver 300 subjects the side by side format stereoscopic image data sent from the set top box 200 to 3D signal processing, and generates left eye image and right eye image data upon which the subtitle is superimposed. The television receiver 300 then displays a binocular disparity image (left eye image and right eye image data) on a display panel such as an LCD or the like, for the user to recognize a stereoscopic image.

Next, a case will be described where the stereoscopic image data and subtitle data (including display control information) is sent from the broadcasting station 100 to the television receiver 300, and the television receiver 300 is a 3D-compatible device (3DTV). The television receiver 300 generates display data for the region to display the left eye subtitle and right eye subtitle, based on the subtitle data (excluding subregion display control information). The television receiver 300 then extracts display data corresponding to the left eye SR from the display data of this region.

The television receiver 300 performs scaling to double of the display data corresponding to the left eye SR in the horizontal direction to obtain left eye display data corresponding to full resolution. The television receiver 300 then superimposes the full-resolution left eye image data on the frame0 which is the target frame information of the left eye SR. That is to say, the television receiver 300 superimposes the left eye display data on the full resolution left eye image data obtained by scaling the left eye image portion of the side by side format stereoscopic image data to double in the horizontal direction, thereby generating left eye image data on which the subtitle has been superimposed.

The television receiver 300 also performs scaling to double of the display data corresponding to the left eye SR in the horizontal direction to obtain right eye display data corresponding to full resolution. The television receiver 300 then superimposes the full-resolution right eye image data on the frame1 which is the target frame information of the right eye SR. That is to say, the television receiver 300 superimposes the right eye display data on the full resolution right eye image data obtained by scaling the right eye image portion of the side by side format stereoscopic image data to double in the horizontal direction, thereby generating right eye image data on which the subtitle has been superimposed.

In this case, the left eye display data is superimposed at a position obtained by shifting the position of the full resolution left eye image data of which the Position which is area information is double, by Disparity1 which is the disparity information. Also, in this case, the right eye display data is superimposed at a position obtained by shifting the position of the full resolution right eye image data of which the Position which is area information is double, by Disparity2 which is the disparity information.

The television receiver 300 displays a binocular disparity image (left eye image and right eye image data) on a display panel such as an LCD or the like, for the user to recognize a stereoscopic image, based on the left eye image data and right eye image data upon which the generated subtitle has been superimposed, as described above.

With the transmission data generating unit 110 shown in FIG. 2, bit stream data BSD output from the multiplexer 119 is a multiplexed data stream including a video data stream and subtitle data stream. The video data stream includes stereoscopic image data. Also, the subtitle data stream includes subtitle data for stereoscopic images (for three-dimensional images) corresponding to the transmission format of the stereoscopic image data.

This subtitle data for stereoscopic images has left eye subtitle data and right eye subtitle data. Accordingly, display data for left eye subtitles to be superimposed on the left eye image data which the stereoscopic image data has, and display data for right eye subtitles to be superimposed on the right eye image data which the stereoscopic image data has, can be readily generated at the reception side. Accordingly, processing becomes easier.

Also, with the transmission data generating unit 110 shown in FIG. 2, the bit stream data BSD output from the multiplexer 119 includes display control information, in addition to stereoscopic image data and subtitle data for stereoscopic images. This display control information includes display control information relating to the left eye SR and right eye SR (area information, target frame information, disparity information).

Accordingly, at the reception side, superimposed display of just the left eye subtitles within the left eye SR and subtitles within the right eye SR on the target frame is easy. The display positions of the left eye subtitles within the left eye SR and subtitles within the right eye SR can be provided with disparity, so consistency in perspective between the objects in the image regarding which subtitles (captions) are being displayed can be maintained in an optimal state.

Also, with the transmission data generating unit 110 shown in FIG. 2, the subtitle processing unit 116 can transmit SCS segments including disparity information which is sequentially updated in the subtitle display period, so the display position of left eye-subtitles within the left eye SR and right eye subtitles within the right eye SR can be dynamically controlled. Accordingly, at the reception side, disparity provided between left eye subtitles and right eye subtitles can be dynamically changed in conjunction with change in the contents of the image.

Also, with the transmission data generating unit 110 shown in FIG. 2, the disparity information included in the SCS segments created at the subtitle processing unit 116 is made up of disparity information of the first frame in the subtitle display period, and—disparity information of frames at each updating frame spacing thereafter. Accordingly, the amount of data transmitted can be reduced, and the memory capacity for holding the disparity information at the reception side can be greatly conserved.

Also, with the transmission data generating unit 110 shown in FIG. 2, the disparity information of the frames at each updating frame spacing included in the SCS segments created at the subtitle processing unit 116 is not an offset value from the previous disparity information but disparity information itself. Accordingly, even if an error occurs in the process of interpolation at the reception side, the error can be recovered from within a certain delay time.

Also, with the transmission data generating unit 110 shown in FIG. 2, the disparity information included in the SCS segments created at the subtitle processing unit 116 is of integer pixel precision. Accordingly, difference in performance from one receiver to another does not readily occur, so there is no difference over time between different receivers. Alco, there is freedom in interpolation between updating frames according to the capabilities of the receivers, so there is freedom in designing receivers.

“Description of Set Top Box”

Returning to FIG. 1, the set top box 200 receives bit stream data (transport stream) BSD transmitted over broadcast waves from the broadcasting station 100. This bit stream data BSD includes stereoscopic image data including left eye image data and right eye image data, and audio data. This bit stream data BSD also includes subtitle data (including display control information) for stereoscopic images to display subtitles (captions).

The set top box 200 includes a bitstream processing unit 201. This bit stream processing unit 201 extracts stereoscopic image data, audio data, and subtitle data, from the bit stream data BSD. This bit stream processing unit 201 uses the stereoscopic image data, audio data, and subtitle data and so forth, to generate stereoscopic image data with subtitles superimposed.

In this case, disparity can be provided between the left eye subtitles to be superimposed on the left eye image and right eye subtitles to be superimposed on the right eye image. For example, as described above, subtitle data for stereoscopic images—transmitted from the broadcasting station 100 can be generated with disparity provided between left eye subtitles and right eye subtitles. Also, as described above, the display control information added to the subtitle data for stereoscopic images transmitted from the broadcasting station 100 includes disparity information, and disparity can be provided between the left eye subtitles and right eye subtitles based on this disparity information. Thus, by providing disparity between the left eye subtitles and right eye-subtitles, the user can recognize the subtitles (captions) to be closer than the image.

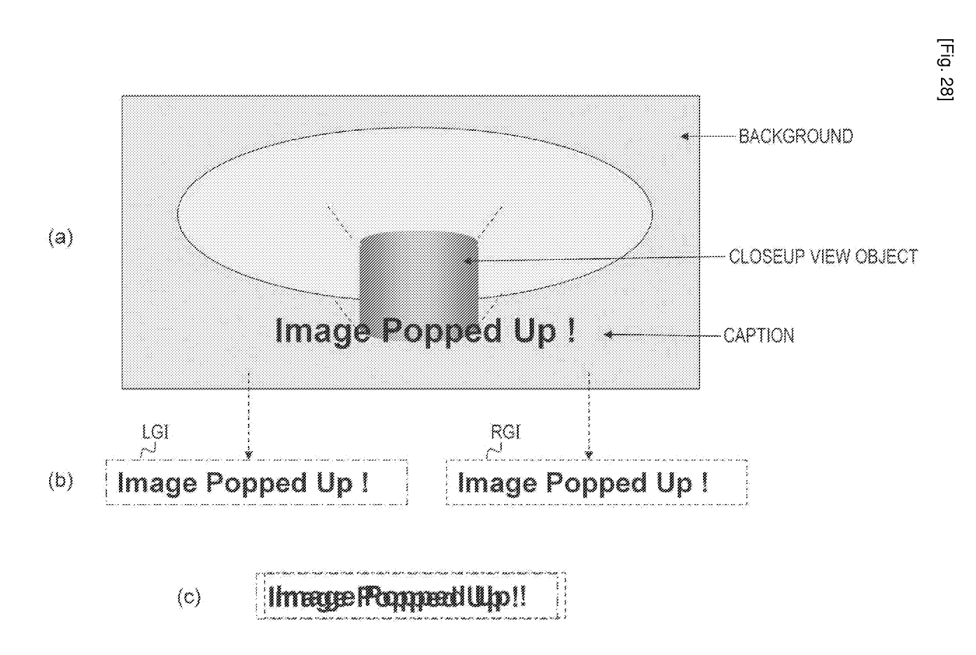

FIG. 27(a) illustrates a display example of a subtitle (caption) on an image. This display example is an example wherein a caption is superimposed on an image made up of background and a closeup object. FIG. 27(b) illustrates perspective of the background, closeup object, and caption, of which the caption is recognized as the nearest.

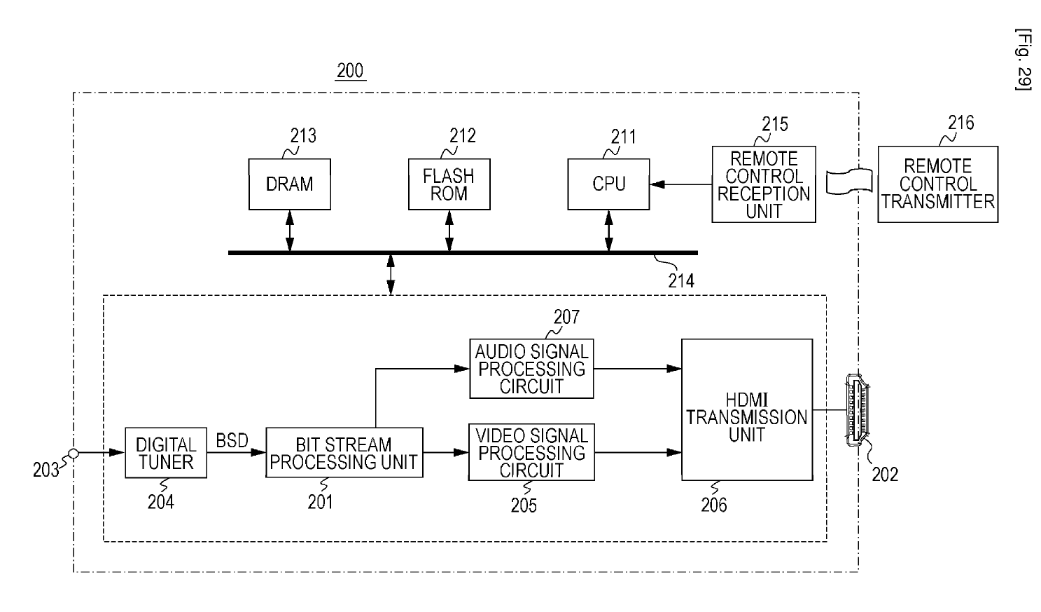

FIG. 28(a) illustrates a display example of a subtitle (caption) on an image, the same as with FIG. 27(a). in FIG. 28(b) illustrates a left eye caption LGI to be superimposed on a left eye image and a right eye subtitle RGI to be superimposed on a right eye image. FIG. 28(c) illustrates that disparity is given between the left eye caption LGI and the right eye caption RGI so that the caption will be recognized as being closest.

“Configuration Example of Set Top Box”

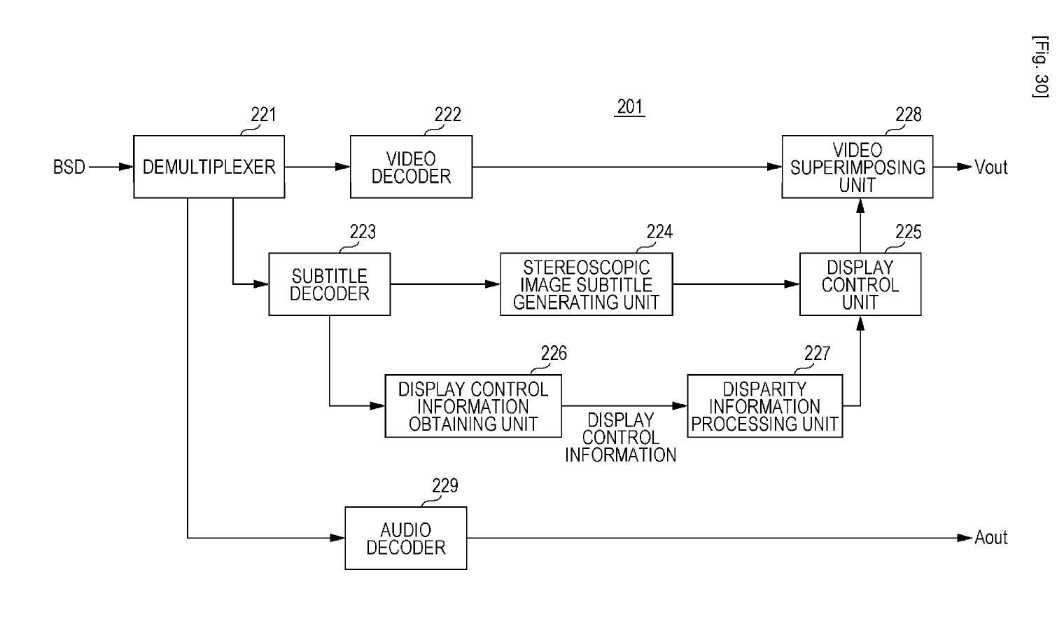

A configuration example of the set top box 200 will be described. FIG. 29 illustrates a configuration example of the set top box 200. This set top box 200 includes a bitstream processing unit 201, an HDMI terminal 202, an antenna terminal 203, a digital tuner 204, a video signal processing circuit 205, an HDMI transmission unit 206, and an audio signal processing circuit 207. Also, this set top box 200 includes a CPU 211, flash ROM 212, DRAM 213, an internal bus 214, a remote control reception unit 215, and a remote control transmitter 216.

The antenna terminal 203 is a terminal for inputting television broadcasting signal received at a reception antenna (not illustrated). The digital tuner 204 processes the television broadcasting signal input to the antenna terminal 203, and outputs predetermined bit stream data (transport stream) BSD corresponding to the user's selected channel.

The bit stream processing unit 201 extracts stereoscopic image data, audio data, subtitle data for stereoscopic images (including display control information) and so forth from the bit stream data BSD. The bit stream processing unit 201 outputs audio data. This bit stream processing unit 201 also synthesizes the display data the left eye subtitles and right eye subtitles as to the stereoscopic image data to obtain output stereoscopic image data with subtitles superimposed. The display control information includes area information for the left eye SR and right eye SR, target frame information, and disparity information.

In this case, the bit stream processing unit 201 generates display data for the region for displaying the left eye subtitles and right eye subtitles, based on the subtitle data (excluding display control information for subregions). The bit stream processing unit 201 then extracts display data corresponding to the left eye SR and display data corresponding to the right eye SR based on the area information of the left eye SR and right eye SR from the display data of this region.

The bit stream processing unit 201 then superimposes the display data corresponding to the left eye SR and right eye SR on the stereoscopic image data, and obtains output stereoscopic image data (stereoscopic image data for display). In this case, the display data corresponding to the left eye SR is superimposed on the frame portion (left eye image frame portion) indicated by frame0 which is the target frame information of the left eye SR. Also, the display data corresponding to the right eye SR is superimposed on the frame portion (right eye image frame portion) indicated by frame1 which is the target frame information of the right eye SR. At this time, the bit stream processing unit 201 performs shift adjustment of the subtitle display position (superimposing position) of the left eye subtitles within the left eye SR and right eye subtitles within the right eye SR.

The video signal processing circuit 205 subjects the output stereoscopic image data obtained at the bitstream processing unit 201 to image quality adjustment processing according to need, and supplies the output stereoscopic image data after processing thereof to the HDMI transmission unit 206. The audio signal processing circuit 207 subjects the audio data output from the bit stream processing unit 201 to audio quality adjustment processing according to need, and supplies the audio data after processing thereof to the HDMI transmission unit 206.

The HDMI transmission unit 206 transmits, by communication conforming to HDMI, uncompressed image data and audio data for example, from the HDMI terminal 202. In this case, since the data is transmitted by an HDMI TMDS channel, the image data and audio data are subjected to packing, and are output from the HDMI transmission unit 206 to the HDMI terminal 202.

For example, in the event that the transmission format of the stereoscopic image data from the broadcasting station 100 is the side by side format, the TMDS transmission format is the side by side format (see FIG. 24). Also, in the event that the transmission format of the stereoscopic image data from the broadcasting station 100 is the top and bottom format, the TMDS transmission format is the top and bottom format. Also, in the event that the transmission format of the stereoscopic image data from the broadcasting station 100 is the MVC format, the TMDS transmission format is the frame packing format (see FIG. 25).

The CPU 211 controls the operation of each unit of the set top box 200. The flash ROM 212 performs storage of control software, and storage of data. The DRAM 213 configures the work area of the CPU 211. The CPU 211 loads the software and data readout from the flash ROM 212 to the DRAM 213, and starts up the software to control each unit of the set top box 200.

The remote control reception unit 215 receives a remote control signal (remote control code) transmitted from the remote control transmitter 216, and supplies to the CPU 211. The CPU 211 controls each unit of the set top box 200 based on this remote control code. The CPU 211, flash ROM 212, and DRAM 213 are connected to the internal bus 214.

The operation of the set top box 200 will briefly be described. The television broadcasting signal input to the antenna terminal 203 is supplied to the digital tuner 204. With this digital tuner 204, the television broadcasting signal is processed, and predetermined bit stream data (transport stream) BSD corresponding to the user's selected channel is output.

The bit stream data BSD output from the digital tuner 204 is supplied to the bit stream processing unit 201. With this bit stream processing unit 201, stereoscopic image data, audio data, subtitle data for stereoscopic images (including display control information), and so forth, are extracted from the bit stream data BSD. At the bit stream processing unit 201, the display data of the left eye subtitles and right eye subtitles (bitmap data) is synthesized as to the stereoscopic image data, and output stereoscopic image data with subtitles superimposed thereon is obtained.

The output stereoscopic image data generated at the bit stream processing unit 201 is supplied to the video signal processing circuit 205. At this video signal processing circuit 205, image quality adjustment and the like is performed on the output stereoscopic image data as necessary. The output stereoscopic image data following—processing that is output from the video signal processing circuit 205 is supplied to the HDMI transmission unit 206.

Also, the audio data obtained at the bit stream processing unit 201 is supplied to the audio signal processing circuit 207. At the audio signal processing circuit 207, the audio data is subjected to audio quality adjustment processing according to need. The audio data after processing that is output from the audio signal processing circuit 207 is supplied to the HDMI transmission unit 206. The stereoscopic image data and audio data supplied to the HDMI transmission unit 206 are transmitted from the HDMI terminal 202 to the HDMI cable 400 by an HDMI TMDS channel.

“Configuration Example of Bit Stream Processing Unit”

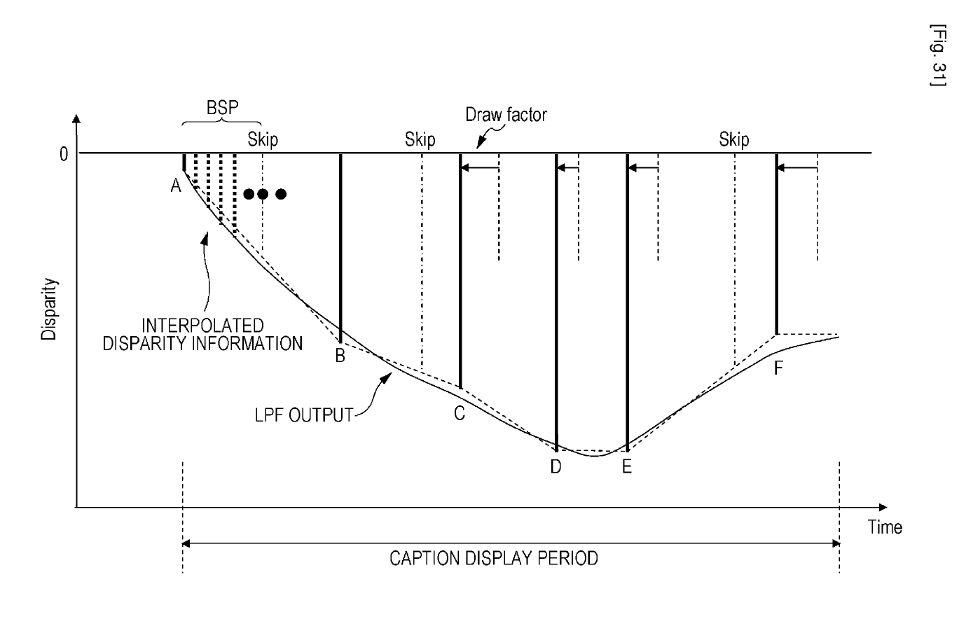

FIG. 30 illustrates a configuration example of the bit stream processing unit 201. This bitstream processing unit 201 is configured to correspond to the above transmission data generating unit 110 shown in FIG. 2. This bit stream processing unit 201 includes a demultiplexer 221, a video decoder 222, and an audio decoder 229. Also, the bit stream processing unit 201 includes a subtitle decoder 223, a stereoscopic image subtitle generating unit 224, a display control unit 225, a display control information obtaining unit 226, a disparity information processing unit 227, and a video superimposing unit 228.

The demultiplexer 221 extracts the packets for video, audio, and subtitles, from the bit stream data BSD, and sends to the decoders. Note that the demultiplexer 221 extracts information such as PMT, EIT, and so forth inserted in the bit stream data BSD, and sends to the CPU 211. AS described above, Stream_content (‘0x03’=DVBsubtitles) & Component_type (for 3D target) is described in the component descriptor beneath the EIT. Accordingly, the fact that subtitle data for stereoscopic images is included in the subtitle data stream can be recognized. Accordingly, the CPU 211 can recognize by this description that subtitle data for stereoscopic images is included in the subtitle data stream.

The video decoder 222 performs processing opposite to that of the video encoder 112 of the transmission data generating unit 110 described above. That is to say, the video datastream is reconstructed from the video packets extracted at the demultiplexer 221, and decoding processing is performed to obtain stereoscopic image data including left eye image data and right eye image data. The transmission format for this stereoscopic image data is, for example, the side by side format, top and bottom format, frame sequential format, MVC format, or the like.

The subtitle decoder 223 performs processing opposite to that of the subtitle encoder 118 of the transmission data generating unit 110 described above. That is to say, this subtitle decoder 223 reconstructs the subtitle data stream from the packets of the- subtitles extracted at the demultiplexer 221, performs decoding processing, and obtains subtitle data for stereoscopic images (including display control information). The stereoscopic image subtitle generating unit 224 generates display data (bitmap data) of the left eye subtitles and right eye subtitles to be superimposed on the stereoscopic image data, based on the subtitle data for stereoscopic images (excluding display control information). This stereoscopic image subtitle generating unit 224 configures an display data generating unit.

The display control unit 225 controls display data to be superimposed on the stereoscopic image data, based on the display control information (left eye SR and right eye SR area information, target frame information, and disparity information). That is to say, the display control unit 225 extracts display data corresponding to the left eye SR and display data corresponding to the right eye SR from the display data (bitmap data) of the left eye subtitles and right eye subtitles to be superimposed on the stereoscopic image data, based on the area information of the left eye SR and right eye SR.

Also, the display control unit 225 supplies the display data corresponding to the left eye SR and right eye SR to the video superimposing unit 228, and superimposes on the stereoscopic image data. In this case, the display data corresponding to the left eye SR is superimposed in the frame portion indicated by frame0 which is target frame information of the left eye SR (left eye image frame portion). Also, the display data corresponding to the right eye SR is superimposed in the frame portion indicated by frame1 which is target frame information of the right eye SR (right eye image frame portion). At this time, the display control unit 225 performs shift adjustment of the display position (superimposing position) of the left eye subtitles within the left eye SR and right eye subtitles within the right eye SR based on the disparity information, so as to provide disparity between the left eye subtitles and right eye subtitles.

The display control information obtaining unit 226 obtains the display control information (area information, target frame information, and disparity information) from the subtitle datastream. This display control information includes the disparity information used in common during the caption display period (see “subregion_disparity” in FIG. 18). Also, this display control information may include the disparity information sequentially updated during the caption display period (see “disparity_update” in FIG. 21). The disparity information sequentially updated during the caption display period is made up of disparity information of the first frame in the subtitle display period, and disparity information of frames at each updating frame spacing thereafter (updating frame spacings).

The disparity information processing unit 227 transmits the area information and target frame information included in the display control information, and further, the disparity information used in common during the caption display period, to the display control unit 225 without any change. On the other hand, with regard to the disparity information sequentially updated during the caption display period, the disparity information processing unit 227 generates disparity information at an arbitrary frame spacing during the caption display period, e.g., one frame spacing, and transmits this to the display control unit 225.

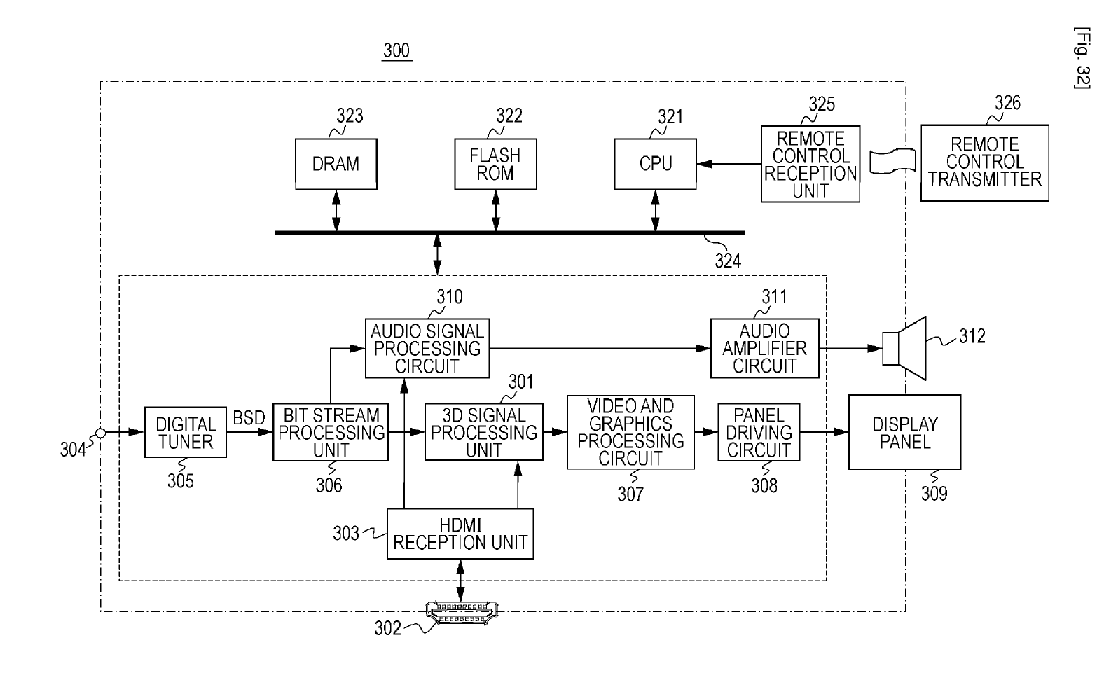

The disparity information processing unit 227 performs interpolation processing involving low-pass filter (LIP) processing in the temporal direction (frame direction) for this interpolation processing, rather than linear interpolation processing, so that the change in disparity information at predetermined frame spacings following the interpolation processing will be smooth in the temporal direction (frame direction). FIG. 31 illustrates an example of interpolation processing involving the aforementioned LPF processing at the disparity information processing unit 227. This example corresponds to the updating example of disparity information in FIG. 23 described above.

Now, in the event that only disparity information (disparity vectors) used in common during the caption display period is sent from the disparity information processing unit 227, the display control unit 225 uses this disparity information. Also, in the event that disparity information sequentially updated during the caption display period is also further sent from the disparity information processing unit 227, the disparity information processing unit 227 uses one or the other.

Which to use is constrained by information (“rendering_level” indicating the level of correlation of disparity information (disparity) that is essential at the reception side (decoder) side for displaying captions, included in the extended display control data unit. In this case, in the event of “00” for example, user settings as applied. Using disparity information sequentially updated during the caption display period enables disparity to be applied to the left eye subtitles and right eye subtitles to be dynamically changed in conjunction with changes in the contents of the image.

The video superimposing unit 228 obtains output stereoscopic image data Vout. In this case, the video superimposing unit 228 superimposes the display data (bitmap data) of the left eye SR and right eye SR that has been subjected to shift adjustment by the display control unit 225, on the stereoscopic image data obtained at the video decoder 222 at the corresponding target frame portion. The video superimposing unit 228 then externally outputs the output stereoscopic image data Vout from the bit stream processing unit 201.

Also, the audio decoder 229 performs processing the opposite from that of the audio encoder 113 of the transmission data generating unit 110 described above. That is to say, the audio decoder 229 reconstructs the audio elementary stream from the audio packets extracted at the demultiplexer 221, performs decoding processing, and obtains audio data Aout. The audio decoder 229 then externally outputs the audio data Aout from the bit stream processing unit 201.

The operations of the bit stream processing unit 201 shown in FIG. 30 will be briefly described. The bitstream data BSD output from the digital tuner (see FIG. 29) is supplied to the demultiplexer 221. At the demultiplexer 221, packets of video, audio, and subtitles are extracted from the bit stream data BSD, and supplied to the decoders.

The video data stream from the video packets extracted at the demultiplexer 221 is reconstructed at the video decoder 222, and further subjected to decoding processing, thereby obtaining stereoscopic image data including the left eye image data and right eye image data. This stereoscopic image data is supplied to the display control information obtaining unit 226.

Also, at the subtitle decoder 223, the subtitle data stream is reconstructed from the subtitle packets extracted at the demultiplexer 221, and further decoding processing is performed, thereby obtaining subtitle data for stereoscopic images (including display control information). This subtitle data is supplied to the stereoscopic image subtitle generating unit 224.

At the stereoscopic image subtitle generating unit 224, display data (bitmap data) of left eye subtitles and right eye subtitles to be superimposed on the stereoscopic image data is generated based on the subtitle data for stereoscopic images (excluding display control information). This display data is supplied to the display control unit 225.

Also, at the display control information obtaining unit 226, display control information (area information, target frame information, and disparity information) is obtained from the subtitle data stream. This display control information is supplied to the display control unit 225 by way of the disparity information processing unit 227. At this time, the disparity information processing unit 227 performs the following processing with regard to the disparity information sequentially updated during the caption display period. That is to say, interpolation processing involving LPF processing in the temporal direction (frame direction) is performed at the disparity information processing unit 227, thereby generating disparity information at an arbitrary frame spacing during the caption display period, e.g., one frame spacing, which is then transmitted to the display control unit 225.

At the display control unit 225, superimposing of display data as to the stereoscopic image data is controlled based on the display control information (area information of left eye SR and right eye SR, target frame information, and disparity information). That is to say, the display data of the left eye SR and the right eye SR is extracted from the display data generated at the stereoscopic image subtitle generating unit 224, and subjected to shift adjustment. Subsequently, the shift-adjusted display data of the left eye SR and the right eye SR is supplied to the video superimposing unit 228 so as to be superimposed on the target frame of the stereoscopic image data.

At the video superimposing unit 228, the display data shift adjusted at the display control unit 225 is superimposed onto the stereoscopic image data obtained at the video decoder 222, thereby obtaining output stereoscopic image data Vout. This output-stereoscopic image data Vout is externally output from the bit stream processing unit 201.

Also, at the audio decoder 229, the audio elementary stream is reconstructed from the audio packets extracted at the demultiplexer 221, and further decoding processing is performed, thereby obtaining audio data Aout corresponding to the stereoscopic image data Vout for display that has been described above. This audio data Aout is externally output from the bit stream processing unit 201.

With the set top box 200 shown in FIG. 29, the bit stream data BSD output from the digital tuner 204 is a multiplexed data stream having a video data stream and subtitle datastream. The video data stream includes stereoscopic image data. Also, the subtitle data stream includes subtitle data for stereoscopic image data (for three-dimensional images) corresponding to the transmission format of the stereoscopic image data.

This subtitle data for stereoscopic images has data for left eye subtitles and data for right eye subtitles. Accordingly, the stereoscopic image subtitle generating unit 224 of the bitstream processing unit 201 can easily generate display data for left eye subtitles to be superimposed on the left eye image data which the stereoscopic image data has. Also, the stereoscopic image subtitle generating unit 224 of the bit stream processing unit 201 can easily generate display data for right eye subtitles to be superimposed on the right eye image data which the stereoscopic image data has. Thus, processing can be made easier.

Also, with the set top box 200 shown in FIG. 29, the bit stream data BSD output from the digital tuner 204 includes, in addition to the stereoscopic image data and subtitle data for stereoscopic images, display control information. This display control information includes display control information (area information, target frame information, and disparity information) relating to the left eye SR and right eye SR. Accordingly, performing superimposed display of left eye subtitles within the left eye SR and subtitles within the right eye SR alone upon the respective target frames is easy. Also, disparity can be provided to the display positions of the left eye subtitles within the left eye SR and subtitles within the right eye SR, so consistency in perspective between the objects in the image regarding which subtitles (captions) are being displayed can be maintained in an optimal state.

Also, with the set top box 200 shown in FIG. 29, in the event that disparity information sequentially updated within the caption display period is included display control information obtained at the display control information obtaining unit 226 of the bitstream processing unit 201, the display control unit 225 can dynamically control the display positions of the left eye subtitles within the left eye SR and the right eye subtitles within the right eye SR. Accordingly, disparity applied to the left eye subtitles and right eye subtitles can be dynamically changed in conjunction with changes in the contents of the image.

Also, with the set top box 200 shown in FIG. 29, interpolation processing is performed on disparity information of multiple frames making up the disparity information sequentially updated within the caption display period (period of predetermined number of frames). In this case, even in the event that disparity information is transmitted from the transmission side at each updating frame spacing, the disparity to be provided between the left eye subtitles and right eye subtitles can be controlled at fine spacings, e.g., every frame.

Also, with the set top box 200 shown in FIG. 29, the interpolation processing at the disparity information processing unit 227 of the bit stream processing unit 201 is performed involving low-pass filter processing in the temporal direction (frame direction). Accordingly, even in the event that disparity information is transmitted from the transmission side at each updating frame spacing, change of the disparity information following interpolation direction in the temporal direction can be smoothed, and an unnatural sensation of the transition of disparity applied between the left eye subtitles and right eye subtitles becoming discontinuous at each updating frame spacing can be suppressed.

“Description of Television Receiver”

Returning to FIG. 1, the television receiver 300 receives stereoscopic image data transmitted from the set top box 200 via the HDMI cable 400. This television receiver 300 includes a 3D signal processing unit 301. This 3D signal processing unit 301 subjects the stereoscopic image data to processing (decoding processing) corresponding to the transmission method to generate left eye image data and right eye image data.

“Configuration Example of Television Receiver”

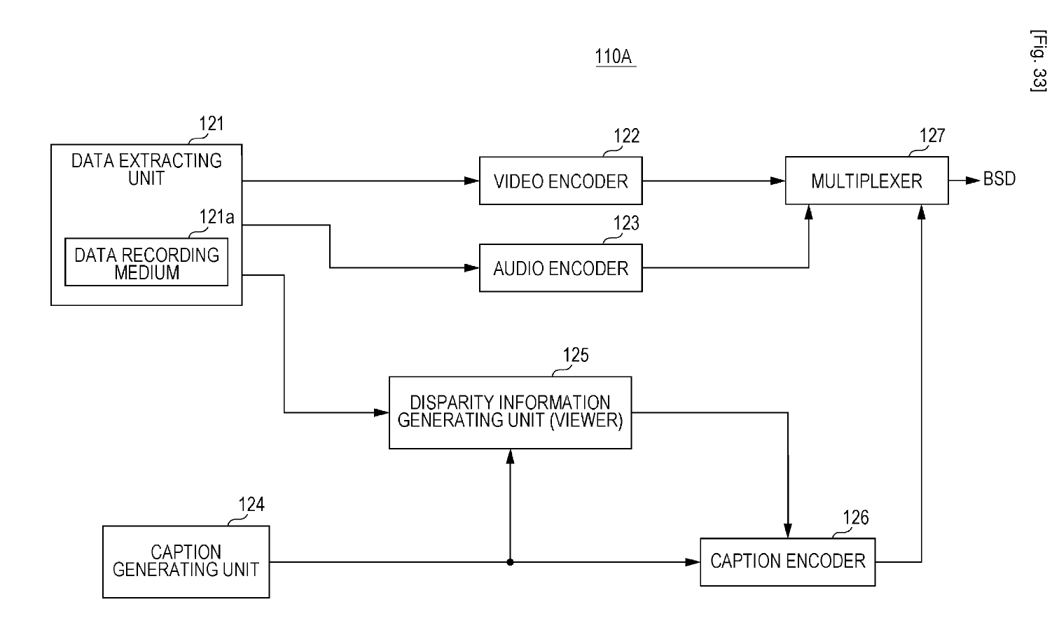

A configuration example of the television receiver 300 will be described. FIG. 32 illustrates a configuration example of the television receiver 300. This television receiver 300 includes a 3D signal processing unit 301, an HDMI terminal 302, an HDMI reception unit 303, an antenna terminal 304, a digital tuner 305, and a bit stream processing unit 306.

Also, this television receiver 300 includes a video and graphics processing circuit 307, a panel driving circuit 308, a display panel 309, an audio signal processing circuit 310, an audio amplifier circuit 311, and a speaker 312. Also, this television receiver 300 includes a CPU 321, flash ROM 322, DRAM 323, internal bus 324, a remote control reception unit 325, and a remote control transmitter 326.

The antenna terminal 304 is a terminal for inputting a television broadcasting signal received at a reception antenna (not illustrated). The digital tuner 305 processes the television broadcasting signal input to the antenna terminal 304, and outputs predetermined bit stream data (transport stream) corresponding to the user's selected channel. The bit stream processing unit 306 extracts stereoscopic image data, audio data, subtitle data for stereoscopic image display (including display control information), and so forth, from the bitstream data BSD.

Also, the bit stream processing unit 306 is configured in the same way as with the bit stream processing unit 201 of the set top box 200. This bit stream processing unit 306 synthesizes the display data of left eye subtitles and right eye subtitles onto stereoscopic image data, so as to generate output stereoscopic image data with- subtitles superimposed thereupon, and outputs. Note that in the event that the transmission format of the stereoscopic image data is, for example, the side by side format or the top and bottom format, the bit stream processing unit 306 performs scaling processing and outputs left eye image data and right eye image data of full resolution (see the portion of the television receiver 300 in FIG. 24 through FIG. 26). Also, the bit stream processing unit 306 outputs audio data.

The HDMI reception unit 303 receives uncompressed image data and audio data supplied to the HDMI terminal 302 via the HDMI cable 400 by communication conforming to HDMI. This HDMI reception unit 303 of which the version is, for example, HDMI 1.4a, is in a state in which the stereoscopic image data can be handled.

The 3D signal processing unit 301 subjects the stereoscopic image data received at the HDMI reception unit 303 to decoding processing and generates full-resolution left eye image data and right eye image data. The 3D signal processing unit 301 performs decoding processing corresponding to the TMDS transmission data format. Note that the 3D signal processing unit 301 does not do anything to full-resolution left eye image data and right eye image data obtained at the bit stream processing unit 306.

The video and graphics processing circuit 307 generates image data for displaying a stereoscopic image based on the left eye image data and right eye image data generated at the 3D signal processing unit 301. Also, the video and graphics processing circuit 307 subjects the image data to image quality adjustment processing according to need. Also, the video and graphics processing circuit 307 synthesizes the data of superposition information, such as menus, program listings, and so forth, as to the image data according to need. The panel driving circuit 308 drives the display panel 309 based on the image data output from the video and graphics processing circuit 307. The display panel 309 is configured of, for example, an LCD (Liquid Crystal Display), PDP (Plasma Display Panel), or the like.

The audio signal processing circuit 310 subjects the audio data received at the HDMI reception unit 303 or obtained at the bit stream processing unit 306 to necessary processing such as D/A conversion or the like. The audio amplifier circuit 311 amplifies the audio signal output from the audio signal processing circuit 310, supplies to the speaker 312.

The CPU 321 controls the operation of each unit of the television receiver 300. The flash ROM 322 performs storing of control software and storing of data. The DRAM 323 makes up the work area of the CPU 321. The CPU 321 loads the software and data read out from the flash ROM 322 to the DRAM 323, starts up the software, and- controls each unit of the television receiver 300. The remote control unit 325 receives the remote control signal (remote control code) transmitted from the remote control transmitter 326, and supplies to the CPU 321. The CPU 321 controls each unit of the television receiver 300 based on this remote control code. The CPU 321, flash ROM 322, and DRAM 323 are connected to the internal bus 324.

The operations of the television receiver 300 illustrated in FIG. 32 will briefly be described. The HDMI reception unit 303 receives the stereoscopic image data and audio data transmitted from the set top box 200 connected to the HDMI terminal 302 via the HDMI cable 400. This stereoscopic image data received at this HDMI reception unit 303 is supplied to the 3D signal processing unit 301. Also, the audio data received at this HDMI reception unit 303 is supplied to the audio signal processing unit 310.

The television broadcasting signal input to the antenna terminal 304 is supplied to the digital tuner 305. With this digital tuner 305, the television broadcasting signal is processed, and predetermined bit stream data (transport stream) BSD corresponding to the user's selected channel is output.

The bit stream data BSD output from the digital tuner 305 is supplied to the bit stream processing unit 306. With this bit stream processing unit 306, stereoscopic image data, audio data, subtitle data for stereoscopic images (including display control information), and so forth are extracted from the bit stream data. Also, with this bit stream processing unit 306, display data of left eye subtitles and right eye subtitles is synthesized and output stereoscopic image data with subtitles superimposed (full-resolution left eye image data and right eye image data) is generated. This output stereoscopic image data is supplied to the video and graphics processing circuit 307 via the 3D signal processing unit 301.

With the 3D signal processing unit 301, the stereoscopic image data received at the HDMI reception unit 303 is subjected to decoding processing, and full-resolution left eye image data and right eye image data are generated. The left eye image data and right eye image data are supplied to the video and graphics processing circuit 307. With this video and graphics processing circuit 307, image data for displaying a stereoscopic image is generated based on the left eye image data and right eye image data, and image quality adjustment processing, and synthesizing processing of superimposed information data such as OSD (on-screen display) is also performed according to need.

The image data obtained at this video and graphics processing circuit 307 is supplied to the panel driving circuit 308. Accordingly, a stereoscopic image is displayed on the display panel 309. For example, a left image according to left eye image data, and a right image according to right eye image data are alternately displayed in a time-sharing manner. The viewer can view the left eye image alone by the left eye, and the right eye image alone by the right eye, and consequently can sense the stereoscopic image by wearing shutter glasses wherein the left eye shutter and right eye shutter are alternately opened in sync with display of the display panel 309.

Also, the audio data obtained at the bit stream processing unit 306 is supplied to the with the audio signal processing circuit 310. At the audio signal processing circuit 310, the audio data received at the HDMI reception unit 303 or obtained at the bitstream processing unit 306 is subjected to necessary processing such as D/A conversion or the like. This audio data is amplified at the audio amplifier circuit 311, and then supplied to the speaker 312. Accordingly, audio corresponding to the display image of the display panel 309 is output from the speaker 312.

“Other Configuration of Transmission Data Generating Unit and Bit Stream Processing Unit (1)” “Configuration Example of Transmission Data Generating Unit”

FIG. 33 illustrates a configuration example of a transmission data generating unit 110A of the broadcasting station 100 (see FIG. 1). This transmission data generating unit 110A transmits disparity information (disparity vectors) with a data structure readily compatible with the ARIB (Association of Radio Industries and Businesses) format which is an already-existing broadcasting standard. The transmission data-generating unit 110A includes a data extracting unit (archiving unit) 121, a video encoder 122, an audio encoder 123, a caption generating unit 124, a disparity information creating unit 125, a caption encoder 126, a caption encoder 168, and a multiplexer 127.

A data recording medium 121a is, for example detachably mounted to the data extracting unit 121. This data recording medium 121a has recorded therein, along with stereoscopic image data including left eye image data and right eye image data, audio data and disparity information, in a correlated manner, in the same way with the data recording medium 111a in the data extracting unit 111 of the transmission data-generating unit 110 shown in FIG. 2. The data extracting unit 121 extracts, from the data recording medium 121a, the stereoscopic image data, audio data, disparity information, and so forth. The data recording medium 121a is a disc-shaped recording medium, semiconductor memory, or the like.

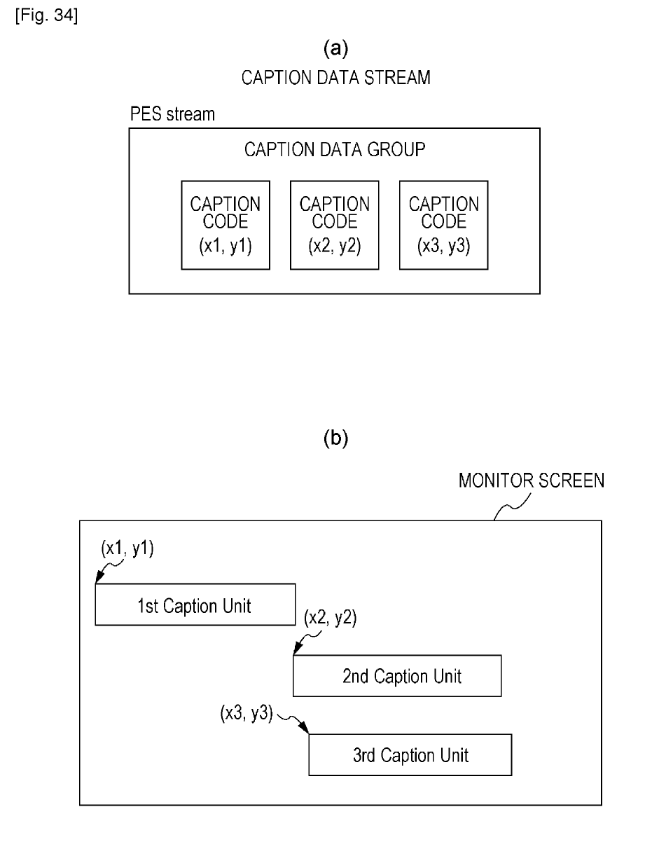

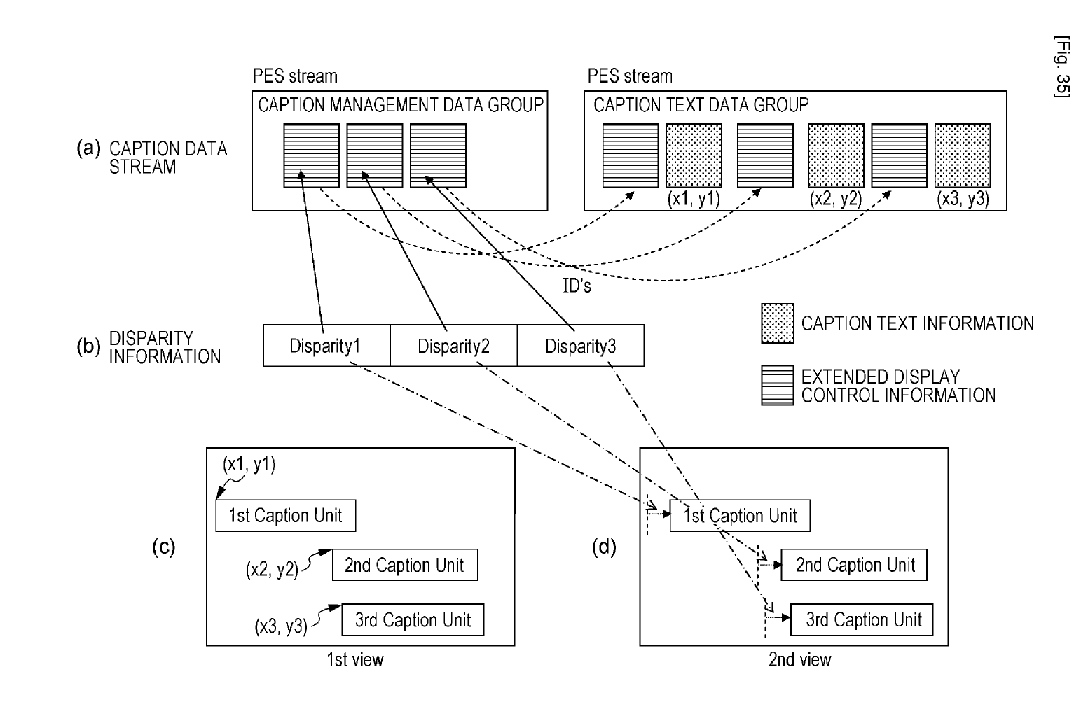

Returning to FIG. 33, the caption generating unit 124 generates caption data (ARIB format caption text data). The caption encoder 126 generates a caption data stream (caption elementary stream) including caption data generated at the caption generating unit 124. FIG. 34(a) illustrates a configuration example of a caption data stream. This example illustrates an example in which three caption units (captions) of “1st Caption Unit”, “2nd Caption Unit”, and “3rd Caption Unit” are displayed on the same screen as shown in FIG. 34(b).

Caption data of each caption unit is inserted into caption stream data as caption text data (caption code) of a caption text group. Note that while not shown in the drawings, setting data such as display region of the caption units and so forth is inserted in the caption data stream as data of the caption management data group. The display regions of the captions units of “1st Caption Unit”, “2nd Caption Unit”, and “3rd Caption Unit” are indicated by (x1, y1), (x2, y2), and (x3, y3), respectively.

The disparity information creating unit 125 has a viewer function. This disparity information creating unit 125 subjects the disparity information output from the data extracting unit 121, i.e., the disparity vectors for each pixel (pixel), to downsizing-processing, and generates disparity vectors belonging to a predetermined area. The disparity information creating unit 125 performs the same downsizing processing as the disparity information creating unit 115 of the transmission data generating unit 110 shown in FIG. 2 described above, though detailed description thereof will be omitted.

The disparity information creating unit 125 creates disparity vectors corresponding to a predetermined number of caption units (captions) displayed on the same screen, by way of the above-described downsizing processing. In this case, the disparity information creating unit 125 either creates disparity vectors for each caption unit (individual disparity vectors), or creates a disparity vector shared between the caption units (common disparity vector). The selection thereof is by user settings, for example.

In the event of creating individual disparity vectors, the disparity information creating unit 125 obtains the disparity vector belonging to that display region by the above-described downsizing processing, based on the display region of each caption unit. Also, in the event of creating a common vector, the disparity information creating unit 125 obtains the disparity vectors of the entire picture (entire image) by the above-described downsizing processing (see FIG. 9(d)). Note that an arrangement may be made where, in the event of creating a common vector, the disparity information creating unit 125 obtains disparity vectors belonging to the display area of each caption unit and selects the disparity vector with the greatest value.

As described above, the caption encoder 126 includes the disparity vector (disparity information) created at the disparity information creating unit 125 as described above in the caption data stream. In this case, the caption data of each caption unit displayed in the same screen is inserted in the caption data stream into the PES stream of the caption text data group, as caption text data (caption code). Also, disparity vectors (disparity information) is inserted in this caption data stream, into the PES stream of the caption management data of PES stream of caption text data group, as display control information for the captions.

Description will be made regarding a case where individual disparity vectors are to be created with the disparity information creating unit 125, and disparity vectors (disparity information) are to be inserted in the PES stream of the caption management data. Here, we will consider an example where three caption units (captions) of“1st Caption Unit”, “2nd Caption Unit”, and “3rd Caption Unit” are displayed on the same screen.

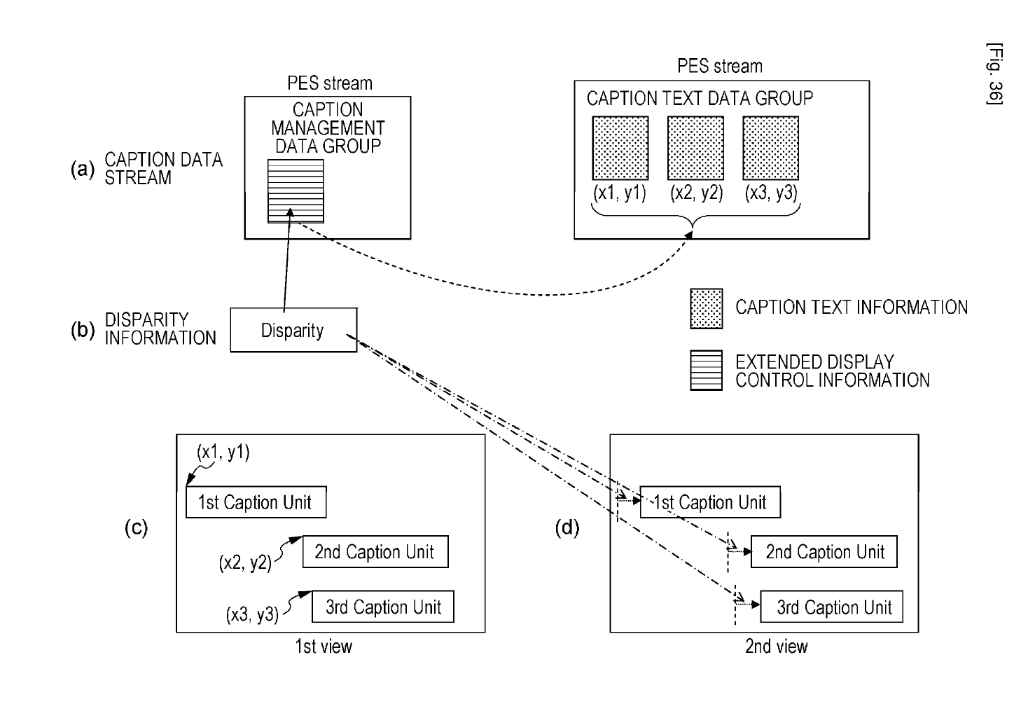

As shown in FIG. 35(b), the disparity information creating unit 125 creates individual disparity vectors corresponding to the caption units. “Disparity 1” is an individual disparity vector corresponding to “1st Caption Unit”. “Disparity 2” is an individual disparity vector corresponding to “2nd Caption Unit”. “Disparity 3” is an individual disparity vector corresponding to “3rd Caption Unit”.

FIG. 35(a) illustrates a configuration example of a caption data stream (PES stream) generated at the caption encoder 126. The PES stream of the caption data group has inserted therein caption text information of each caption unit, and extended display control information (data unit ID) correlated with each caption text information. Also, the PES stream of the caption management data group has inserted therein extended display control information (disparity information) correlated to the caption text information of each caption unit.

The extended display control information (data unit ID) of the caption text data group is necessary to correlate each extended display control information (disparity information) of the caption management data group with each caption text information of the caption text data group. In this case, disparity information serving as each extended display control information of the caption management data group is individual disparity vectors of the corresponding caption units. Note that though not shown in the drawings, setting data of the display area of each caption unit is inserted in the PES stream of the caption management data group as caption management data (control code). The display areas of the captions units of “1st Caption Unit”, “2nd Caption Unit”, and “3rd Caption Unit” are indicated by (x1, y1), (x2, y2), and (x3,y3), respectively.

FIG. 35(c) illustrates a first view (1st View) upon which each caption unit (caption) has been superimposed, aright eye image for example. Also, FIG. 35(d) illustrates a second view (2nd View) upon which each caption unit (caption) has been super imposed, a left eye image for example. The individual disparity vectors corresponding to the caption units are used to provide disparity between the caption units superimposed on the right eye image and the caption units superimposed on the left eye image, for example.

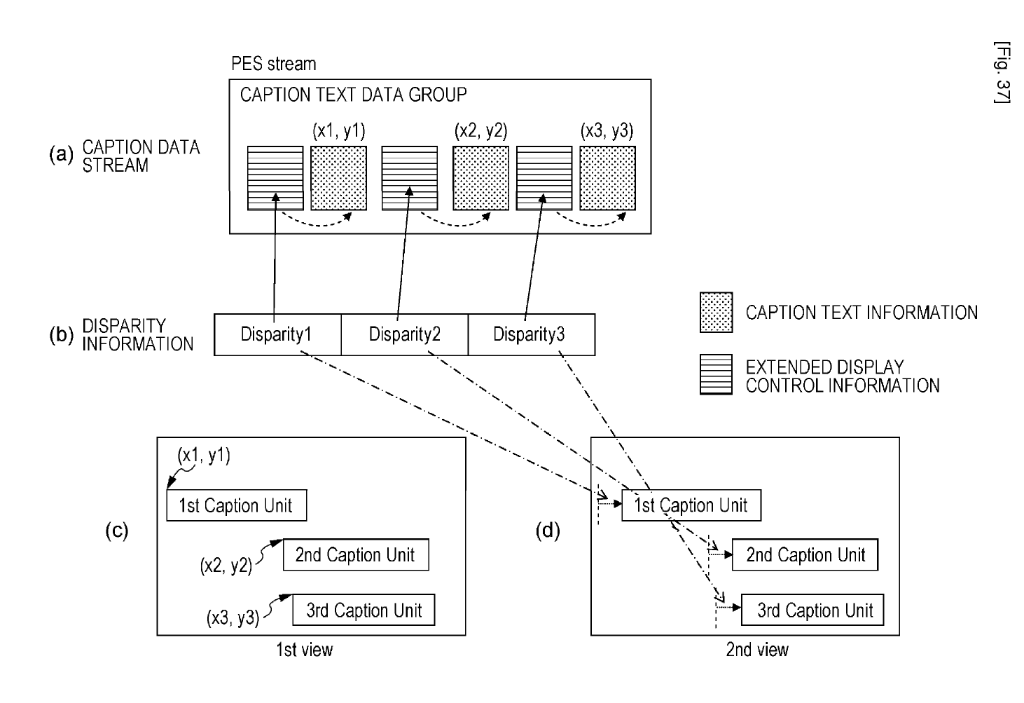

Description will be made regarding a case where a common disparity vector is to be created with the disparity information creating unit 125, and the disparity vector (disparity information) is to be inserted in the PES stream of the caption management data. Here, we will consider an example where three caption units (captions) of “1st Caption Unit”, “2nd Caption Unit”, and “3rd Caption Unit” are displayed on the same screen. As shown in FIG. 36(b), the disparity information creating unit 125 creates a common disparity vector shared by the caption units.

FIG. 36(a) illustrates a configuration example of the caption data stream (PES stream) generated at the caption encoder 126. The PES stream of the caption data group has inserted therein caption text information of each caption unit. Also, the PES stream of the caption management data group has inserted therein extended display control information (disparity information) correlated in common to the caption text information of each caption unit. In this case, the disparity information serving as the extended display control information of the caption management data group is the shared disparity vector of each caption unit.

Note that though not shown in the drawings, setting data of the display area and so forth of each caption unit is inserted in the PES stream of the caption management data group as caption management data (control code). The display areas of the captions units of “1st Caption Unit”, “2nd Caption Unit”, and “3rd Caption Unit” are indicated by (x1, y1), (x2, y2), and (x3, y3), respectively.

FIG. 36(c) illustrates a first view (1st View) upon which each caption unit (caption) has been superimposed, aright eye image for example. Also, FIG. 36(d) illustrates a second view (2nd View) upon which each caption unit (caption) has been superimposed, a left eye image for example. The common disparity vector shared between the caption units is used to provide disparity between the caption units superimposed on the right eye image and the caption units superimposed on the left eye image, for example.

Next, description will be made regarding a case where individual disparity vectors are to be created with the disparity information creating unit 125, and disparity vectors (disparity information) are to be inserted in the PES stream of the caption text data group. Here, we will consider an example where three caption units (captions) of“1st Caption Unit”, “2nd Caption Unit”, and “3rd Caption Unit” are displayed on the same screen.

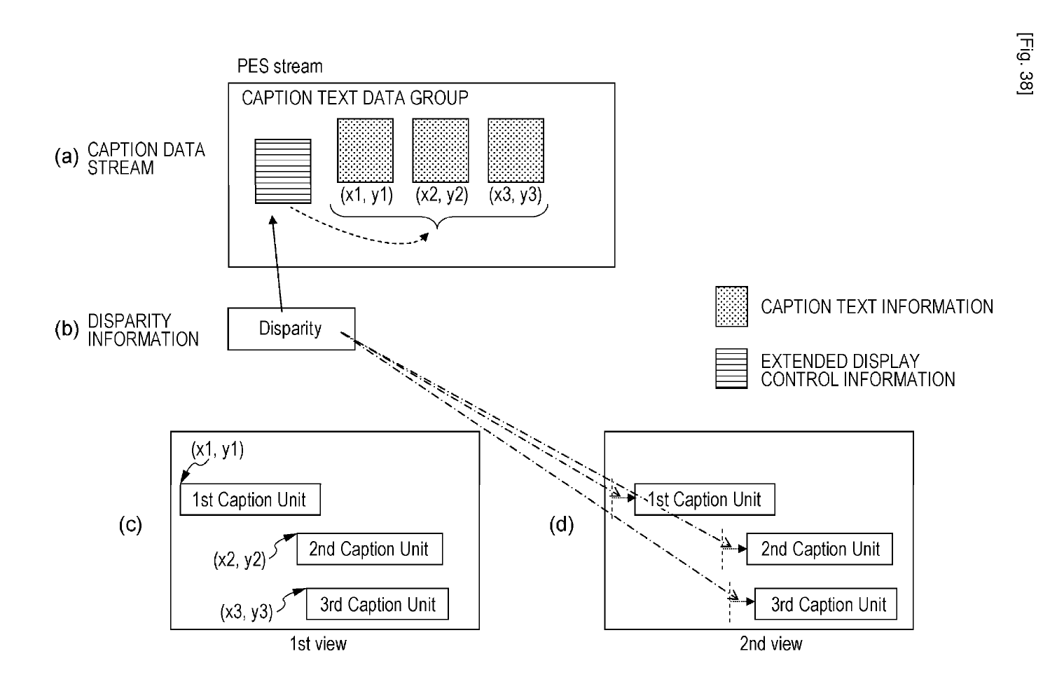

As shown in FIG. 37(b), the disparity information creating unit 125 creates individual disparity vectors corresponding to the caption units. “Disparity 1” is an individual disparity vector corresponding to “1st Caption Unit”. “Disparity 2” is an individual disparity vector corresponding to“2nd Caption Unit”. “Disparity 3” is an individual disparity vector corresponding to “3rd Caption Unit”.

FIG. 37(a) illustrates a configuration example of a PES stream of a caption text data group out of caption data streams (PES streams) generated at the caption encoder 126. The PES stream of the caption text data group has inserted therein caption text information (caption text data) of each caption unit. Also, display control information (disparity information) corresponding to the caption text information of each caption unit is inserted therein. In this case, the disparity information serving as each display control information is the individual disparity vectors created at the disparity information creating unit 125 as described above.

Note that though not shown in the drawings, setting data of the display area and so forth of each caption unit is inserted in the PES stream of the caption management data group as caption management data (control code). The display areas of the captions units of “1st Caption Unit”, “2nd Caption Unit”, and “3rd Caption Unit” are indicated by (x1, y1), (x2, y2), and (x3, y3), respectively.

FIG. 37(c) illustrates a first view (1st View) upon which each caption unit (caption) has been superimposed, aright eye image for example. Also, FIG. 37(d) illustrates a second view (2nd View) upon which each caption unit (caption) has been superimposed, a left eye image for example. The individual disparity vectors corresponding to the caption units are used to provide disparity between the caption units superimposed on the right eye image and the caption units superimposed on the left eye image, for example.

Description will be made regarding a case where a common disparity vector is to be created with the disparity information creating unit 125, and the disparity vector (disparity information) is to be inserted in the PES stream of the caption management data. Here, we will consider an example where three caption units (captions) of “1st Caption Unit”, “2nd Caption Unit”, and “3rd Caption Unit” are displayed on the same screen. As shown in FIG. 38(b), the disparity information creating unit 125 creates a common disparity vector“Disparity” shared by the caption units.

FIG. 38(a) illustrates a configuration example of the caption data stream (PES stream) generated at the caption encoder 126. The PES stream of the caption data group has inserted therein caption text information (caption text data) of each caption unit. Also, the PES stream of the caption text data group has inserted therein display control information (disparity information) correlated in common to the caption text information of each caption unit. In this case, the disparity information serving as the display control information is the shared disparity vector created at the disparity information creating unit 125 as described above.

Note that though not shown in the drawings, setting data of the display area and so forth of each caption unit is inserted in the PES stream of the caption management data group as caption management information (control code). The display areas of the captions units of “1st Caption Unit”, “2nd Caption Unit”, and “3rd Caption Unit” are indicated by (x1, y1), (x2, y2), and (x3, y3), respectively.

FIG. 38(c) illustrates a first view (1st View) upon which each caption unit (caption) has been superimposed, aright eye image for example. Also, FIG. 38(d) illustrates a second view (2nd View) upon which each caption unit (caption) has been superimposed, a left eye image for example. The common disparity vector shared between the caption units is used to provide disparity between the caption units superimposed on the right eye image and the caption units superimposed on the left eye image, for example.

Note that the examples in FIGS. 35(c) and (d), FIG. 36(c) and (d), FIG. 37(c) and (d), and FIG. 38(c) and (d), involve shifting only the positions of the caption units to be superimposed on the second view (e.g., left eye image). However, there may be conceived cases of shifting only the positions of the caption units to be superimposed on the first view (e.g., right, eye image), or shifting the positions of the caption units to be superimposed on both views.

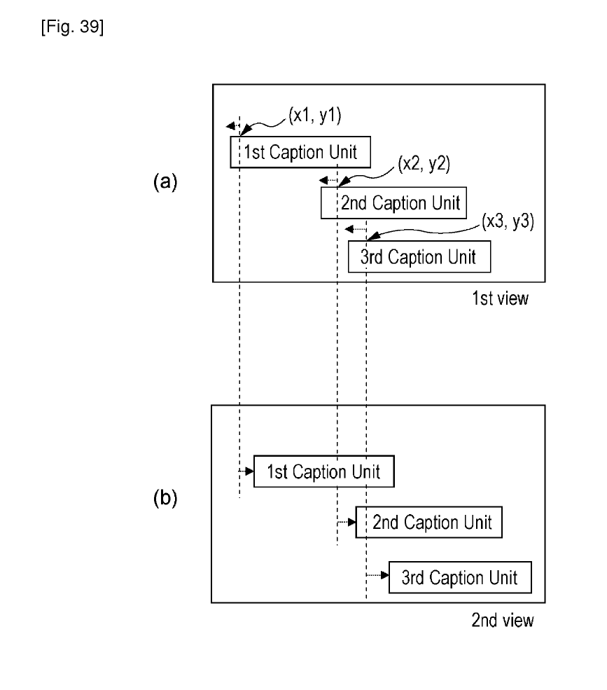

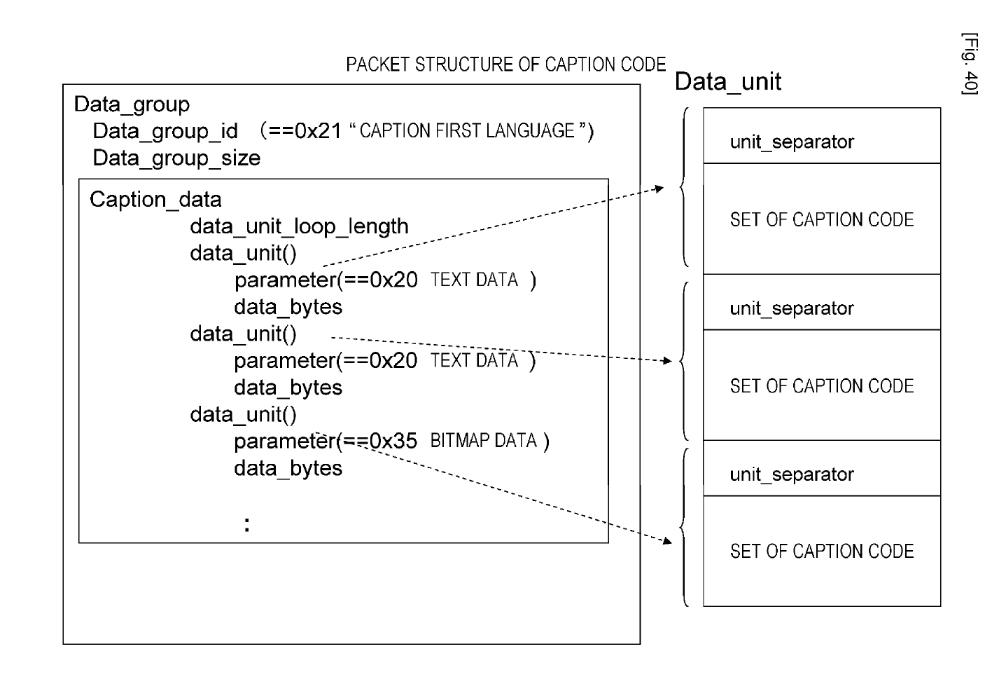

FIG. 39(a) and (b) illustrates a case of shifting the positions of the caption units to be superimposed on both the first view and second view. In this case, the shift values (offset values) D[i] of the caption units at the first view and second view are obtained as follows from the value “disparity[i]” of the disparity vector corresponding to the caption units.

That is to say, in the event that disparity[i] is an even number, with the first view this is obtained as“D[i]=-disparity[i]/2”, and with the second view this is obtained as “D[i]=disparity[i]/2”. Accordingly, the position of the caption units to be superimposed on the first view is shifted to the left by“disparity[i]/2”. Also, the position of the caption units to be superimposed on the second view is shifted to the right by“disparity[i]/2”.

Also, in the event that disparity[i] is an odd number, with the first view this is obtained as“D[i]=-(disparity[i]+1)/2”, and with the second view this is obtained as “D[i]=(disparity[i]−1)/2”. Accordingly, the position of the caption units to be superimposed on the first view is shifted to the left by “(disparity[i]+1)/2”. Also, the position of the caption units to be superimposed on the second view is shifted to the right by“(disparity[i]−1)/2”.

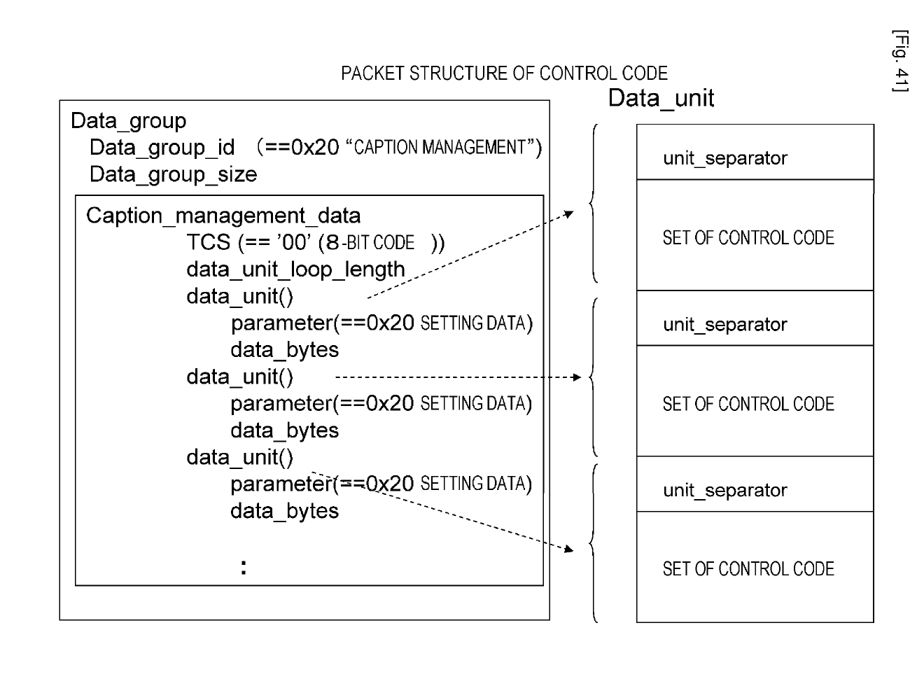

Now, the packet structure of caption code and control will be briefly described. First, the basic packet structure of caption code included in the PES stream of a caption text data group will be described. FIG. 40 illustrates the packet structure of caption code. “Data_group_id” indicates a data group identification, and here indicates that this is a caption text data group. Note that “Data_group_id” which indicates a caption text data group further identifies language. For example, “Data_group_id==0x21” indicates that this is a caption text data group, and is caption text (first language).

“Data_group_size” indicates the number of bytes of the following data group data. In the event of a caption text data group, this data group data is caption text data (caption_data). One data unit or more is disposed in the caption text data. Each data unit is separated by data unit separator code (unit_parameter). Caption code is disposed as data unit data (data_unit_data) within each data unit.

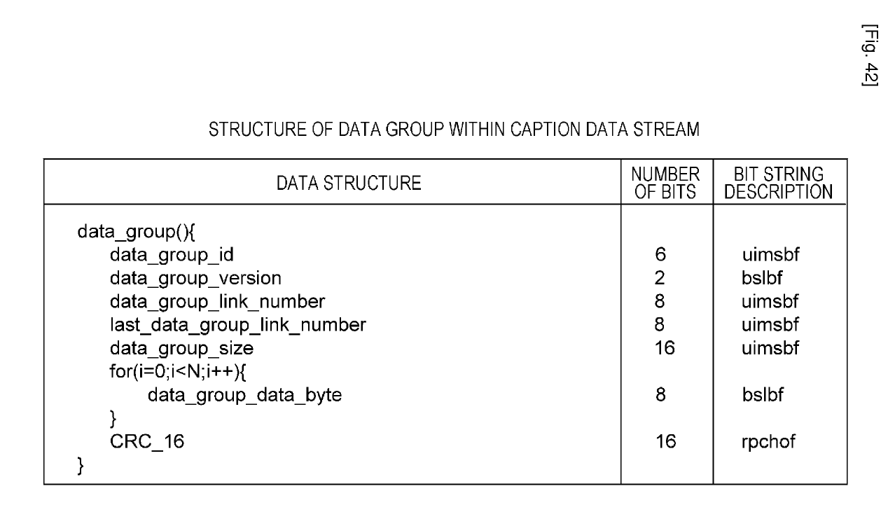

Next, description will be made regarding the packet structure of control code. FIG. 41 illustrates the packet structure of control code included in the PES stream of a caption-management data group. “Data_group_id” indicates data group identification. Here this indicates that this is a caption management data group, and is “Data_group_id==0x20”. “Data_group_size” indicates the number of bytes of the following data group data. In the event of a caption management data group, this data group data is caption management data (caption_management_data).

One data unit or more is disposed in the caption text data. Each data unit is separated by data unit separator code (unit_parameter). Control code is disposed as data unit data (data_unit_data) within each data unit. With this embodiment, the value of a disparity vector is provided as 8-bit code. “TCS” is 2-bit data, indicating the character encoding format. Here, “TCS=\” is set, indicating 8-bit code.

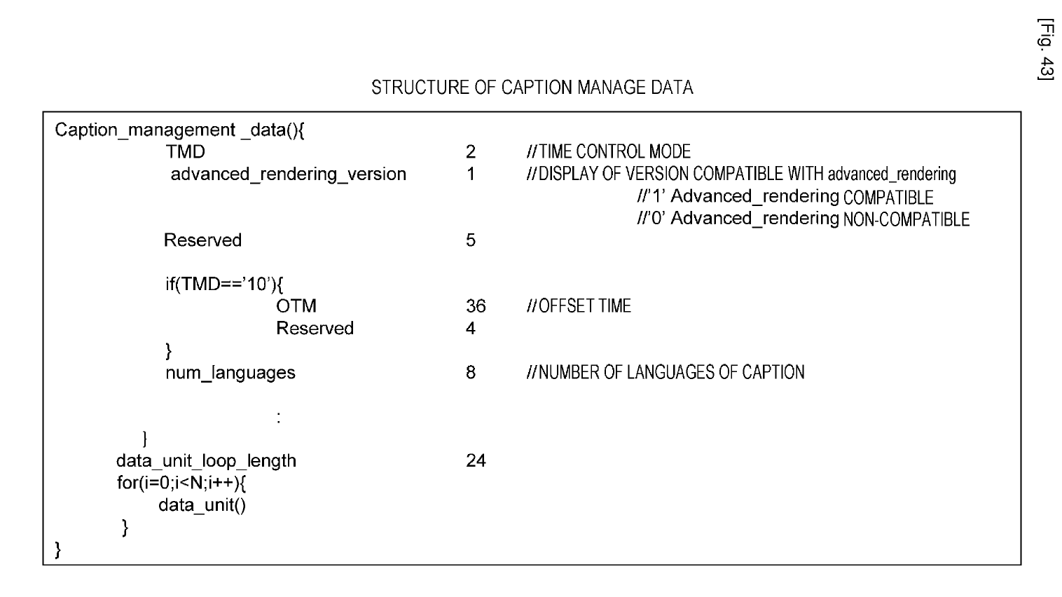

FIG. 42 illustrates the structure of a data group within a caption data stream (PES stream). The 6-bit field of “data_group_id” indicates the data group identification, identifying the type of caption management data or caption text data. The 16-bit field of “data_group_size” indicate the number of bytes of the following data group data in this data group field. The data group data is stored in “data_group_data_byte”. “CRC_{—}16” is 16-bit cyclic redundancy check code. The encoding section of this CRC code is from the head of the “data group_id” to the end of the“data_group_data_byte”.

In the event of a caption management data group, the “data_group_data_byte” in the data group structure in FIG. 42 is caption management data (caption_management_data). Also, in the event of a caption text data group, the“data_group_data_byte” in the data group structure in FIG. 42 is caption management data (caption_data).

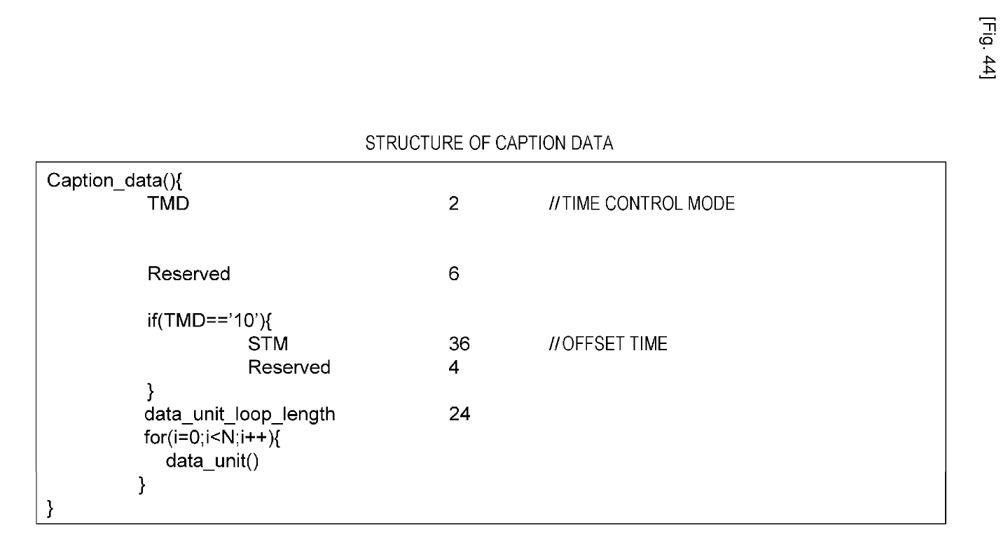

FIG. 43 is a diagram schematically illustrating the structure of caption management data in a case of a disparity vector (disparity information) being inserted within a PES stream of caption management data. “advanced_rendering_version” is 1-bit flag information indicating whether or not compatible with extended display of caption, which is newly defined with this embodiment. At the reception side, whether or not compatible with extended display of caption can be easily comprehended, based on the flag information situated in the layer of management information in this way. The 24-bit field of“data_unit_loop_length” indicates the number of bytes of the following data group data in this caption management data field. The data unit to be transmitted with this caption management data field is stored in “data_unit”.

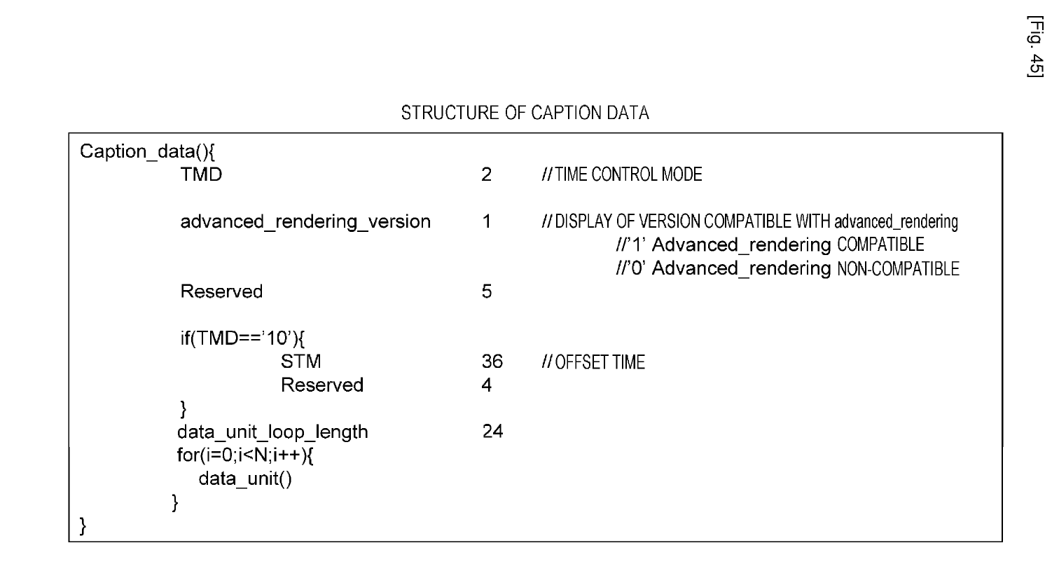

FIG. 44 is a diagram schematically illustrating the structure of caption data in a case of a disparity vector (disparity information) being inserted within a PES stream of caption management data. The 24-bit field of “data_unit_loop_length” indicates the number of bytes of the following data unit in this caption data field. The data unit to be transmitted with this caption data field is stored in“data_unit”. Note that this caption data structure has no flag information of “advanced_rendering_version”.

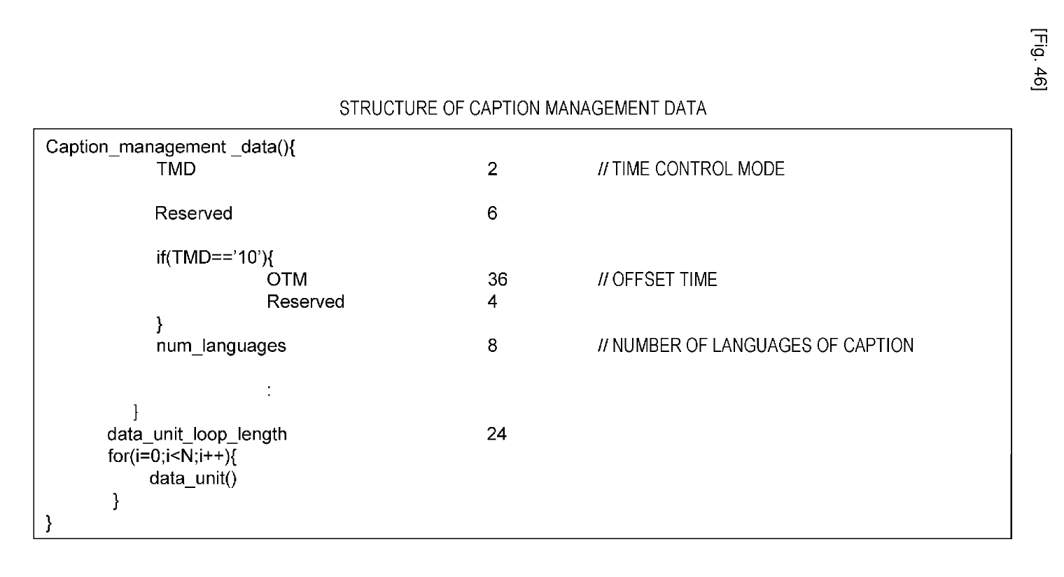

FIG. 45 is a diagram schematically illustrating the structure of caption data in a case of a disparity vector (disparity information) being inserted within a PES stream of a caption text data group. “advanced_rendering_version” is 1-bit flag information indicating whether or not compatible with extended display of caption, which is newly defined with this embodiment. At the reception side, whether or not compatible with extended display of caption can be easily comprehended, based on the flag information situated in the higher layer of the data unit in this way. The 24-bit field of“data_unit_loop_length” indicates the number of bytes of the following data unit in this caption management data field. The data unit to be transmitted with this caption text data field is stored in“data_unit”.

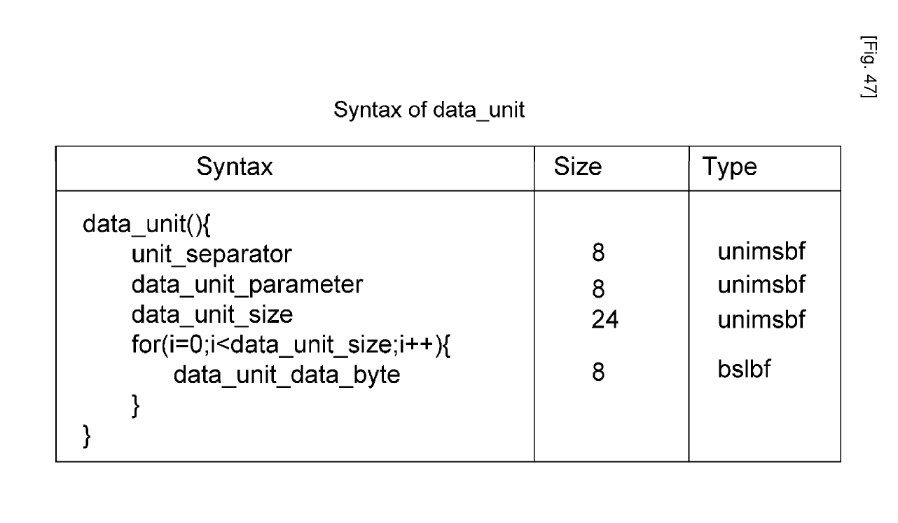

FIG. 46 is a diagram schematically illustrating the structure of caption management data in a case of a disparity vector (disparity information) being inserted within a PES stream of a caption text data group. The 24-bit field of “data_unit_loop_length” indicates the number of bytes of the following data unit in this caption data field. The data unit to be transmitted with this caption data field is stored in“data_unit”. Note that this caption management data structure has no flag information of “advanced_rendering_version”.

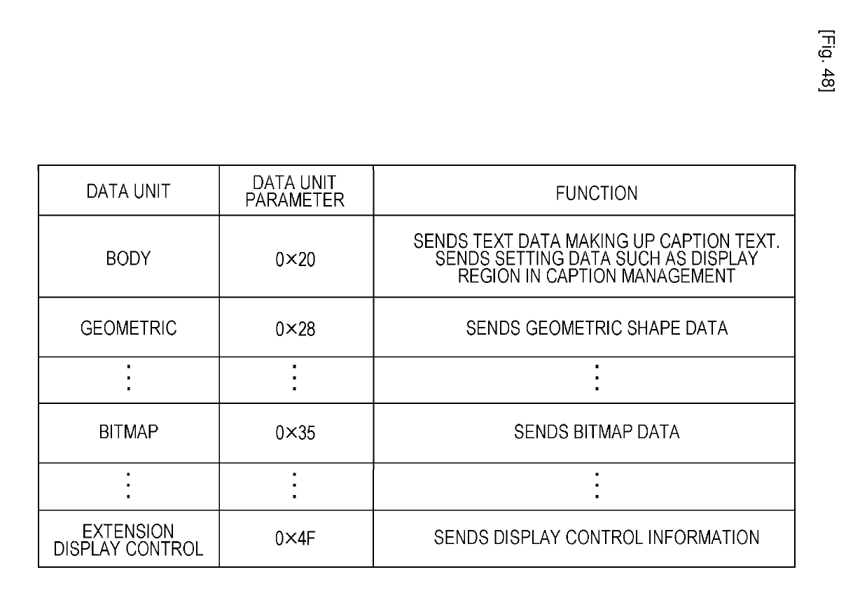

FIG. 47 is a diagram illustrating the structure (Syntax) of a data unit (data_unit) included in a caption datastream. The 8-bit field of “unit separator” indicates data unit separator code, and is set to “0x1F”. The 8-bit field of“data_unit_parameter” is a data unit parameter for identifying the type of data unit.

FIG. 48 is a diagram illustrating the types of data units, and the data unit parameters and functions thereof. For example, the data unit parameter indicating the data unit of the body is set to “0x20”. Also, for example, the data unit parameter indicating a geometric data unit is set to “0x28”. Also, for example, the data unit parameter indicating a bitmap data unit is set to“0x35”. In this embodiment, a data unit of extended display control for storing display control information (extended display control information) is newly defined, and the data unit parameter indicating this data unit is set to, for example, “0x4F”.

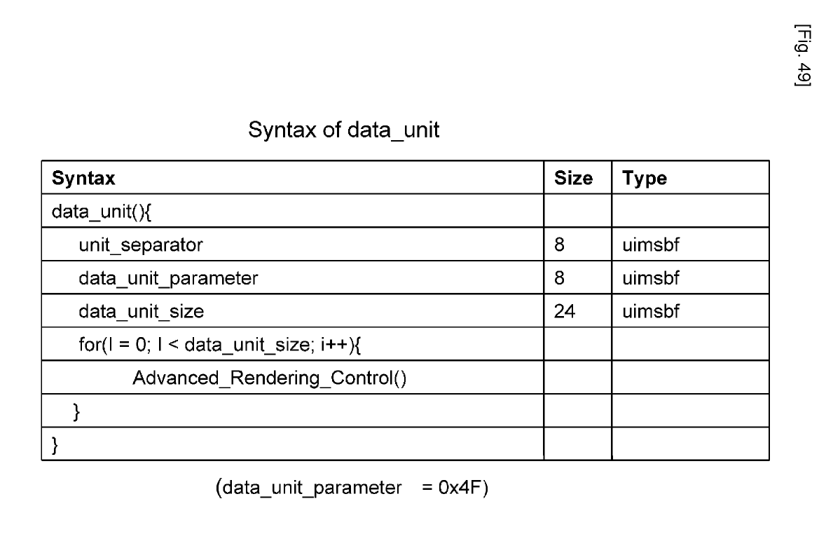

The 24-bit field of “data_unit_size” indicates the number of bytes of the following data unit data in this data unit field. The data unit data is stored in “data_unit_data_byte”. FIG. 49 is a diagram illustrating the structure (Syntax) of a data unit (data_unit) for extended display control. In this case, the data unit parameter is “0x4F”, and the display control information is stored in the “Advanced_Rendering_Control” serving as the “data_unit_data_byte”.

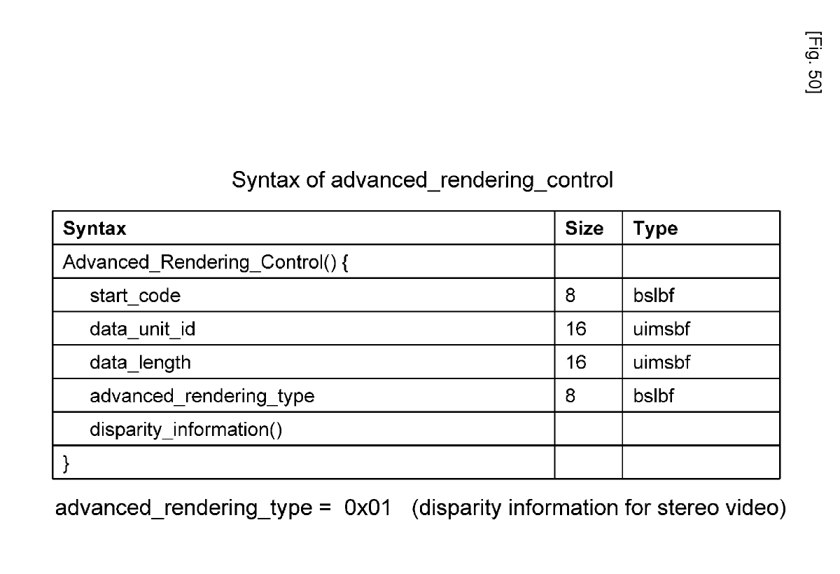

FIG. 50 is a diagram illustrating the structure (Syntax) of “Advanced_Rendering_Control” in a data unit of extended display control which a PES stream of a caption management data group has in the examples in FIG. 35 and FIG. 36 described above. Also, this FIG. 50 illustrates the structure (Syntax) of “Advanced_Rendering_Control” in a data unit of extended display control which a PES stream of a caption text data group has in the examples in FIG. 37 and FIG. 38 described above. That is to say, this FIG. 50 illustrates a structure in a case of inserting stereo video disparity information as display control information.

The 8-bit field of“start_code” indicates the start of “Advanced_Rendering_Control”. The 16-bit field of “data_unit_id” indicates the data unit ID. The 16-bit field of “data_length” indicates the number of data bytes following in this advanced rendering control field. The 8-bit field of“Advanced_rendering_type” is the advanced rendering type specifying the type of the display control information. Here, this indicates that the data unit parameter is set to “0x01” for example, and the display control information is “stereo video disparity information”. The disparity information is stored in “disparity_information”.

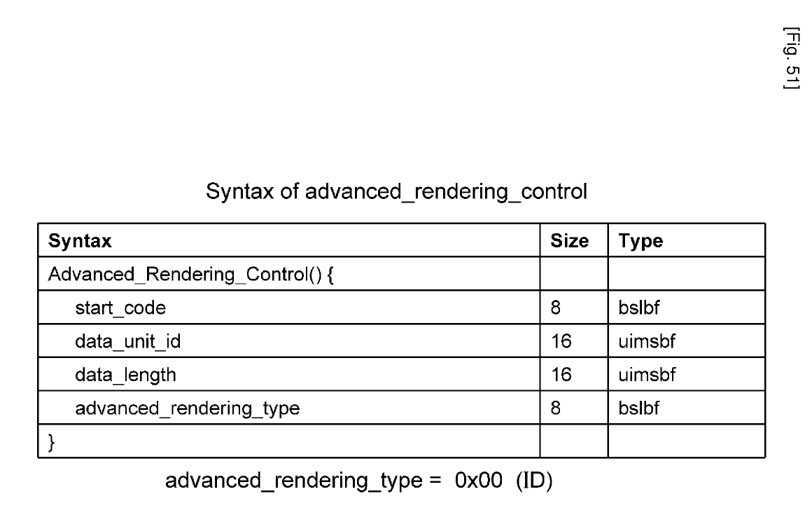

FIG. 51 illustrates the structure (Syntax) of “Advanced_Rendering_Control” in a data unit of extended display control which a PES stream of a caption text data group has in the example of FIG. 35 described above. That is to say, FIG. 51 illustrates the structure in the event of inserting a data unit ID as display control information.

The 8-bit field of “start_code” indicates the start of “Advanced_Rendering_Control”. The 16-bit field of “data_unit_id” indicates the data unit ID. The 16-bit field of “data_length” indicates the number of data bytes following in this advanced rendering control field. The 8-bit field of“Advanced_rendering_type” is the advanced rendering type specifying the type of the display control information. Here, the data unit parameter is “0x00” for example, indicating that the display control information is “data unit ID”.

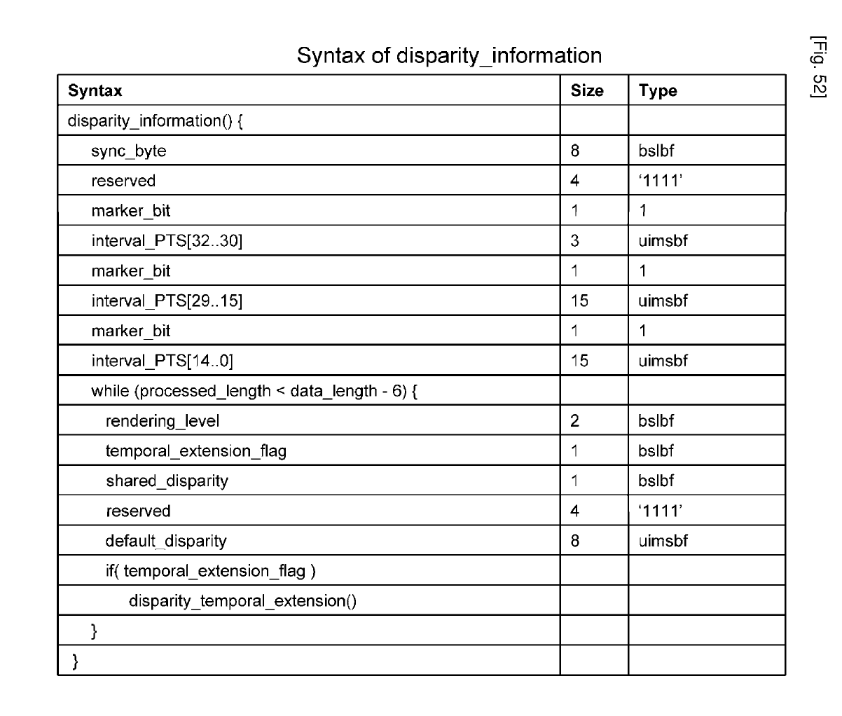

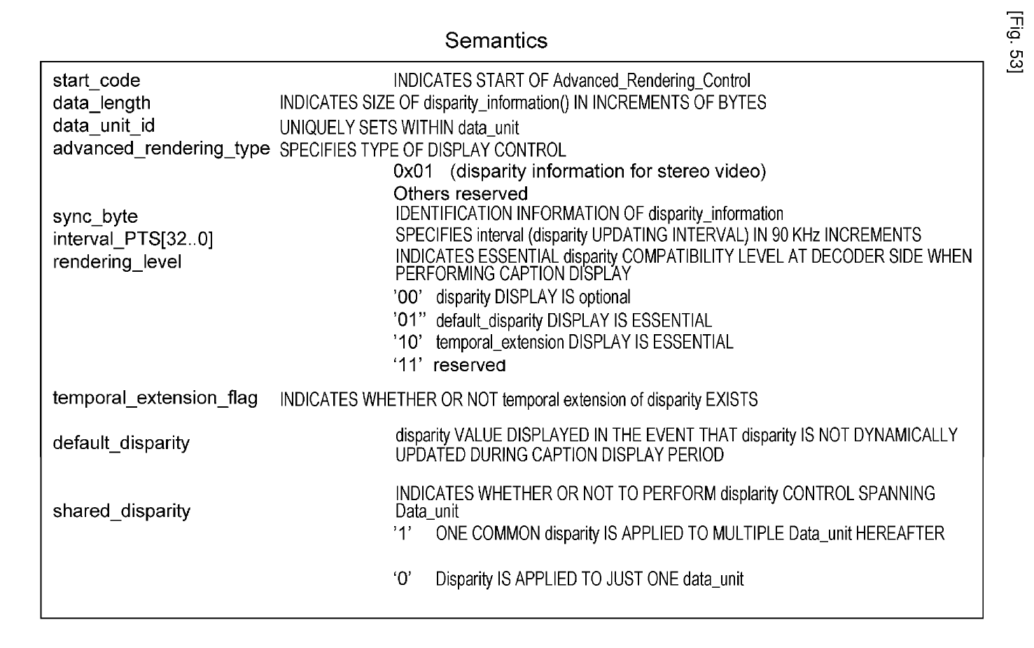

Note that FIG. 53 illustrates principal data stipulations in the structure of “Advanced_Rendering_Control” described above, and further in the structure of “disparity_information” in the later-described FIG. 52.

FIG. 52 illustrates a structure example (Syntax) of “Advanced_Rendering_Control” in “disparity_information” within a extended display control data unit (data_unit) included in a caption text data group. The 8-bit field of “sync_byte” is identification information of“disparity_information”, and indicates the start of this“disparity_information”. “interval_PTS[32.0]” specifies the frame cycle (the spacing of one frame) in updating frame spacings of the disparity information (disparity), in 90 KHz spacings. That is to say, “interval_PTS[32.0]” expresses a value of the frame cycle measured with a 90 KHz in a 33-bit length.

By instructing the frame cycle with “interval_PTS[32.0]” in the disparity information, the updating frame spacings of disparity information intended at the transmission side can be correctly transmitted to the reception side. In the event that this information is not appended, the video frame cycle, for example, is referenced at the reception side.

“rendering_level” indicates the correspondence level of disparity information (disparity) essential at the reception side (decoder side) for displaying captions. “00” indicates that 3-dimensional display of captions using disparity information is optional (optional). “01” indicates that 3-dimensional display of captions using disparity information used in common within the caption display period (default_disparity) is essential. “10” indicates that 3-dimensional display of captions using disparity information sequentially updated within the caption display period (disparity_update) is essential.

“temporal_extension_flag” is 1-bit flag information indicating whether or not there exists disparity information sequentially updated within the caption display period (disparity_update). In this case, “1” indicates that this exists, and “0” indicates that this does not exist. The 8-bit field of “default_disparity” indicates default disparity-information. This disparity information is disparity information in the event of not being updated, i.e., disparity information used in common within the caption display period.

“shared_disparity” indicates whether or not to perform common disparity information (disparity) control over data units (Data_unit). “1” indicates that one common disparity information (disparity) is to be applied to subsequent multiple data units (Data_unit). “0” indicates that disparity information (disparity) is to be applied to one data unit (Data_unit).

In the event that“temporal_extension_flag” is “1”, the disparity information has “disparity_temporal_extension( )”. The structure example (Syntax) of this “disparity_temporal_extension( )” is the same as described above, so description thereof will be omitted here (see FIG. 21 and FIG. 22).

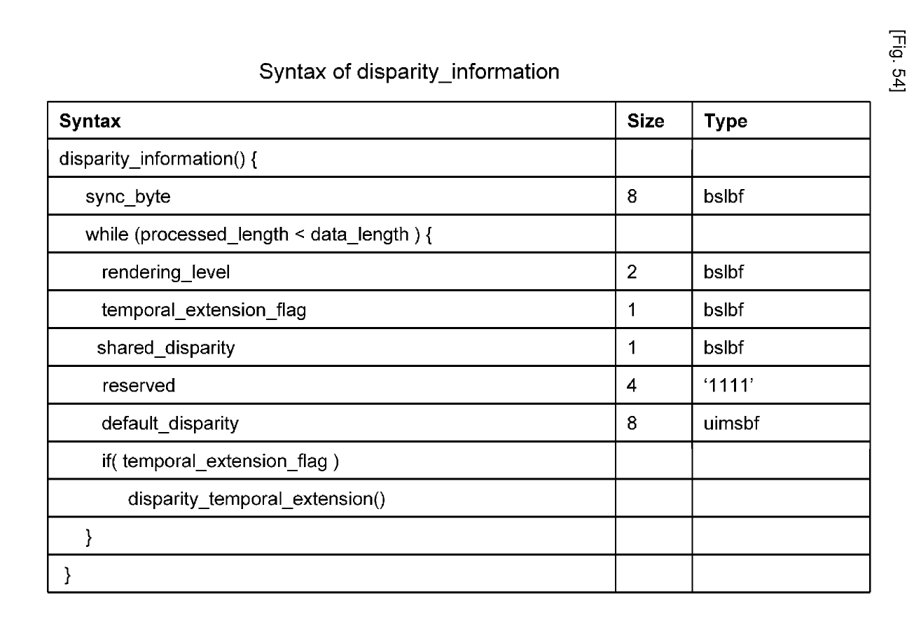

Note that “interval_PTS[32.0]” is appended to the structure example (Syntax) of“disparity_information” in FIG. 52 described above. However, a structure example (Syntax) of “disparity information” without “interval_PTS[32.01]” appended thereto is also conceivable. In this case, the structure of “disparity_information” is as shown in FIG. 54.

Returning to FIG. 33, the video encoder 122 subjects the stereoscopic image data supplied from the data extracting unit 121 to encoding such as MPEG4-AVC, MPEG2, VC-1, or the like, and a video elementary stream is generated. The audio encoder 123 subjects the audio data supplied from the data extracting unit 121 to encoding such as MPEG4-AVC, MPEG2, VC-1, or the like, generating an audio elementary stream.

The multiplexer 127 multiplexes the elementary streams output from the video encoder 122, audio encoder 123, and caption encoder 126. This multiplexer 127 outputs the bit stream data (transport stream) BSD as transmission data (multiplexed data stream).

The operations of the transmission data generating unit 110A shown in FIG. 33 will be described in brief. Stereoscopic image data output from the data extracting unit 121 is supplied to the video encoder 122. The video encoder 122 subjects the this stereoscopic image data to encoding such as MPEG4-AVC, MPEG2, VC-1, or the like, and a video elementary stream including this encoded video data is generated. This video elementary stream is supplied to the multiplexer 127.

Also, at the caption generating unit 124, ARIB format caption data is generated. This caption data is supplied to the caption encoder 126. At this caption encoder 126, a caption elementary stream including the caption data generated at the caption-generating unit 124 (caption data stream) is generated. This caption elementary stream is supplied to the multiplexer 127.

The disparity vector for each pixel (pixel) output from the data extracting unit 121 is supplied to the disparity information creating unit 125. At this disparity information-creating unit 125, disparity vectors (horizontal direction disparity vectors) corresponding to a predetermined number of caption units (captions) displayed on the same screen are created by downsizing processing. In this case, the disparity information creating unit 125 creates disparity vectors for each caption unit (individual disparity vectors) or a disparity vector (shared disparity vector) common to all caption units.

The disparity vectors created at the disparity information creating unit 125 are supplied to the caption encoder 126. At the caption encoder 126, the disparity vectors are included in the caption data stream (see FIG. 35 through FIG. 38). With the caption data stream, caption data of each caption unit displayed on the same screen is inserted in the PES stream of the caption text data group as caption text data (caption code). Also, with this caption data stream, disparity vectors (disparity information) are inserted in the PES stream of the caption management data group or PES stream of the caption text data group, as display control information for the captions. In this case, the disparity vector is inserted into a data unit of extended display control for sending the display control information that has been newly defined (see FIG. 49).

Also, the audio data output from the data extracting unit 121 is supplied to the audio encoder 123. At the audio encoder 123, the audio data is subjected to encoding such as MPEG2 Audio AAC, or the like, generating an audio elementary stream including the encoded audio data. This audio elementary stream is supplied to the multiplexer 127.

As described above, the multiplexer 127 is supplied with the elementary streams from the video encoder 122, audio encoder 123, and caption encoder 126. This multiplexer 127 packetizes and multiplexes the elementary streams supplied from the encoders, thereby obtaining a bit stream data (transport stream) BSD as transmission data.

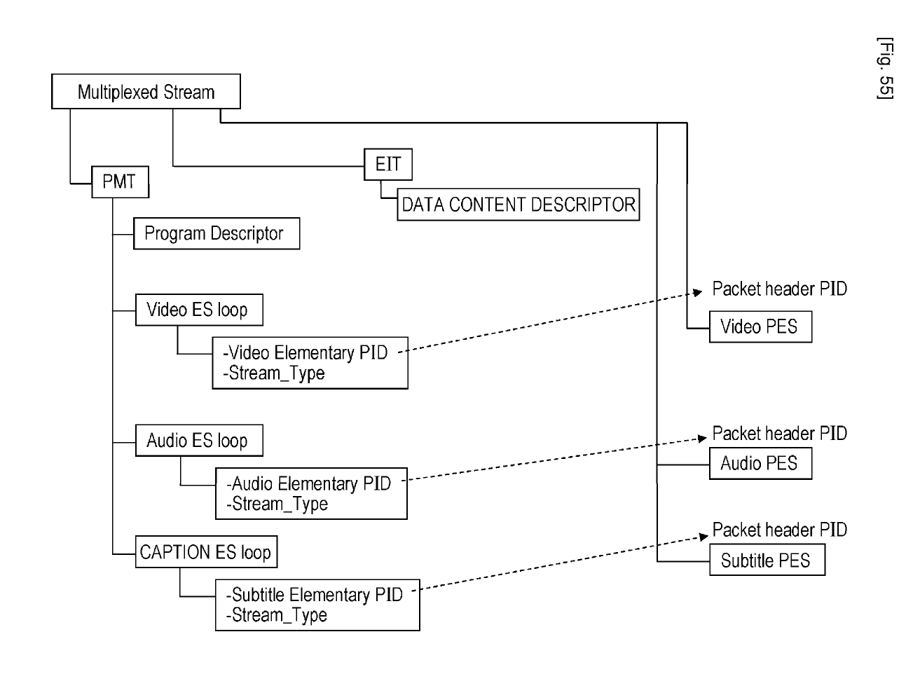

FIG. 55 is a diagram illustrating a configuration example of a general transport stream (multiplexed data stream) including a video elementary stream, audio elementary stream, and caption elementary stream. This transport stream includes PES packets obtained by packetizing the elementary streams. With this configuration example, a PES packet “Video PES” of the video elementary stream is included. Also, with this configuration example, a PES packet “AudioPES” of the audio elementary stream, and a PES packet “SubtitlePES” of the caption elementary stream are included.

The transport stream includes a PMT (Program Map Table) as PSI (Program Specific Information). This PSI is information describing to which program each elementary stream included in the transport stream belongs to. Also, the transport stream includes an EIT (Event Information Table) serving as SI (Serviced Information) which performs management in event increments.

A program descriptor (ProgramDescriptor) describing information relating to the overall program exists in the PMT. Also, an elementary loop having information relating to each elementary stream exists in this PMT. With this configuration example, there exists a video elementary loop, an audio elementary loop, and a subtitle elementary loop. Each elementary loop has situated therein a packet identifier (PID) and stream type (Stream_Type) and so forth for each stream, and while not shown in the drawings, a descriptor describing information relating to the elementary streams is also placed therein.

With this embodiment, the transport stream (multiplexed data stream) output from the multiplexer 127 (see FIG. 33) has inserted therein flag information indicating whether or not the caption data stream corresponds to extended display control for captions. Now, extended display control for captions is 3-dimensional caption display using disparity information for example, and so forth. In this case, at the reception side (set top box 200), whether or not the caption data stream corresponds to extended display control for captions can be comprehended without opening the data within the caption data stream.

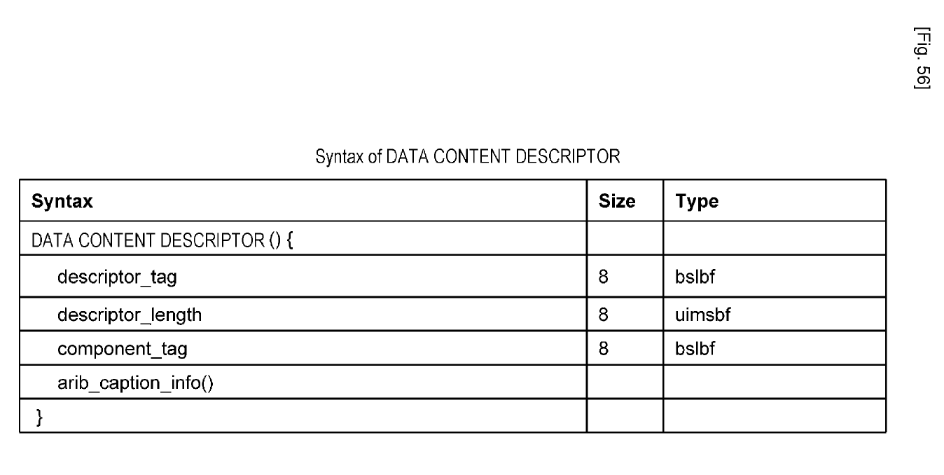

The multiplexer 127 inserts this flag information beneath the above-described EIT, for example. With the configuration example in FIG. 55, a data content descriptor is inserted beneath the EIT. This data content descriptor includes flag information “Advanced_Rendering_support”. FIG. 56 is a diagram illustrating a structure example (Syntax) of a data content descriptor. “descriptor_tag” is 8-bit data indicating the type of descriptor (descriptor), and here indicates a data content descriptor. “descriptor_length” is 8-bit data indicating the size of descriptor. This data indicates the number of bytes following“descriptor_length” as the length of the descriptor.

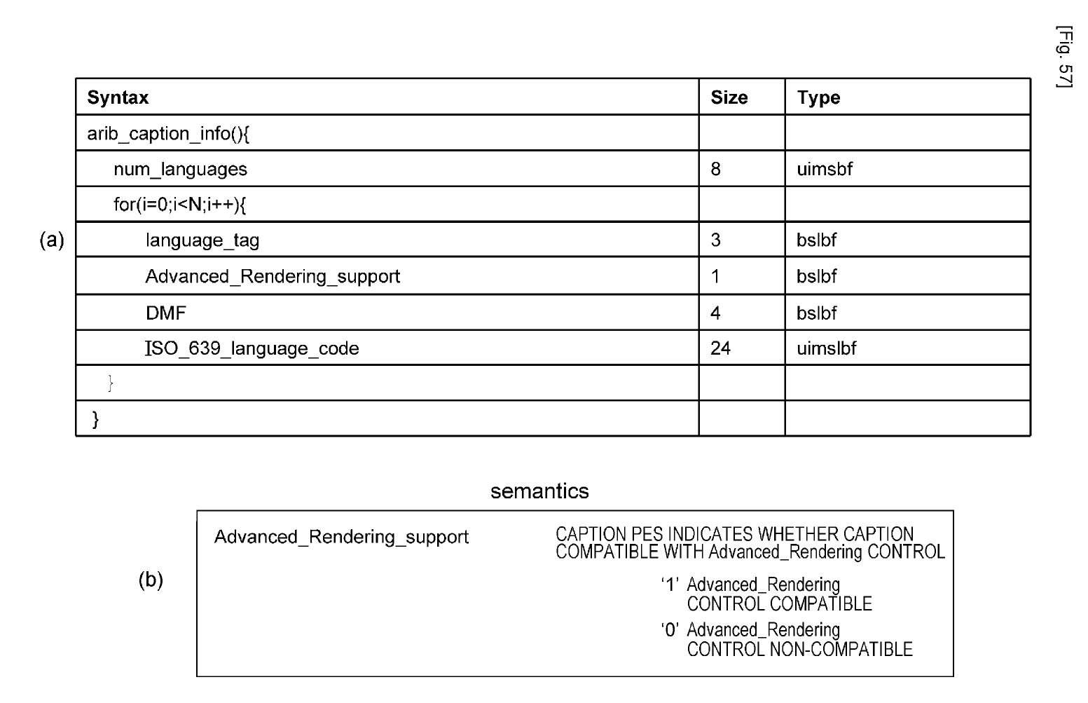

“component_tag” is 8-bit data for correlating with the elementary stream for caption. “arib_caption_info” is defined after this“component_tag”. FIG. 57(a) is a diagram illustrating a structure example (Syntax) of“arib_caption_info”. As shown in FIG. 57(b), “Advanced_Rendering_support” is 1-bit flag information indicating whether the caption data stream corresponds to extended display control for captions. “1” indicates that this- corresponds to extended display control for captions. “0” indicates that this dopes not correspond to extended display control for captions.

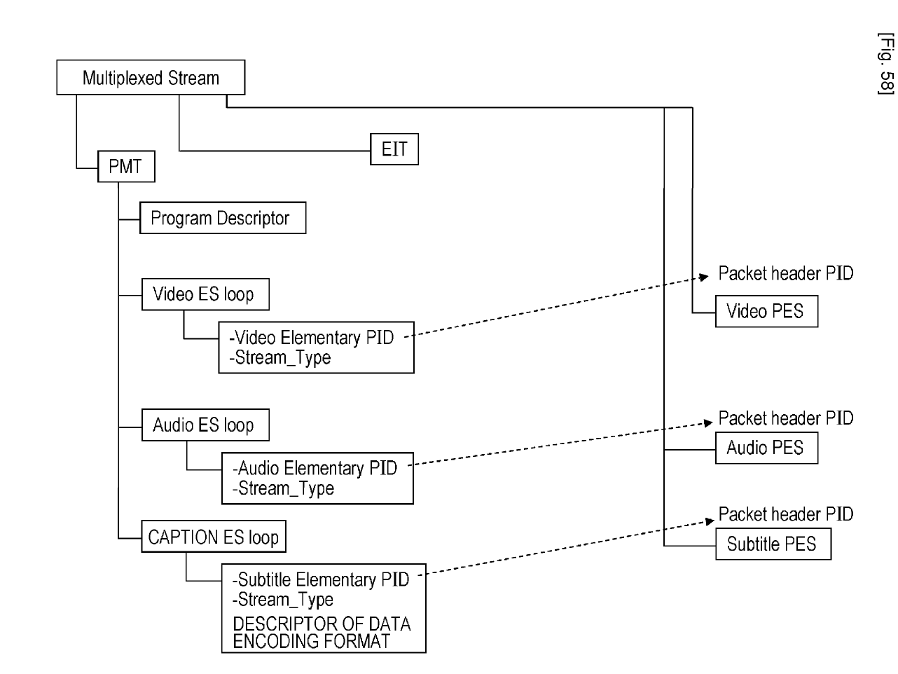

Note that the multiplexer 127 can insert the above-described flag information beneath the PMT. FIG. 58 is a diagram illustrating a configuration example of a transport stream (multiplexed data stream) in such a case. With this configuration example, a data encoding format descriptor is inserted beneath a caption ES loop of the PMT. The flag information “Advanced_Rendering_support” is included in this data encoding format descriptor.

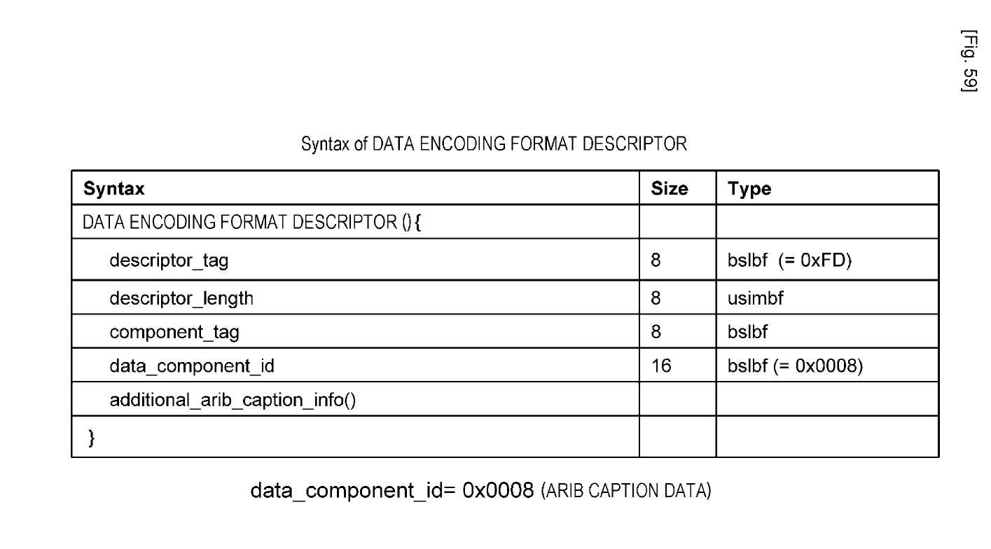

FIG. 59 is a diagram illustrating a structure example (Syntax) of a data encoding format descriptor. “descriptor_tag” is 8-bit data indicating the type of descriptor (descriptor), and here indicates a data content descriptor. “descriptor_length” is 8-bit data indicating the size of descriptor. This data indicates the number of bytes following“descriptor_length” as the length of the descriptor.

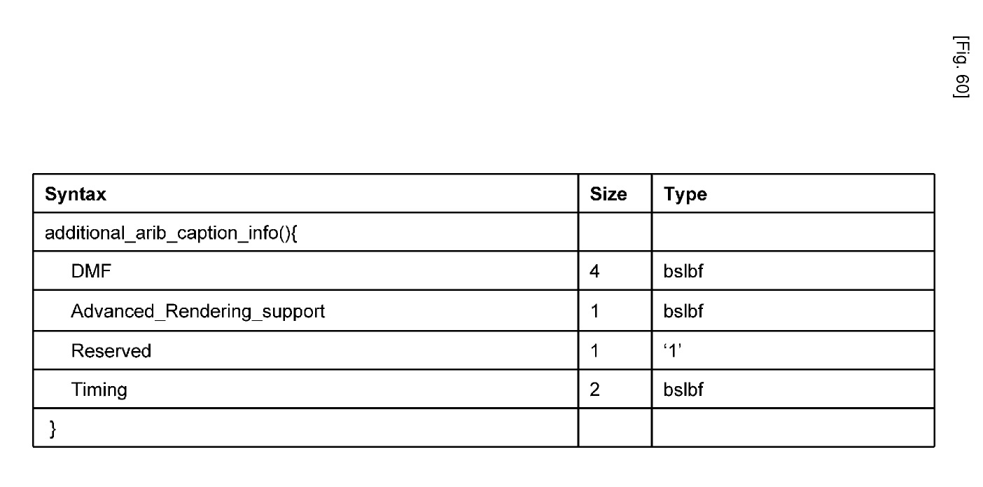

“component_tag” is 8-bit data for correlating with the elementary stream for caption. “data_component_id” is set to “0x0008” indicating caption data here. “additional_arib_caption_info” is defined after “data_component_id”. FIG. 60 is a diagram illustrating a structure example (Syntax) of this “additional_arib_caption_info”. As illustrated in FIG. 57(b) described above, “Advanced_Rendering_support” is 1-bit flag information indicating whether the caption data stream corresponds to extended display control for captions. “1” indicates that this corresponds to extended display control for captions. “0” indicates that this dopes not correspond to extended display control for captions.

As described above, with the transmission data generating unit 110A shown in FIG. 33, the bit stream data BSD output from the multiplexer 127 is a multiplexed data stream having a video data stream and caption data stream. The video data stream includes stereoscopic image data. Also, the caption data stream includes ARIB format caption (caption unit) data and disparity vectors (disparity information).

Also, disparity information is inserted in a data unit sending caption display control information within a PES stream of the caption management data group or PES stream of a caption text data group, and the caption text data (caption text information) and disparity information are correlated. Accordingly, at the reception side (set top box 200), suitable disparity can be provided to the caption units (captions) superimposed on the left eye image and right eye image, using the corresponding disparity vectors (disparity information). Accordingly, regarding caption units (captions) being displayed, consistency in perspective between the objects in the image can be maintained in an optimal state.

Also, with the transmission data generating unit 110A shown in FIG. 33, disparity information used in common during the caption display period (see “default_disparity” in FIG. 52) is inserted in the newly-defined extended display control data units. Also, the disparity information sequentially updated during the caption display period (see “disparity_update” in FIG. 21) can be inserted in the data units. Also, flag information indicating the existence of disparity information sequentially updated during the caption display period is inserted into the extended display control data units (see“temporal_extension_flag” in FIG. 52).

Accordingly, selection can be made regarding whether to transmit just disparity information used in common during the caption display period, or to further transmit disparity information sequentially updated during the caption display period. By trans-mitting the disparity information sequentially updated during the caption display period, disparity applied to the superimposed information can be dynamically changed in conjunction with changes in the contents of the image at the reception side (set top box 200).

Also, with the transmission data generating unit 110A shown in FIG. 33, the disparity information included in the extended display control data units is made up of disparity information of the first frame of the subtitle display period and disparity information atsubsequent updating frame spacings. Accordingly, the amount of transmission data can be reduced, and the memory capacity for holding the disparity information at the reception side can be greatly conserved.

Also, with the transmission data generating unit 110A shown in FIG. 33, the “disparity_temporal_extension( )” to be inserted in the extended display control data units is of the same structure as the “disparity_temporal_extension( )” included in the SCS segment described above (see FIG. 21). Accordingly, while detailed description will be omitted, the transmission data generating unit 110A shown in FIG. 33 can obtain the same advantages as the transmission data generating unit 110 shown in FIG. 2 due to this “disparity_temporal_extension( )” structure.

“Configuration Example of Bit Stream Processing Unit”

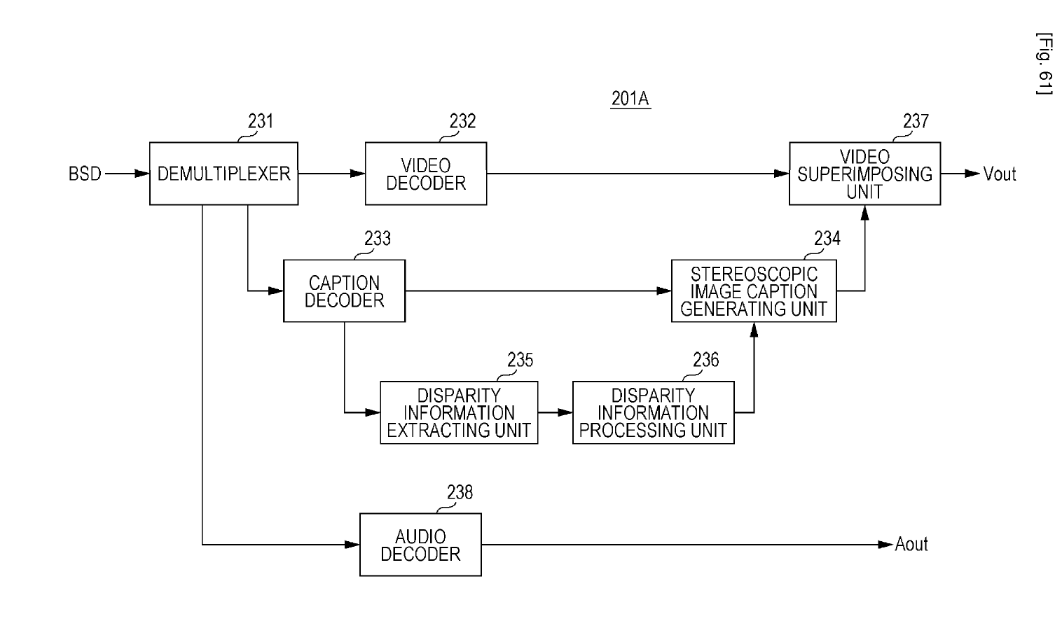

FIG. 61 illustrates a configuration example of a bit stream processing unit 201A of the set top box 200 corresponding to the transmission data generating unit 110A shown in FIG. 33 described above. This bit stream processing unit 201A is of a configuration corresponding to the transmission data generating unit 110A shown in FIG. 33 described above. The bit stream processing unit 201A has a demultiplexer 231, a video decoder 232, and a caption decoder 233. Also, the bit stream processing unit 201A includes a stereoscopic image caption generating unit 234, a disparity information extracting unit 235, a disparity information processing unit 236, a video superimposing unit 237, and an audio decoder 238.

The demultiplexer 231 extracts video, audio, and caption packets from the bit stream data BSD, and sends these to the decoders. The video decoder 232 performs processing opposite to that of the video encoder 122 of the transmission data generating unit 110A described above. That is to say, the video elementary stream is reconstructed from the video packets extracted at the demultiplexer 231, encoding processing is performed, and stereoscopic image data including left eye image data and right eye image data is obtained. The transmission format for the stereoscopic image data is, for example, the above-described first transmission format (“Top & Bottom” format), second-transmission format (“Side by Side” format), third transmission format (“Frame Sequential” format), and so forth (see FIG. 4).

The subtitle decoder 223 performs processing opposite to that of the subtitle encoder 118 of the transmission data generating unit 110 described above. That is to say, the caption decoder 233 reconstructs the caption elementary stream (caption data stream) from the caption packets extracted at the demultiplexer 231, performs decoding processing, and obtains caption data (ARIB format caption data) for each caption unit.

The disparity information extracting unit 235 extracts disparity vectors (disparity information) corresponding to each caption unit from the caption stream obtained through the caption decoder 233. In this case, disparity vectors for each caption unit (individual disparity vectors) or a disparity vector (shared disparity vector) common to the caption units, is obtained (see FIG. 35 through FIG. 38).

As described above, the caption data stream includes data of ARIB format captions (caption units) and disparity vectors (disparity information). Accordingly, the disparity information extracting unit 235 can extract the disparity information (disparity vectors) in a manner correlated with the caption data of the caption units.

The disparity information extracting unit 235 obtains disparity information used in common during the caption display period (see “default_disparity”) in FIG. 52). Further, the disparity information extracting unit 235 may also obtain disparity information sequentially updated during the caption display period (see “disparity_update” in FIG. 21). The disparity information extracting unit 235 sends the disparity information (disparity vectors) to the stereoscopic image caption generating unit 234 via the disparity information processing unit 236. The disparity information sequentially updated during the caption display period is made up of disparity information of the first frame of the subtitle display period and disparity information at subsequent updating frame spacings, as described above.

With regard to the disparity information used in common during the caption display period, the disparity information processing unit 236 sends this to the stereoscopic image caption generating unit 234 without change. On the other hand, with regard to the disparity information sequentially updated during the caption display period, the disparity information processing unit 236 performs interpolation processing, generates arbitrary frame spacings during the caption display period, such as one-frame spacing disparity information for example, and sends this to the stereoscopic image caption generating unit 234. The disparity information-processing unit 236 performs interpolation processing involving low-pass filter (LIP) processing in the temporal direction (frame direction) for this interpolation processing, rather than linear interpolation processing, so that the change in disparity information at predetermined frame spacings following the interpolation processing will be smooth in the temporal direction (frame direction) (see FIG. 31).

The stereoscopic image caption generating unit 234 generates left eye caption and right eye caption to be superimposed on the left eye image and right eye image, respectively. This generating processing is performed based on the caption data for each caption unit obtained at the caption decoder 233 and the disparity information (disparity vectors) supplied via the disparity information processing unit 236. This stereoscopic image caption generating unit 234 then outputs left eye caption and right eye caption data (bit map data).

In this case, the left eye caption and right eye caption data are the same. However, the left eye caption and right eye caption have their superimposed positions within the image shifted in the horizontal direction by an amount equivalent to the disparity vector. Accordingly, caption subjected to disparity adjustment in accordance with the perspective of the objects within the image can be used as the same caption to be superimposed on the left eye image and right eye image, and consistency in perspective with the objects in the image can be maintained in an optimal state.

Now, in the event that just the disparity information (disparity vector) used in common during the caption display period is transmitted from the disparity information processing unit 236, the stereoscopic image caption generating unit 234 uses this disparity information. Also, in the event that disparity information sequentially updated during the caption display period is also transmitted from the disparity information processing unit 236, the stereoscopic image subtitle generating unit 224 uses one or the other.

Which to use is constrained by information (see “rendering_level” in FIG. 52) indicating the level of correlation of disparity information (disparity) that is essential at the reception side (decoder) side for displaying captions, included in the extended display control data unit, as described above for example. In this case, in the event of “00” for example, user settings as applied. Using disparity information sequentially updated during the caption display period enables disparity to be applied to the left eye-subtitles and right eye subtitles to be dynamically changed in conjunction with changes in the contents of the image.

The video superimposing unit 237 superimposes data (bitmap data) of left eye captions and right eye captions generated at the stereoscopic image caption generating unit 234 into the stereoscopic image data obtained at the video decoder 232 (left eye image data and right eye image data), and obtains display stereoscopic image data Vout. The video superimposing unit 237 then externally outputs the display stereoscopic image data Vout from the bit stream processing unit 201A.

Also, the audio decoder 238 performs processing opposite to that of the subtitle decoder 223 of the transmission data generating unit 110A. That is to say, the audio decoder 238 reconstructs an audio elementary stream from the audio packets extracted at the demultiplexer 231, performs decoding processing and obtains audio data Aout. The audio decoder 238 then externally outputs the audio data Aout from the bit stream processing unit 201A.

The operations of the bit stream processing unit 201A shown in FIG. 61 will be described in brief. The bitstream data BSD output from the digital tuner (see FIG. 29) is supplied to the demultiplexer 231. At this demultiplexer 231, video, audio, and caption packets are extracted from the bit stream data BSD and supplied to the decoders.

At the video decoder 232, the video elementary stream is reconstructed from the video packets extracted at the demultiplexer 231, and further decoding processing is performed, thereby obtaining stereoscopic image data including left eye image data and right eye image data. This stereoscopic image data is supplied to the video superimposing unit 237.

Also, with the caption decoder 233, the caption elementary stream is reconstructed from the caption packets extracted at the demultiplexer 231, and further decoding processing is performed, thereby obtaining caption data (ARIB format caption data) of the caption units. The caption data of the captions units is supplied to the stereoscopic image caption generating unit 234.

Also, with the disparity information extracting unit 235, disparity vectors (disparity information) corresponding to the caption units are extracted from the caption stream obtained through the caption decoder 233. In this case, the disparity information extracting unit 235 obtains disparity vectors for each caption unit (individual disparity vectors) or a disparity vector common to the caption units (shared disparity vector).

Also, the disparity information extracting unit 235 obtains disparity information used in common during the caption display period, or disparity information sequentially updated during the caption display period along with this. The disparity information (disparity vectors) extracted at the disparity information extracting unit 235 is sent to the stereoscopic image caption generating unit 234 through the disparity information processing unit 236. At the disparity information processing unit 236, the following processing is performed regarding disparity information sequentially updated during the caption display period. That is to say, interpolation processing involving LPF processing in the temporal direction (frame direction) is performed at the disparity information processing unit 236, thereby generating disparity information at an arbitrary frame spacing during the caption display period, e.g., one frame spacing, which is then transmitted to the stereoscopic image caption generating unit 234.

At the stereoscopic image caption generating unit 234, left eye caption and right eye caption data (bitmap data) to be superimposed on the left eye image and right eye image respectively, is generated based on the caption data of the caption units and the disparity vectors corresponding to the captions units. In this case, the captions of the right eye for example, have the superimposed positions within the image as to the left eye captions shifted in the horizontal direction by an amount equivalent to the disparity vector. This left eye caption and right eye caption data is supplied to the video superimposing unit 237.

At the video superimposing unit 237, the left eye caption and right eye caption data (bitmap data) generated at the stereoscopic image caption generating unit 234 is superimposed on the stereoscopic image data obtained at the video decoder 232, thereby obtaining display stereoscopic image data Vout. This display stereoscopic image data Vout is externally output from the bit stream processing unit 201A.

Also, with the audio decoder 238, the audio elementary stream is reconstructed from the audio packets extracted at the demultiplexer 231, and further decoding processing is performed, thereby obtaining audio data Aout corresponding to the above-described display stereoscopic image data Vout. This audio data Aout is externally output from the bit stream processing unit 201A.

As described above, caption (caption unit) data and disparity vectors (disparity information) are included in the caption data stream included in the bit stream data BSD supplied to the bit stream processing unit 201A. The disparity vectors (disparity information) are inserted in data units sending caption display control information within the PES stream in the caption text data group, with the caption data and disparity vectors correlated.

Accordingly, with the bit stream processing unit 201A, suitable disparity can be provided to caption units (Captions) superimposed on the left eye image and right eye image, using the corresponding disparity vectors (disparity information). Accordingly, regarding caption units (captions) being displayed, consistency in perspective between the objects in the image can be maintained in an optimal state.

Also, the disparity information extracting unit 235 of the bit stream processing unit 201A shown in FIG. 61 uses disparity information sequentially updated during the caption display period, and accordingly disparity to be applied to the left eye subtitles and right eye subtitles can be dynamically changed in conjunction with changes in the contents of the image.

Also, with the disparity information processing unit 236 of the bit stream processing unit 201A, disparity information at arbitrary frame spacings during the caption display period is generated by interpolation processing being performed as to the disparity information sequentially updated during the caption display period. In this case, even in the event of disparity information being transmitted from the transmission side (broadcasting station 100) each base segment period (updating frame spacing) such as 16 frames or the like, the disparity to be applied to the left eye and right eye captions can be controlled in fine spacings, e.g., each frame.

Also, with the disparity information processing unit 236 of the bit stream processing unit 201A shown in FIG. 61, interpolation processing involving low-pass filter processing in the temporal direction (frame direction) is performed. Accordingly, even in the event of disparity information being transmitted from the transmission side (broadcasting station 100) each base segment period (updating frame spacing), change of the disparity information in the temporal direction (frame direction) after interpolation processing can be made smooth (see FIG. 31). Accordingly, an unnatural sensation of the transition of disparity applied to the left eye and right eye captions becoming discontinuous at each updating frame spacing can be suppressed.

“Other Configuration of Transmission Data Generating Unit and Bit Stream Processing Unit (2)”

“Configuration Example of Transmission Data Generating Unit”

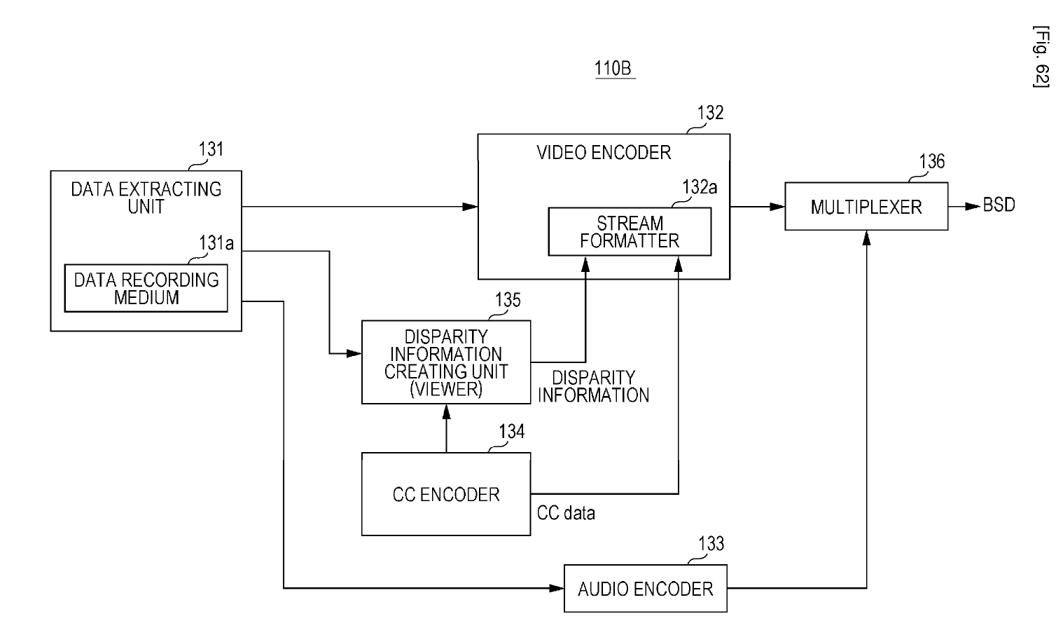

FIG. 62 illustrates a configuration example of a transmission data generating unit 110B at the broadcasting station 100 (see FIG. 1). This transmission data generating unit 110B transmits disparity information (disparity vectors) with a data structure readily compatible with the CEA format which is an already-existing broadcasting standard. This transmission data generating unit 110B has a data extracting unit (archiving unit) 131, a video encoder 132, and an audio encoder 133. Also, the transmission data generating unit 110B has a closed caption encoder (CC encoder) 134, a disparity information creating unit 135, and a multiplexer 136.

A data recording medium 131a is, for example detachably mounted to the data extracting unit 131. This data recording medium 131a has recorded therein, along with stereoscopic image data including left eye image data and right eye image data, audio data and disparity information, in a correlated manner, in the same way with the data recording medium 111a in the data extracting unit 111 of the transmission data-generating unit 110 shown in FIG. 2. The data extracting unit 131 extracts, from the data recording medium 131a, the stereoscopic image data, audio data, disparity information, and so forth, and outputs this. The data recording medium 131a is a disc-shaped recording medium, semiconductor memory, or the like.

The CC encoder 134 is an encoder conforming to the CEA-708 standard, and outputs CC data (data for closed caption information) for caption display of closed caption. In this case, the CC encoder 134 sequentially outputs CC data of each closed caption information displayed in time sequence.

The disparity information creating unit 135 subjects the disparity vectors output from the data extracting unit 131, i.e., disparity vectors for each pixel, to downsizing processing, and outputs disparity information (disparity vectors) correlated with each window ID (Window ID) included in the CC data output from the CC encoder 134 described above. The disparity information creating unit 135 performs downsizing the processing the same as with the disparity information creating unit 115 of the transmission data generating unit 110 in FIG. 2 described above, and detailed description thereof will be omitted.

The disparity information creating unit 135 crates disparity vectors corresponding to a predetermined number of caption units (captions) displayed on the same screen by the above-described downsizing processing. In this case, the disparity information creating unit 135 either creates disparity vectors for each caption unit (individual disparity vectors), or creates a disparity vector shared between the caption units (common disparity vector). The selection thereof is by user settings, for example. This disparity information also includes shift object specifying information which specifies which of the closed caption information to be superimposed on the left eye image and the closed caption information to be superimposed on the right eye image is to be shifted based on this disparity information.

In the event of creating individual disparity vectors, the disparity information creating unit 135 obtains the disparity vector belonging to that display region by the above-described downsizing processing, based on the display region of each caption unit. Also, in the event of creating a common vector, the disparity information creating unit 135 obtains the disparity vectors of the entire picture (entire image) by the above-described downsizing processing (see FIG. 9(d)). Note that an arrangement may be made where, in the event of creating a common vector, the disparity information creating unit 135 obtains disparity vectors belonging to the display area of each caption unit and selects the disparity vector with the greatest value.

This disparity information is disparity information used in common within a period of a predetermined number of frames (caption display period) in which the closed caption information is displayed, for example, or disparity information sequentially updated during this caption display period. The disparity information sequentially updated during the caption display period is made up of the first frame of the period of the predetermined number of frames, and disparity information of frames at subsequent updating frame spacings.

The video encoder 132 subjects the stereoscopic image data supplied from the data extracting unit 131 to encoding such as MPEG4-AVC, MPEG2, VC-1, or the like, obtaining encoded video data. Also, the video encoder 132 generates a video elementary stream including the encoded video data in the payload portion thereof, with a downstream stream formatter 132a.

The above-described CC data output from the CC encoder 134 and the disparity information created at the disparity information creating unit 135 are supplied to the stream formatter 132a within the video encoder 132. The stream formatter 132a embeds the CC data and disparity information in the video elementary stream as user data. That is to say, stereoscopic image data is included in the payload portion of the video elementary stream, and also CC data and disparity information are included in the user data area of the header portion.

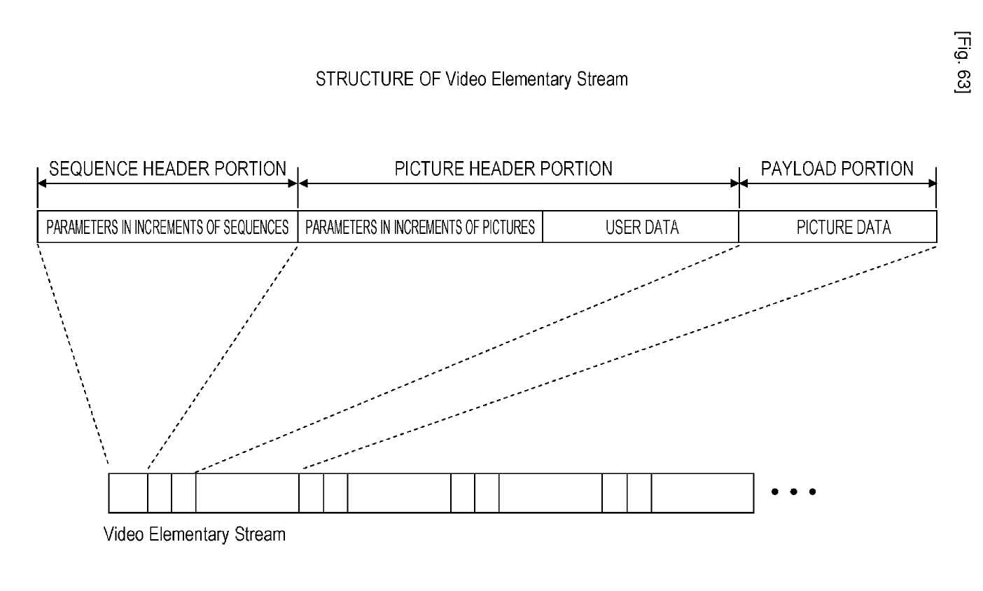

As shown in FIG. 63, the video elementary stream has a sequence header portion including parameters in increments of sequences situated at the head thereof. Following this sequence header portion, a picture header including parameters in increments of- pictures, and user data, is situated. Following this is picture header portions and payload portions, repeatedly situated. The above-described CC data and disparity information are embedded in the user data area of the picture header portion. Details of embedding (inserting) this disparity information into the user data area will be described later.

The audio encoder 133 performs encoding such as MPEG-2 Audio AAC on the audio data extracted at the data extracting unit 131, and generates an audio elementary stream. The multiplexer 136 multiplexes the elementary streams output from the video encoder 132 and audio encoder 133. The multiplexer 136 then outputs bit stream data (transport stream) BSD serving as transmission data (multiplexed data stream).

The operations of the transmission data generating unit 110B shown in FIG. 62 will be described in brief. The stereoscopic image data output from the data extracting unit (archiving unit) 131 is supplied to the video encoder 132. With this video encoder 132, the stereoscopic image data is subjected to encoding such as MPEG4-AVC, MPEG2, VC-1, or the like, and a video elementary stream including the encoded video data is generated. This video elementary stream is supplied to the multiplexer 136.

The CC encoder 134 outputs CC data (data for closed caption information) for caption display of closed captions. In this case, the CC encoder 134 sequentially outputs CC data of each closed caption information displayed in time sequence.

Also, the disparity vectors for each pixel output from the data extracting unit 131 is supplied to the disparity information creating unit 135 where the disparity vectors are- subjected to downsizing processing, and disparity information (disparity vectors) correlated with each window ID (Window ID) included in the CC data output from the CC encoder 134 described above, is output.

The CC data output from the closed caption encoder 134 and the disparity information created at the disparity information creating unit 135 are supplied to the stream formatter 132a of the video encoder 132. At the stream formatter 132a, the CC data and disparity information are inserted into the user data area of the header portion of the video elementary stream. In this case, embedding or insertion of the disparity information is performed by, for example, (A) a method of extending within the range of a known table (CEA table), (B) a method of new extended defining of bytes skipped as padding bytes, or the like, which will be described later.

Also, the audio data output from the data extracting unit 131 is supplied to the audio encoder 133. The audio encoder 133 performs encoding such as MPEG-2 Audio AAC on the audio data, and an audio elementary stream including the encoded audio data is generated. This audio elementary stream is supplied to the multiplexer 136. The multiplexer 136 multiplexes the elementary streams output from the encoders, obtaining bitstream data BSD serving as transmission data.

“Embedding (Insertion) Method of Disparity Information to User Area”

Next, details of a method for embedding the disparity information to the user data area will be described. (A) a method of extending within the range of a known table (CEA table), (B) a method of new extended defining of bytes skipped as padding bytes, or the like, can be conceived. The method (A) is a method where the number of extended bytes is indicated by an extension command EXT1 and a value following it, with parameters being inserted thereafter.

“(A) Method of extending within range of already-existing table (Table) (1)”

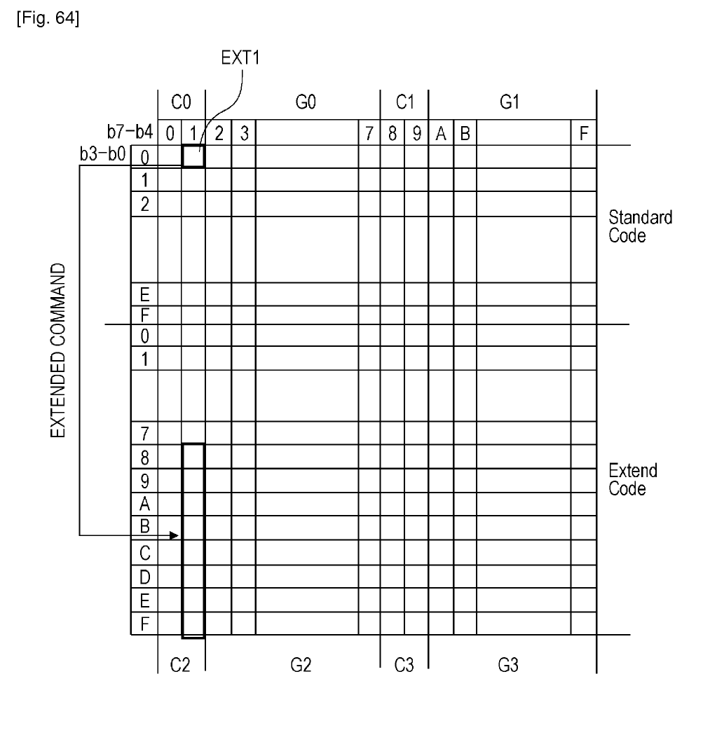

FIG. 64 schematically illustrates a CEA table. In the event of extending within this CEA table, start of an extended command is declared with the 0x10 (EXT1) command in a C0 table, following which the addresses of C2 table (C2 Table), C3 table (C3 Table), G2 table (G2 Table), and G3 table (G3 Table) are specified by the byte length of the extended command. Here, since a 3-byte command is to be configured, the following byte string is defined indicating that three bytes are to following the C2 table. Note that the address space of 0x18 through 0x1F in the C2 table indicating three bytes following is a CEA stipulation.

The total extended command in this case is as follows.

Extended command: EXT1 (0x10)+0x18 (3 bytes following)+(Byte1)+(Byte2)+(Byte3)

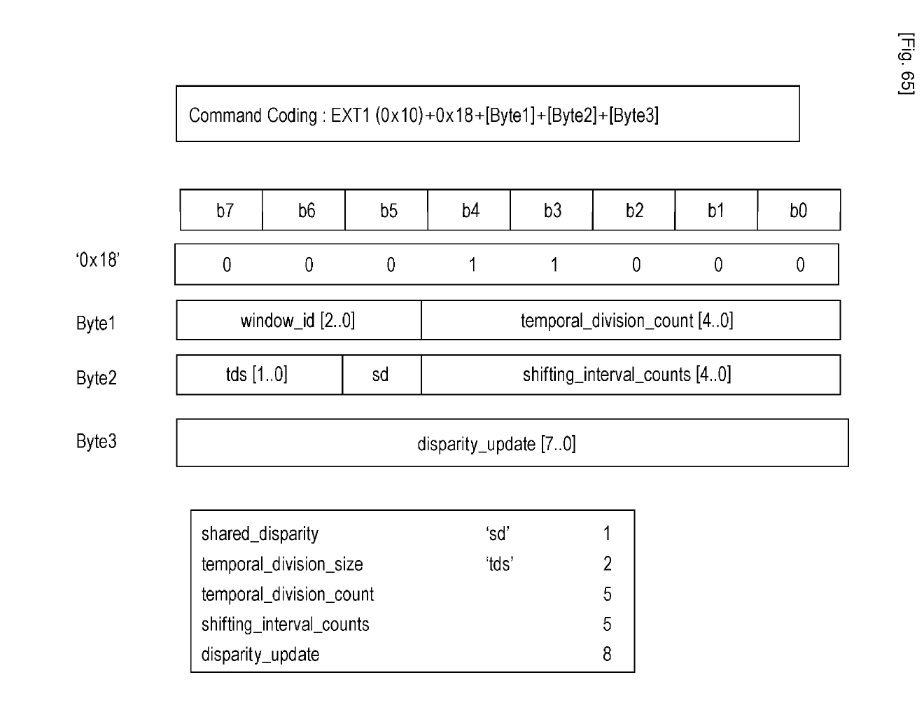

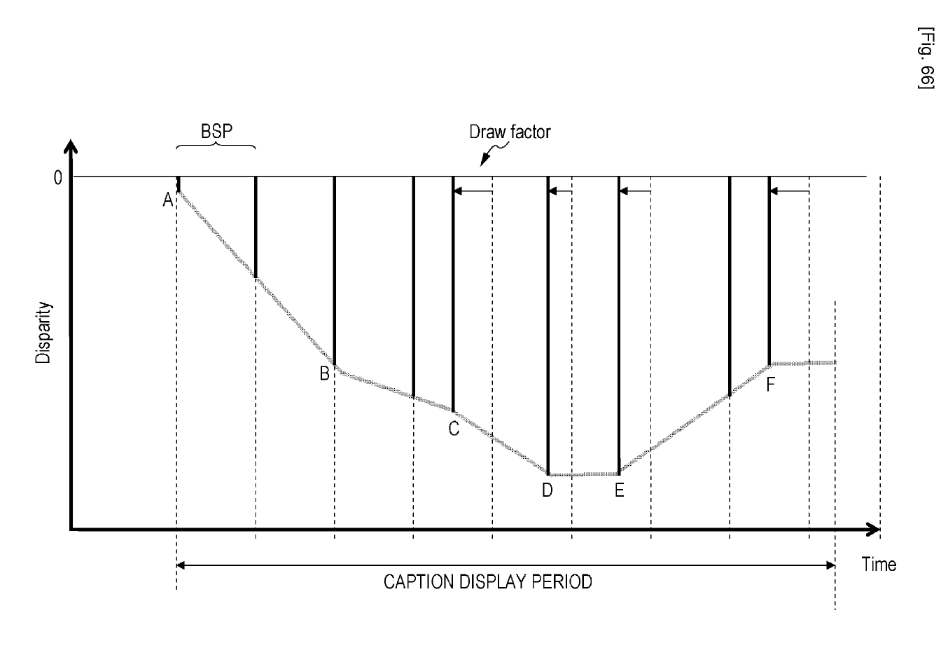

FIG. 65 illustrates a structure example of a 3-byte field of “Byte1”, “Byte2”, and“Byte3”. “window_id” is situated in a 3-bit field from the 7th bit to the 5th bit of “Byte1”. Due to this “window_id”, correlation is made with the window (window) to which the information of the extended command is to be applied. “temporal_division_count” is situated in a 5-bit field from the 4th bit to the 0th bit of “Byte1”. This “temporal_division_count” indicates the number of base segments included in the caption display period (see FIG. 22).

“temporal_division_size” is situated in a 2-bit field of the 7th bit and the 6th bit of “Byte2”. This “temporal_division_size” indicates the number of frames included in the base segment period (updating frame spacing). “00” indicates that this is 16 frames. “01” indicates that this is 25 frames. “10” indicates that this is 30 frames. Further, “11” indicates that this is 32 frames (see FIG. 22).

“shared_disparity” is situated in a 1-bit field of the 5th bit of “Byte2”. This “shared_disparity” indicates whether to perform shared disparity information (disparity) control over all windows (window). “1” indicates that one common disparity information (disparity) is to be applied to all following windows. “0” indicates that the disparity information (disparity) is to be applied to just one window (FIG. 19).

“shifting_interval_counts” is situated in a 5-bit field from the 4th bit to the 0th bit of “Byte2”. This “shifting_interval_counts” indicates the draw factor (Draw factor) for adjusting the base segment period (updating frame spacings), i.e., the number of subtracted frames (see FIG. 22).

In the updating example of disparity information for each base segment period (BSP), the base segment period is adjusted by the draw factor (Draw factor) with regard to the updating timing of disparity information at time points C through F. Due to this adjusting information existing, the base segment period (updating frame spacings) can be adjusting, and the reception side can be informed of change of disparity information in the temporal direction (frame direction) more accurately.

Note that for adjustment of the base segment period (updating frame spacings), adjusting in the direction of lengthening by adding frame scan be conceived, besides adjusting in the direction of shortening by the number of subtracting frames as described above. For example, adjusting in both directions can be performed by making the 5-bit field of “shifting_interval_counts” to be an integer with a sign.

“disparity_update” is situated in an 8-bit field from the 7th bit to the 7th bit of “Byte3”. This “disparity_update” indicates disparity information of a corresponding base segment. Note that “disparity_update” in k=0 is the initial value of disparity information sequentially updated at updating frame spacings during the caption display period, i.e., disparity information of the first frame during the caption display period.

Including the above-described 5-byte extended command in the user data area and repeatedly transmitting allows transmission (transmission) of disparity information sequentially updated during the caption display period and adjusting information of updating frame spacings added thereto.

“(A) Method of extending within range of already-existing table (Table) (2)”

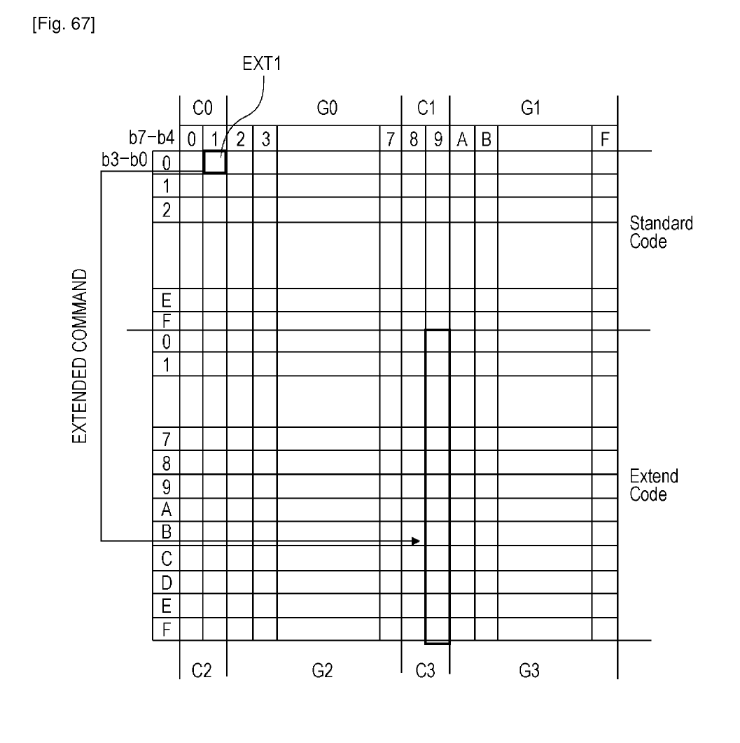

FIG. 67 schematically illustrates a CEA table. In the event of extending within this CA table, start of an extended command is declared with the 0x10 (EXT1) command in a C0 table, following which the addresses of C2 table (C2 Table), C3 table (C3 Table), G2 table (G2 Table), and G3 table (G3 Table) are specified by the byte length of the extended command. Here, since a 3-byte command is to be configured, the following byte string is defined indicating that three bytes are to following the C2 table. Note that the address space of 0x90 through 0x9F in the C3 table indicating three bytes following is a CEA stipulation.

The total extended command in this case is as follows.

Extended command: EXT1 (0x10)+EXTCode(0x90)+(Header(Byte1))+(Byte2)+ . . . +(ByteN)

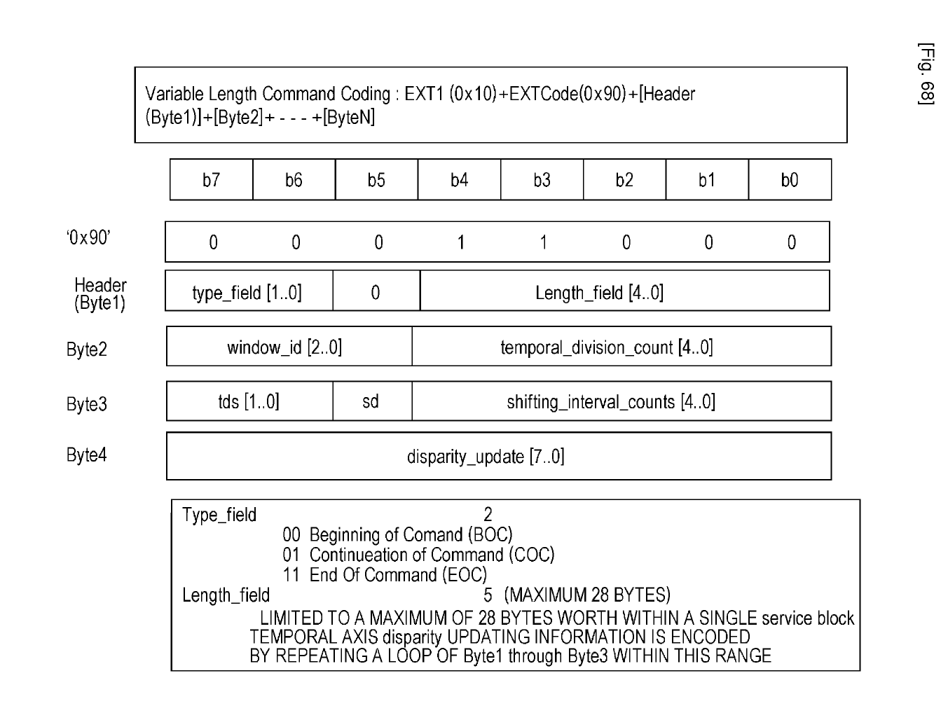

FIG. 68 illustrates a structure example of a 4-byte field of

“Header(Byte1)”, “Byte2”, “Byte3”, and “Byte4”. “type_field” is situated in a 2-bit field of the 7th bit and the 6th bit of “Header(Byte1)”. This “type_field” indicates the command type. “00” indicates the beginning of the command (BOC: Beginning of Command). “01” indicates a continuation of the command (COC: Continuation of Command). “10” indicates the end of the command (EOC: End of Command).

“Length_field” is situated in a 5-bit field from the 4th bit to the 0th bit of “Header(Byte1)”. This “Length_field” indicates the number of commands after this extended command. The maximum allowed in one service block (service block) is 28 bytes worth. Disparity information (disparity) can be updated by repeating loops of Byte2 through Byte4 within this range. In this case, a maximum of 9 sets of disparity information can be updated with one service block.

“window_id” is situated in a 3-bit field from the 7th bit to the 5th bit of “Byte2”. Due to this “window_id”, correlation is made with the window (window) to which the information of the extended command is to be applied. “temporal_division_count” is situated in a 5-bit field from the 4th bit to the 0th bit of “Byte2”. This “temporal_division_count” indicates the number of base segments included in the caption display period (see FIG. 22).

“temporal_division_size” is situated in a 2-bit field of the 7th bit and the 6th bit of “Byte3”. This “temporal_division_size” indicates the number of frames included in the base segment period (updating frame spacing). “00” indicates that this is 16 frames. “01” indicates that this is 25 frames. “10” indicates that this is 30 frames. Further, “11” indicates that this is 32 frames (see FIG. 22).

“shared_disparity” is situated in a 1-bit field of the 5th bit of “Byte3”. This “shared_disparity” indicates whether to perform shared disparity information (disparity) control over all windows (window). “1” indicates that one common disparity information (disparity) is to be applied to all following windows. “0” indicates that the disparity information (disparity) is to be applied to just one window (FIG. 19).

“shifting_interval_counts” is situated in a 5-bit field from the 4th bit to the 0th bit of “Byte3”. This “shifting_interval_counts” indicates the draw factor (Draw factor) for adjusting the base segment period (updating frame spacings), i.e., the number of subtracted frames (see FIG. 22).

“disparity_update” is situated in an 8-bit field from the 7th bit to the 0th bit of “Byte4”. This “disparity_update” indicates disparity information of a corresponding base segment. Note that “disparity_update” in k=0 is the initial value of disparity information sequentially updated at updating frame spacings during the caption display period, i.e., disparity information of the first frame during the caption display period.

Including the above-described variable-length extended command in the user data area and transmitting allows transmission (transmission) of disparity information sequentially updated during the caption display period and adjusting information of updating frame spacings added thereto.

“(B) Method for New Extended Definition of Padding Byte”

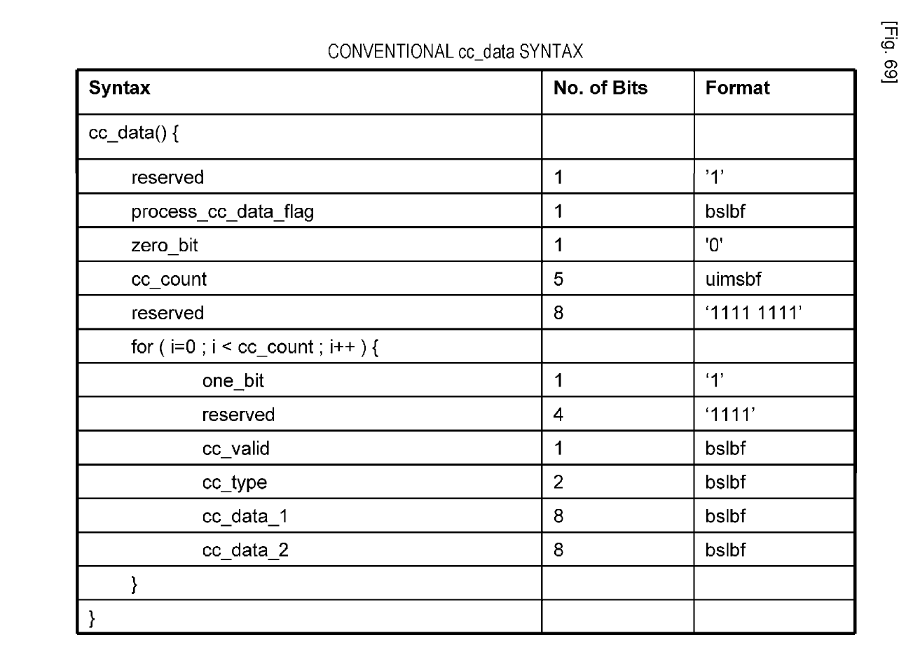

FIG. 69 illustrates a structure example (Syntax) of conventional closed caption data (CC data). It is stipulated that in the case of “cc_valid=0” and “cc_type=00”, the reception side (decoder) skips reading of the fields “cc_data_{—}1” and “cc_data_{—}2”. Here, this space is used to define an extension for transmission of disparity information (disparity).

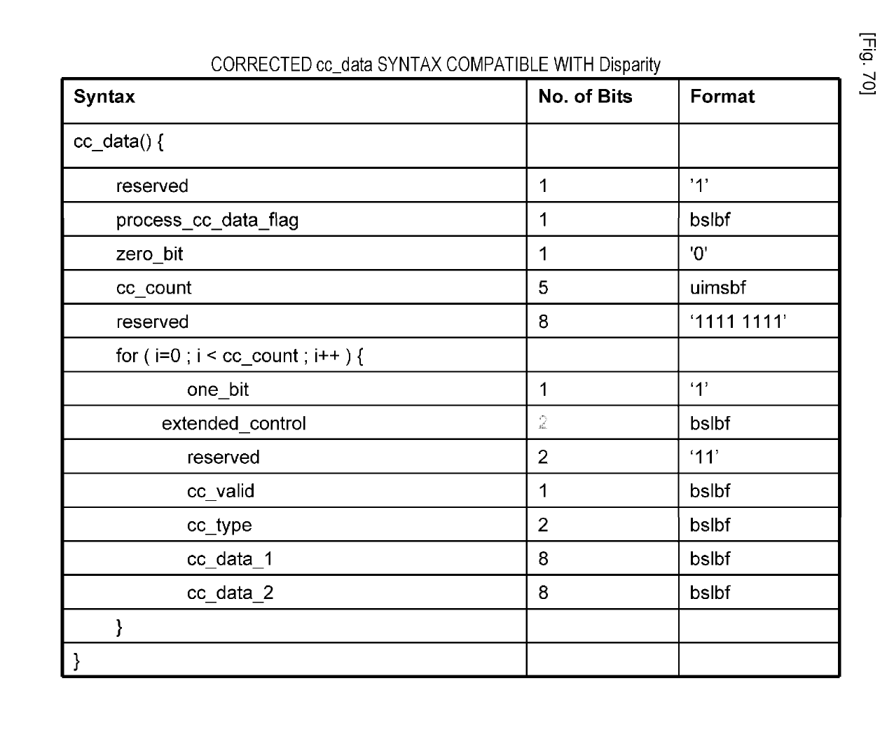

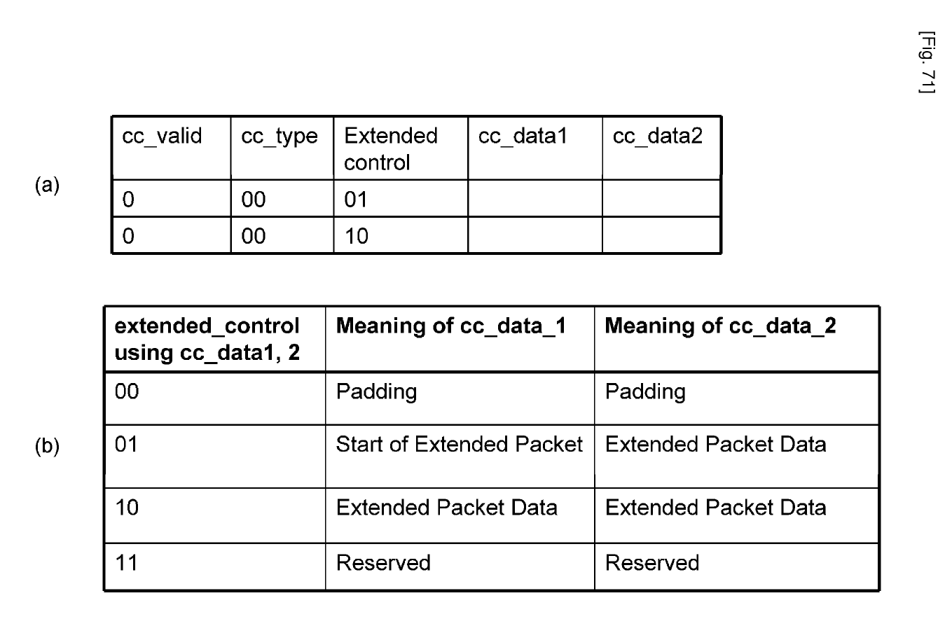

FIG. 70 is a diagram illustrating a structure example (Syntax) of conventional closed caption data (CC data) corrected to be compatible with disparity information (disparity). The 2-bit field of “extended_control” is information for controlling the two fields of “cc_data_{—}1” and“cc_data_{—}2”. As shown in FIG. 71(a), in the event that “cc_valid=0” and “cc_type=00”, and in the event that the 2-bit field of “extended_control” is “01” or “10”, the two fields of “cc_data_{—}1” and “cc_data_{—}2” are used for transmission of disparity information (disparity).

In this case, in the event that“extended_control=01” as in FIG. 71(b), the field “cc_data_{—}1” means “Start of Extended Packet”, and the first extended packet data (1 byte) is inserted. Also, at this time, the field“cc_data_{—}2” means “Extended Packet Data”, and following extended packet data (1 byte) is inserted.

Also, in the event that“extended_control=10” as in FIG. 71(b), the fields of“cc_data_{—}1” and “cc_data_{—}2” mean “Extended Packet Data”, and following extended packet data (1 byte) is inserted. Note that in the event that “extended_control=00” as in FIG. 71(b), the fields of “cc_data_{—}1” and “cc_data_{—}2” mean“Padding”.

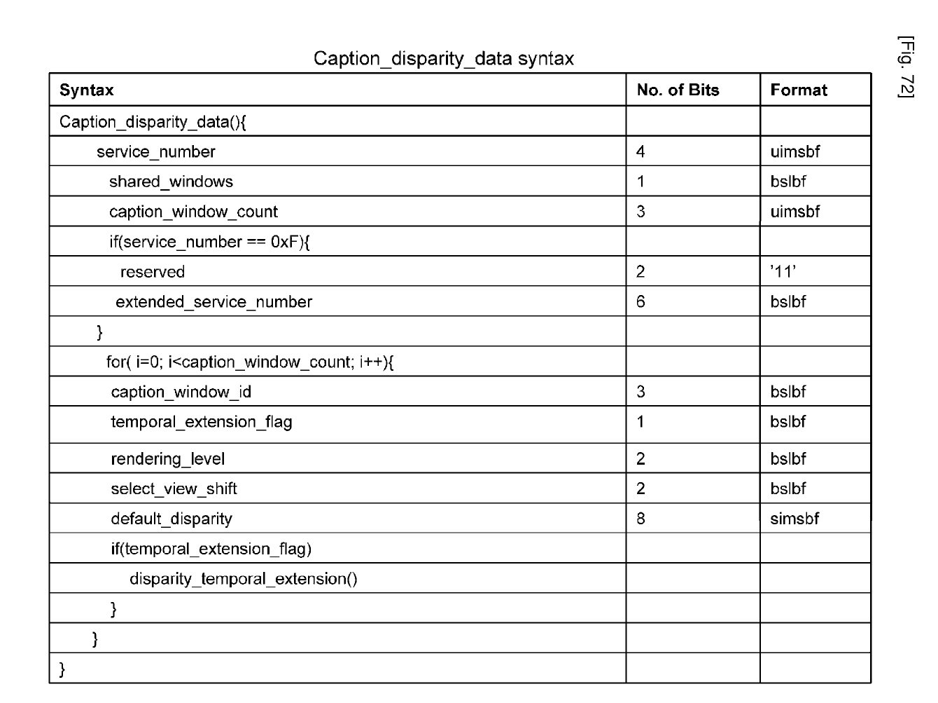

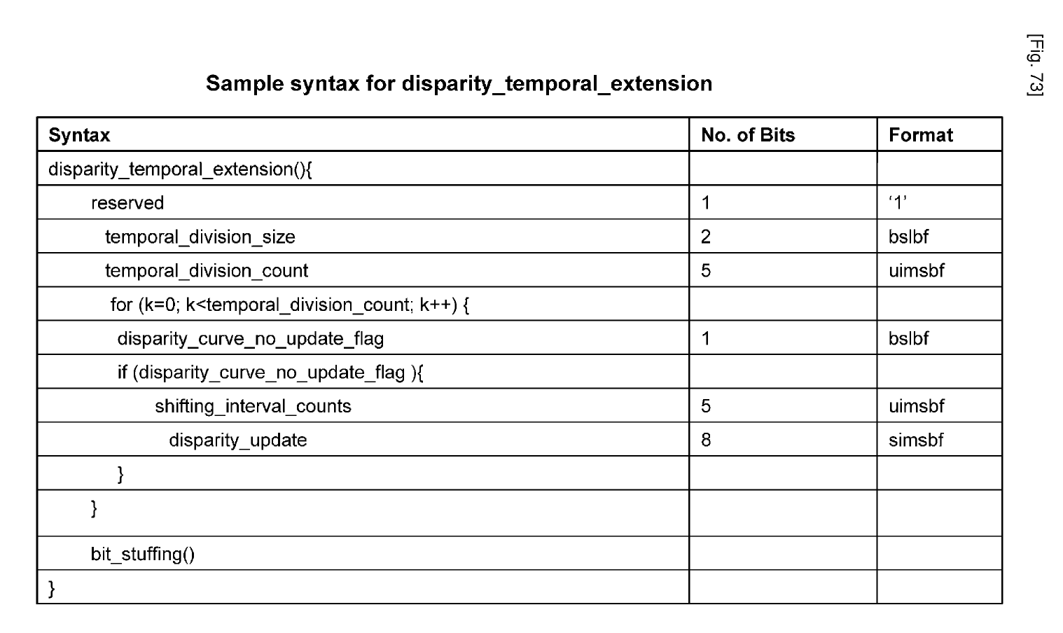

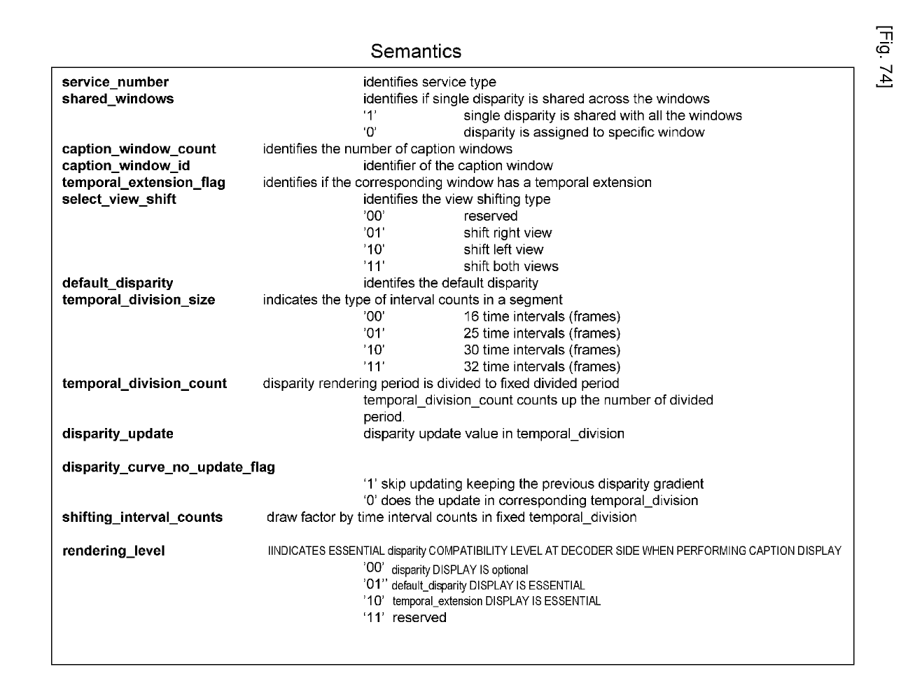

“Extended Packet Data” is then defined as the transport of “caption_disparity_data( )”. FIG. 72 and FIG. 73 illustrate a structure example (syntax) of “caption_disparity_data( )”. FIG. 74 is a diagram illustrating principal data stipulations (semantics) in the structure example of “caption_disparity_data( )”.

“service_number” is 1-bit information indicating service type. “shared_windows” indicates whether or not to perform shared disparity information (disparity) control over all windows (window). “1” indicates that one common disparity information (disparity) is to be applied to all following windows. “0” indicates that the disparity information (disparity) is to be applied to just one window.

“caption_window_count” is 3-bit information indicating the number of caption windows. “caption_window_id” is 3-bit information for identifying caption windows. “temporal_extension_flag” is 1-bit flag information indicating whether or not there exists disparity information sequentially updated during the caption display period (disparity_update). In this case, “1” indicates that there is, and “0” indicates that there is not.

“rendering_level” indicates the correspondence level of disparity information (disparity) essential at the reception side (decoder side) for displaying captions. “00” indicates that 3-dimensional display of captions using disparity information is optional (optional). “01” indicates that 3-dimensional display of captions using disparity information used in common within the caption display period (default_disparity) is essential. “10” indicates that 3-dimensional display of captions using disparity information sequentially updated within the caption display period (disparity_update) is essential.

“select_view_shift” is 2-bit information making up shift object specifying information. This “select view shift” specifies, of the closed caption information to be superimposed on the left eye image and the closed caption information to be superimposed on the right eye image, the closed caption information to be shifted based on the disparity information. “select_view_shift=00” is reserved. In the event of “select_view_shift=01”, just the closed caption information to be superimposed on the right eye image is shifted in the horizontal direction by an amount equivalent to the disparity information (disparity).

Also, in the event of “select_view_shift=10”, just the closed caption information to be superimposed on the right eye image is shifted in the horizontal direction by an amount equivalent to the disparity information (disparity). Further, in the event of “select_view_shift=11”, the closed caption information to be superimposed on the left eye image and the closed caption information to be superimposed on the right eye image are both shifted in the horizontal direction in opposite directions.

The 8-bit field of “default_disparity” indicates default disparity information. This disparity information is disparity information in the event of not being updated, i.e., disparity information used in common within the caption display period. In the event that “temporal_extension_flag=1” is “1”, “caption_disparity_data( )” has “disparity_temporal_extension( )”. Basically, disparity information to be updated every base segment period (BSP: Base Segment Period) is stored here.

As described above, FIG. 20 illustrates an updating example of disparity information each base segment period (BSP). The base segment period means an updating frame spacing. As can be sent from this drawing, the disparity information sequentially updated during the caption display period is made up of the first frame of the period of the predetermined number of frames, and disparity information of frames at subsequent base segment periods (updating frame spacings).

FIG. 73 illustrates a structure example (syntax) of “disparity_temporal_extension( )”. The 2-bit field of “temporal_division_size” indicates the number of frames included in the base segment period (updating frame spacings). “00” indicates that this is 16 frames. “01” indicates that this is 25 frames. “10” indicates that this is 30 frames. Further, “11” indicates that this is 32 frames.

“emporal_division_count” indicates the number of base segments included in the caption display period. “disparity_curve_no_update_flag” is 1-bit flag information indicating whether or not there is updating of disparity information. “1” indicates that updating of disparity information at the edge of the corresponding base segment is not to be performed, i.e., is to be skipped, and “0” indicates that updating of disparity information at the edge of the corresponding base segment is to be performed.

In the example of updating of disparity information every base segment period (BSP) in FIG. 23 described above, disparity information is not updated at the edge of a base segment to which “skip” has been appended. Due to the presence of this flag, in the event that the period where change of disparity information in the frame direction is the same continues for a long time, transmission of the disparity information within the period can be omitted by not updating the disparity information, thereby enabling the data amount of disparity information to be suppressed.

In the event that “disparity_curve_no_update_flag” is“0” and updating of disparity information is to be performed, “shifting_interval_counts” of the corresponding segment is included. On the other hand, in the event that “disparity_curve_no_update_flag” is “1” and updating of disparity information is not to be performed, “disparity_update” of the corresponding segment is not included. The 6-bit field of “shifting_interval_counts” indicates the draw factor (Draw factor) for adjusting the base segment period (updating frame spacings), i.e., the number of subtracted frames.

In the updating example of disparity information for each base segment period (BSP), the base segment period is adjusted for the updating timings for the disparity information at points-in-time C through F, by the draw factor (Draw factor). Due to the presence of this adjusting information, the base segment period (updating frame spacings) can be adjusted, and the change in the temporal direction (frame direction) of the disparity information can be informed to the reception side more accurately.

Note that for adjusting the base segment period (updating frame spacings), adjusting in the direction of lengthening by adding frames, besides adjusting in the direction of shortening by the number of subtracting frames as described above. For example, adjusting in both directions can be performed by making the 5-bit field of “shifting_interval_counts” to be an integer with a sign.

As described above, by making anew extended definition for bytes which has been skipped in reading as padding bytes, disparity information sequentially updated during the caption display period, and adjusting information of updating frame spacings added thereto and so forth can be transmitted (transmitted).

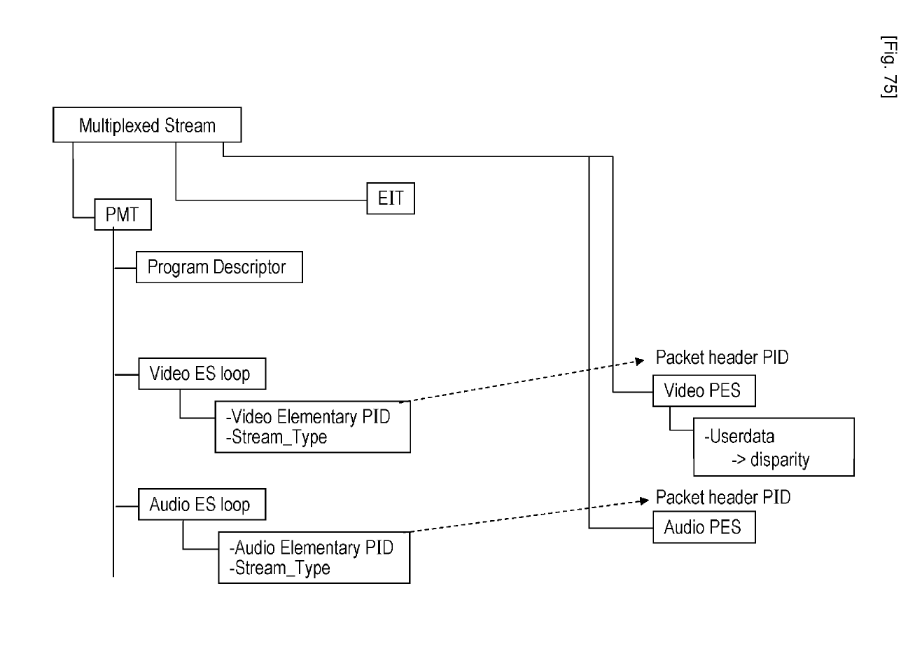

FIG. 75 is a diagram illustrating a configuration example of a general transport stream (multiplexed data stream) including a video elementary stream, audio elementary stream, and caption elementary stream. This transport stream includes PES packets obtained by packetizing the elementary streams. With this configuration example, PES packets “Video PES” of the video elementary stream are included. Also, with this configuration example, PES packets “Audio PES” of the audio elementary stream, PES packets of the caption elementary stream“Subtitle PES” are included.

Also, the transport stream includes a PMT (Program Map Table) as PSI (Program Specific Information). This PSI is information describing to which program each elementary stream included in the transport stream belongs. Also, the transport stream includes an EIT (Event Information Table) as SI (Services Information) regarding which management is performed in increments of events.

A program descriptor (ProgramDescriptor) describing information relating to the entire program exists in the PMT. Also an elementary loop having information relating to each elementary stream exists in this PMT. With this configuration example, there exists a video elementary loop, an audio elementary loop, and a subtitle elementary loop. Each elementary loop has disposed therein information such as packet identifier (PID), stream type (Stream_Type), and the like, for each stream, and also while not shown in the drawings, a descriptor describing information relating to the elementary stream is also disposed therein.

With the transmission data generating unit 110B shown in FIG. 62, disparity information (disparity) is transmitted (transmitted) having been embedded in a user data area of disparity information of a video elementary stream as shown in FIG. 75.

With the transmission data generating unit 110B shown in FIG. 62, stereoscopic image data including left eye image data and right eye image data for displaying a stereoscopic image is included in the payload portion of a video elementary stream and- transmitted. Also, CC data and disparity information for applying disparity to closed caption information of the CC data are transmitted having been inserted in the user data area of the header portion of the video elementary stream.

Accordingly, at the reception side (set top box 200), stereoscopic image data can be obtained form the video elementary stream, and also, CC data and disparity information can be easily obtained. Also at the reception side, appropriate disparity can be applied to the same closed caption information superimposed on the left eye image and right eye image, using disparity information. Accordingly, when displaying closed caption information, consistency in perspective with the objects in the image can be maintained in an optimal state.

Also, with the transmission data generating unit 110B shown in FIG. 62, disparity information sequentially updated during the caption display period (see “disparity_update” in FIG. 65, FIG. 68, and FIG. 73) can be inserted. Accordingly, at the reception side (set top box 200), the disparity to be applied to the closed caption information can be dynamically changed in conjunction with changes in the contents of the image.

Also, with the transmission data generating unit 110B shown in FIG. 62, the disparity information sequentially updated during the caption display period is made up of the first frame of the period of the predetermined number of frames, and disparity information of frames at subsequent updating frame spacings. Accordingly, the amount of transmission data can be reduced, and the memory capacity for holding the disparity-information at the reception side can be greatly conserved.

Also, with the transmission data generating unit 110B shown in FIG. 62, “disparity_temporal_extension( )” included in “caption_disparity_data( )” is of the same structure as the “disparity_temporal_extension( )” included in the SCS segment described above (see FIG. 21). Accordingly, while detailed description will be omitted, the transmission data generating unit 110B shown in FIG. 62 can obtain the same advantages as the transmission data generating unit 110 shown in FIG. 2 due to this “disparity_temporal_extension( )” structure.

“Configuration Example of Transmission Data Generating Unit”

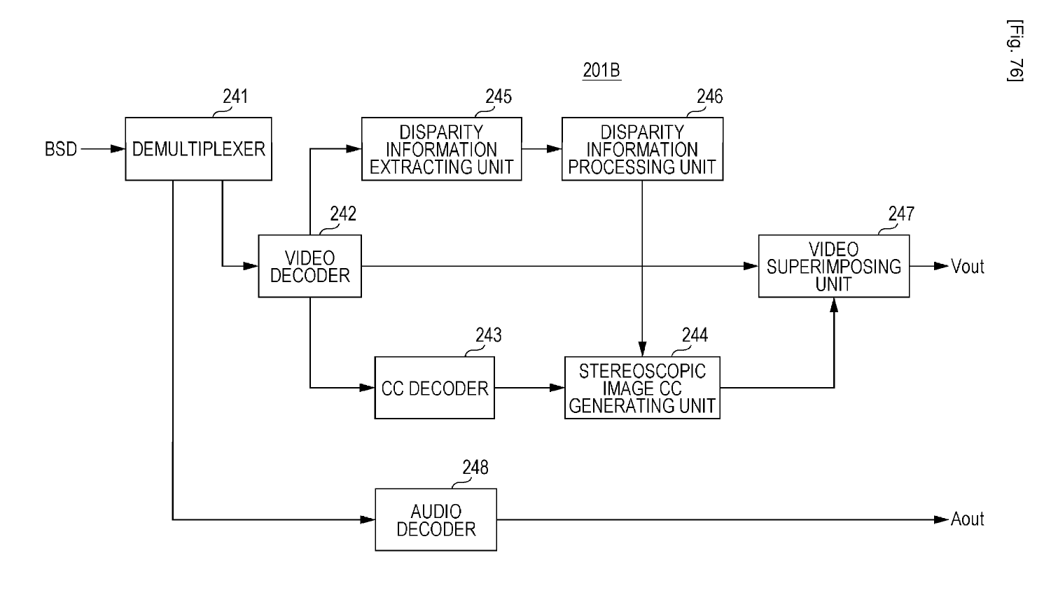

FIG. 76 is a configuration example of a bit stream processing unit 201B of the set top box 200, corresponding to the transmission data generating unit 110B shown in FIG. 62 described above. This bit stream processing unit 201B is of a configuration corresponding to the transmission data generating unit 110B shown in FIG. 62 described above. This bit stream processing unit 201B includes a demultiplexer 241, a video decoder 242, and a CC decoder 243. Also, this bit stream processing unit 201B includes a stereoscopic image CC generating unit 244, a disparity information extracting unit 245, a disparity information processing unit 246, a video superimposing unit 247, and an audio encoder 248.

The demultiplexer 241 extracts video and audio packets from the bit stream data BSD, and sends these to the encoders. The video decoder 242 performs processing opposite to the video decoder 132 of the transmission data generating unit 110B described above. That is to say, the video decoder 242 reconstructs the video elementary stream from the video packets extracted by the demultiplexer 241, performs decoding processing, and obtains stereoscopic image data including left eye image data and right eye image data.

The transmission format for the stereoscopic image data is, for example, the above-described first transmission format (“Top & Bottom” format), second transmission format (“Side by Side” format), third transmission format (“FrameSequential” format), and so forth (see FIG. 4(a) through (c)). The video decoder 242 sends this stereoscopic image data to the video superimposing unit 247.

The CC decoder 243 extracts CC data from the video elementary stream reconstructed at the video decoder 242. The CC decoder 243 then obtains closed caption information (character code for captions), and further control data of superimposing position and display time, for each caption window (Caption Window).

The disparity information extracting unit 245 extracts disparity information from the video elementary stream obtained through the video decoder 242. This disparity information is correlated with closed caption data (character code for captions) for each caption window (Caption Window) obtained at the CC decoder 243 described above. This disparity information is a disparity vector for each caption window (individual disparity vector), or a disparity vector common to each caption window (shared disparity vector).

The disparity information extracting unit 245 obtains disparity information used in common during the caption display period, or disparity information sequentially updated during the caption display period. The disparity information extracting unit 245 sends this disparity information to the stereoscopic image CC generating unit 244 via the disparity information processing unit 246. The disparity information sequentially updated during the caption display period is made up of disparity information of the first frame in the caption display period, and disparity information of frames for each base segment period (updating frame spacing) thereafter.

For disparity information used in common during the caption display period, the disparity information processing unit 246 sends this to the stereoscopic image CC generating unit 244 without change. On the other hand, with regard to the sequentially updated disparity information during the caption display period, the disparity information processing unit 246 performs interpolation processing and generates disparity information at arbitrary frame spacings during the caption display period, at one frame spacings for example, and sends this to the stereoscopic image CC generating unit 244. For this interpolation processing, the disparity information processing unit 246 performs interpolation processing involving low-pass filter (LPF) processing in the temporal direction (frame direction) rather than linear interpolation processing, so as to smooth change in the disparity information in predetermined frame spacings following the interpolation processing in the temporal direction (frame direction) (see FIG. 31).

The stereoscopic image CC generating unit 244 generates data of left eye closed caption information (caption) and right eye closed caption information (caption), for the left eye image and right eye image, for each caption window (Caption Window). This- generating processing is performed based on the closed caption data and superimposing processing control data obtained at the CC decoder 243, and the disparity information sent from the disparity information extracting unit 245 via the disparity information processing unit 246 (disparity vector). The stereoscopic image CC generating unit 244 outputs data for the left eye captions and right eye captions (bitmap data).

In this case, the left captions and right eye captions are the same information. However, the superimposing positions of the left eye caption and right eye caption within the image are shifted in the horizontal direction by an amount equivalent to the disparity vector, for example. Accordingly, the same caption superimposed on the left eye image and right eye image can be used with disparity adjustment performed therebetween in accordance with the perspective of objects in the image, and accordingly, consistency in perspective with the objects in the image can be maintained in an optimal state.

Now, in the event that only disparity information (disparity vector) to be used in common during the caption display period is transmitted from the disparity information processing unit 246, for example, the stereoscopic image CC generating unit 244 uses this disparity information. Also, in the event that only disparity information (disparity vectors) sequentially updated during the caption display period is also transmitted from the disparity information processing unit 246, for example, the stereoscopic image CC generating unit 244 uses this disparity information. Further, in the event that disparity information to be used in common during the caption display period and disparity information sequentially updated during the caption display period are both transmitted from the disparity information processing unit 246, for example, the stereoscopic image CC generating unit 244 uses one or the other.

Which to use is constrained by information (“rendering_level” indicating the level of correlation of disparity information (disparity) that is essential at the reception side (decoder) side for displaying captions, included in the extended display control data unit. In this case, in the event of “00” for example, user settings as applied. Using disparity information sequentially updated during the caption display period enables disparity to be applied to the left eye subtitles and right eye subtitles to be dynamically changed in conjunction with changes in the contents of the image.

The video superimposing unit 247 superimposes the left eye and right eye caption data (bitmap data) generated at the stereoscopic image CC generating unit 244 onto the stereoscopic image data (left eye image data and right eye image data) obtained at the video decoder 242, and obtains display stereoscopic image data Vout. The video superimposing unit 247 then externally outputs the display stereoscopic image data Vout from the bit stream processing unit 201B.

Also, the audio encoder 248 performs processing opposite to that of the audio encoder 133 of the transmission data generating unit 110B described above. That is to say, this audio encoder 248 reconstructs the audio elementary stream from the audio packets extracted at the demultiplexer 241, performs decoding processing, and obtains audio data Aout. This audio encoder 248 then externally outputs the audio data Aout from the bit stream processing unit 201B.

The operations of the bit stream processing unit 201B shown in FIG. 76 will be described in brief. The bitstream data BSD output from the digital tuner 204 (see FIG. 29) is supplied to the demultiplexer 241. At the demultiplexer 241, video and audio packets are extracted from the bit stream data BSD, and supplied to the decoders. At the video decoder 242, the video elementary stream is reconstructed from the video packets extracted at the demultiplexer 241, decoding processing is further performed, and stereoscopic image data including left eye image data and right eye image data is obtained. This stereoscopic image data is supplied to the video superimposing unit 247.

Also, the video elementary stream reconstructed at the video decoder 242 is supplied to the CC decoder 243. At the CC decoder 243, CC data is extracted from the video elementary stream. With this CC decoder 243, closed caption information (Charactercode for captions), and further control of data superimposing position and display time, for each caption window (Caption Window), are obtained from the CC data. This closed caption information and control data of data superimposing position and display time are supplied to the stereoscopic image CC generating unit 244.

Also, the video elementary stream reconstructed at the video decoder 242 is supplied to the disparity information extracting unit 245. At the disparity information extracting unit 245, disparity information is extracted from the video elementary stream. This- disparity information is correlated with the closed caption data (charactercode for captions) for each caption window (Caption Window) obtained at the CC decoder 243 described above. This disparity information is supplied to the stereoscopic image CC generating unit 244 via the disparity information processing unit 246.

At the disparity information processing unit 246, the following processing is performed regarding the disparity information sequentially updated during the caption display period. That is to say, at the disparity information processing unit 246, interpolation processing is performed involving low-pass filter (LPF) processing in the temporal direction (frame direction), generating disparity information at arbitrary frame spacings during the caption display period, atone frame spacings for example, which is sent to the stereoscopic image CC generating unit 244.

At the stereoscopic image CC generating unit 244, data of left eye closed caption information (captions) and right eye closed caption information (captions) is generated for each caption window (Caption Window). This generating processing is performed based on the closed caption data and superimposed position control data obtained at the CC decoder 243 and the disparity information (disparity vectors) supplied from the disparity information extracting unit 245 via the disparity information processing unit 246.

At the stereoscopic image CC generating unit 244, one or both of the left eye closed caption information and right eye closed caption information are subjected to shift processing to apply disparity. In this case, in the event that the disparity information-supplied via the disparity information processing unit 246 is disparity information to be used in common among the frames, disparity is applied to the closed caption information to be superimposed on the left eye image and right eye image, based on this common disparity information. Also, in the event that the disparity information is disparity information to be sequentially updated at each frame, the disparity information updated at each frame is applied to the closed caption information superimposed on the left eye image and right eye image.

Thus, the data of closed caption information (bitmap data) for the left eye and right eye, generated for each caption window (Caption window) at the stereoscopic image CC generating unit 244 is supplied to the video superimposing unit 247 along with the control data for display time. At the video superimposing unit 247, data of the closed caption information supplied from the stereoscopic image CC generating unit 244 is superimposed on the stereoscopic image data (left eye image data and right eye image data) obtained at the video decoder 242, and display stereoscopic image data Vout is obtained.

Also, at the audio encoder 248, the audio elementary stream is reconstructed from audio packets extracted from the demultiplexer 241, and further encoding processing is performed, thereby obtaining audio data Aout corresponding to the display stereoscopic image data Vout described above. This audio data Aout is externally output from the bit stream processing unit 201B.

With the bit stream processing unit 201B shown in FIG. 76, stereoscopic image data can be obtained from the payload portion of the video elementary stream, and also CC data and disparity information can be obtained from the user data area of the header portion. Accordingly, the closed caption information to be superimposed on the left eye image and right eye image can be provided with suitable disparity, using disparity information matching this closed caption information. Accordingly, when displaying closed caption information, consistency in perspective with the objects in the image can be maintained in an optimal state.

Also, with the disparity information extracting unit 245 of the bit stream processing unit 201B shown in FIG. 76, disparity information used in common during the caption display period, or disparity information sequentially updated during the caption display period, is obtained. Using the disparity information sequentially updated during the caption display period at the stereoscopic image CC generating unit 244 enables disparity to be applied to closed caption information to be superimposed on the left eye image and right eye image to be dynamically changed in conjunction with changes in the contents of the image.

Also, with the disparity information processing unit 246 of the bit stream processing unit 201B shown in FIG. 76, disparity information sequentially updated during the caption display period is subjected to interpolation processing, and disparity information of arbitrary frame spacings during the caption display period is generated. In this case, even in the event of disparity information being transmitted from the transmission side (broadcasting station 100) each base segment period (updating frame spacing) such as 16 frames or the like, the disparity to be applied to the closed caption information superimposed on the left eye image and right eye image can be controlled in fine spacings, e.g., each frame.

Also, with the disparity information processing unit 236 of the bit stream processing unit 201B shown in FIG. 76, interpolation processing involving low-pass filter processing in the temporal direction (frame direction) is performed. Accordingly, even in the event of disparity information being transmitted from the transmission side (broadcasting station 100) each base segment period (updating frame spacing), change of the disparity information in the temporal direction (frame direction) after interpolation processing can be made smooth (see FIG. 31). Accordingly, an unnatural sensation of the transition of disparity applied to the closed caption information superimposed on the left eye image and right eye becoming discontinuous at each updating frame spacing can be suppressed.

### 2. Modifications

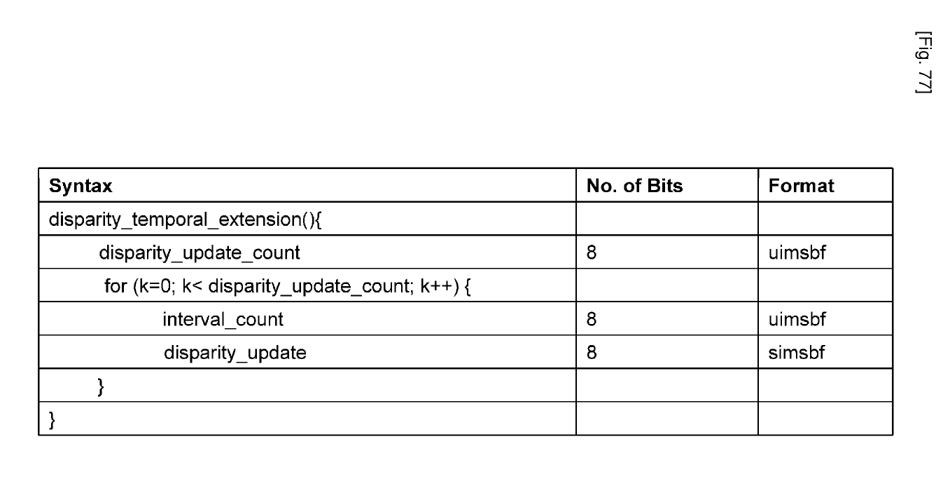

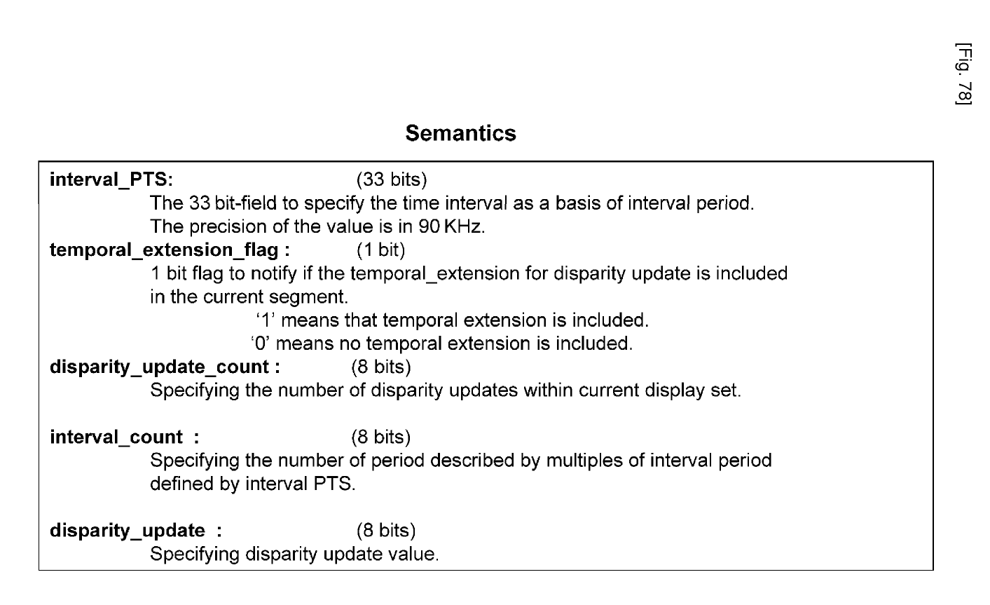

Note that FIG. 77 illustrates another structure example (syntax) of “disparity_temporal_extension( )”. Also, FIG. 78 illustrates principal data stipulations (semantics) in the structure example of “disparity_temporal_extension( )”. The 8-bit field of “disparity_update_count” indicates the number of updates of disparity information (disparity). There is a for loop restricted by the number of times of update of the disparity information.

The 8-bit field of “interval_count” indicates the updating period in terms of a multiple of the interval period (Interval period) indicated by “interval_PTS” described later. The 8-bit field of “disparity_update” indicates disparity information of a corresponding updating period. Note that“disparity_update” when k=0 is the initial value of disparity information sequentially updated at updating frame spacings during the caption display period, i.e., disparity information of the first frame during the caption display period.

Note that in the event of using“disparity_temporal_extension( )” of the structure shown in FIG. 77 instead of “disparity_temporal_extension( )” of the structure shown in FIG. 21, a 33-bit field of “interval_PTS” is provided in portion including the substantial information of SCS (Subregion Composition segment) shown in FIG. 18. This “interval_PTS” specifies the interval period (Interval period) in 90 KHz increments. That is to say, “interval_PTS” represents a value where this interval period (Interval period) was measured with a 90-KHz clock, with a 33-bit length.

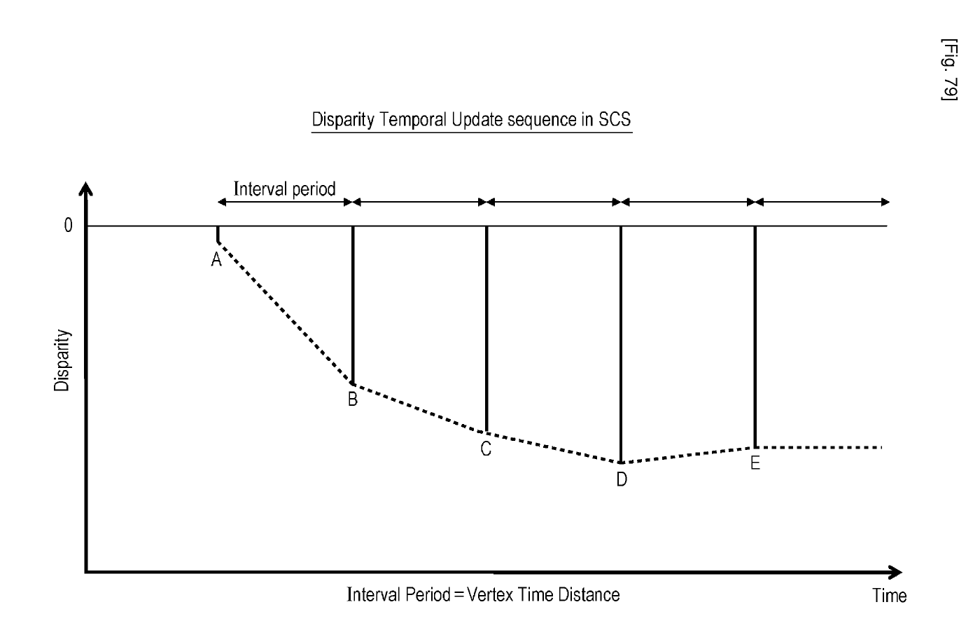

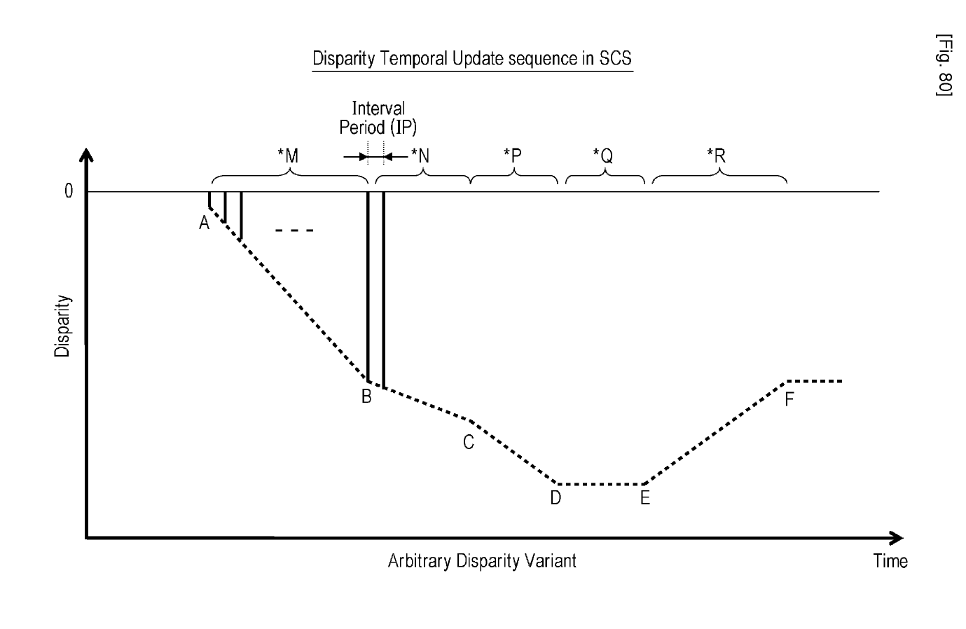

FIG. 79 and FIG. 80 illustrate an updating example of disparity information in a case of using the “disparity_temporal_extension( )” of the structure shown in FIG. 77. FIG. 79 is a diagram illustrating a case where the interval period (Interval period) indicated by “interval_PTS” is fixed, and moreover the period is equal to the updating period. In this case, “interval_count” is“1”.

On the other hand, FIG. 80 is a diagram illustrating an example of updating disparity information in a case where the interval period (Interval period) indicated by “interval_PTS” is a short period (e.g., may be a frame cycle). In this case, “interval_count” is M, N, P, Q, R at each updating period. Note that in FIG. 79 and FIG. 80, “A” indicates the start frame of the caption display period (start point), and “B” through “F” indicate subsequent updating frames (updating points).

The same processing as described above can be performed at the reception side in the event of sending disparity information sequentially updated during the caption display period to the reception side (set top box 200 or the like) using the “disparity_temporal_extension( )” of the structure shown in FIG. 77, as well. That is to say, in this case as well, by performing interpolation processing on the disparity information each updating period at the reception side, disparity information at arbitrary frame spacings, one frame spacings for example, can be generated and used.

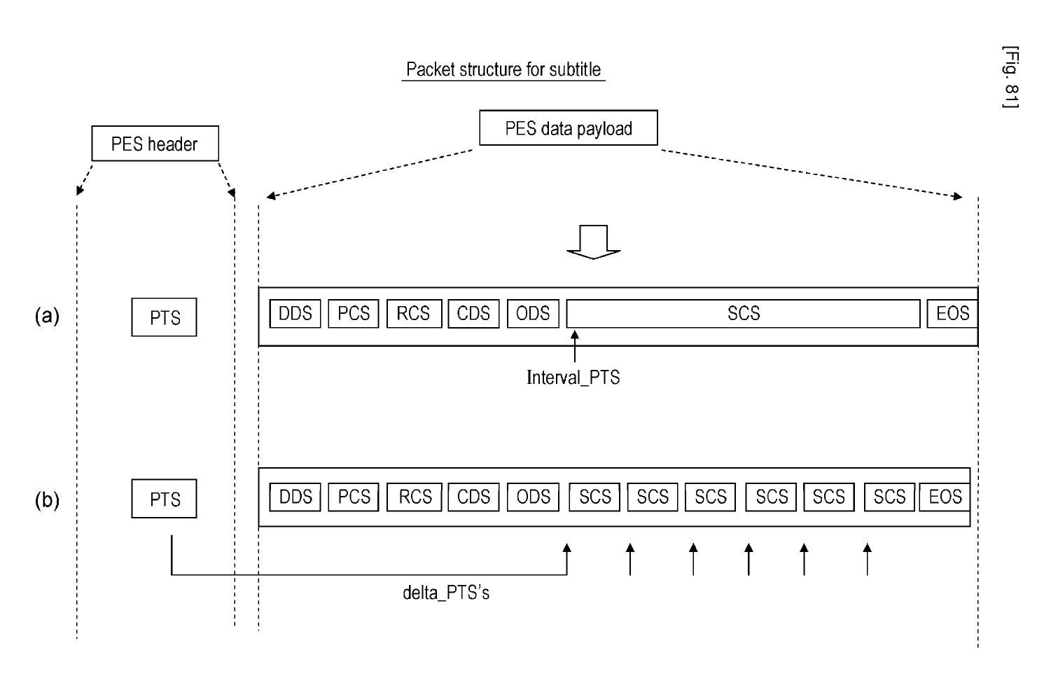

FIG. 81(a) illustrates a configuration example of a subtitle data stream in a case of using the “disparity_temporal_extension( )” of the structure shown in FIG. 77. Time information (PTS) is included in the PES efficient. Also, the segments of DDS, PCS, RCS, CDS, ODS, SCS, and EDS are included as PES payload data. These are transmitted in batch before the subtitle display period starts. While not described above, a configuration example of a subtitle data stream in the case of using the “disparity_temporal_extension( )” of the structure shown in FIG. 21 is also the same.

Note that the disparity information sequentially updated during the caption display period can be sent to the reception side (set top box 200 or the like) without including the “disparity_temporal_extension( )” in the SCS segment. In this case, “temporal_extension_flag=0” is set, and only“subregion_disparity” is encoded at the SCS segment (see FIG. 18). In this case, an SCS segment is inserted into the subtitle data stream each timing that updating is performed. In such a case, while omitted from the drawings, a time difference value (delta PTS) is added to each updating timing SCS segment as time information.

FIG. 81(b) illustrates a configuration of the subtitle data stream in such a case. First, the segments of DDS, PCS, RCS, CDS, ODS, and SCS are transmitted as PES payload data. Subsequently, at a timing of performing updating, a predetermined number of SCS segments of which the time difference value (delta PTS) and disparity information have been updated are transmitted. Finally, an EDS segment is also transmitted with the SCS segments.

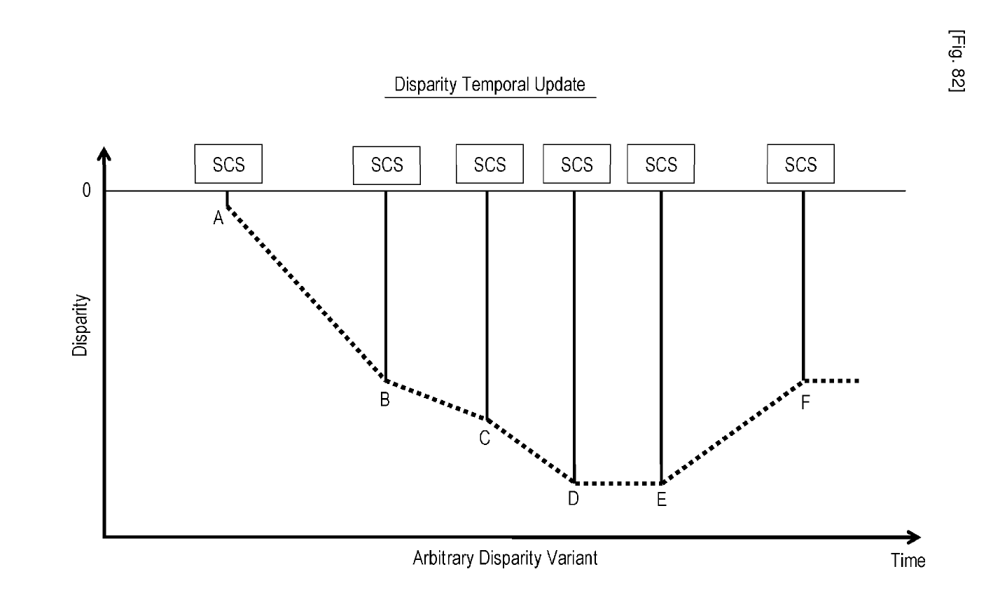

FIG. 82 illustrates an updating example of disparity information in a case of sequentially transmitting SCS segments as described above. Note that in FIG. 82, “A” indicates the start frame of the caption display period (start point), and “B” through “F” indicate subsequent updating frames (updating points).

In the case of sequentially transmitting SCS segments and sending disparity information sequentially updated during the caption display period to the reception side (set top box 200 or the like) as well, the same processing as described above can be performed at the reception side. That is to say, in this case as well, by performing interpolation processing on the disparity information each updating period at the reception side, disparity information at arbitrary frame spacings, one frame spacings for example, can be generated and used.

Note that description of using the“disparity_temporal_extension” of the structure shown in FIG. 77 described above has been made with reference to description of the transmission data generating unit 110 shown in FIG. 2 (FIG. 21, etc.). However, while detailed description will be omitted, this can also be equally applied to the ARIB format and CEA format, not just the DVB format, as a matter of course.

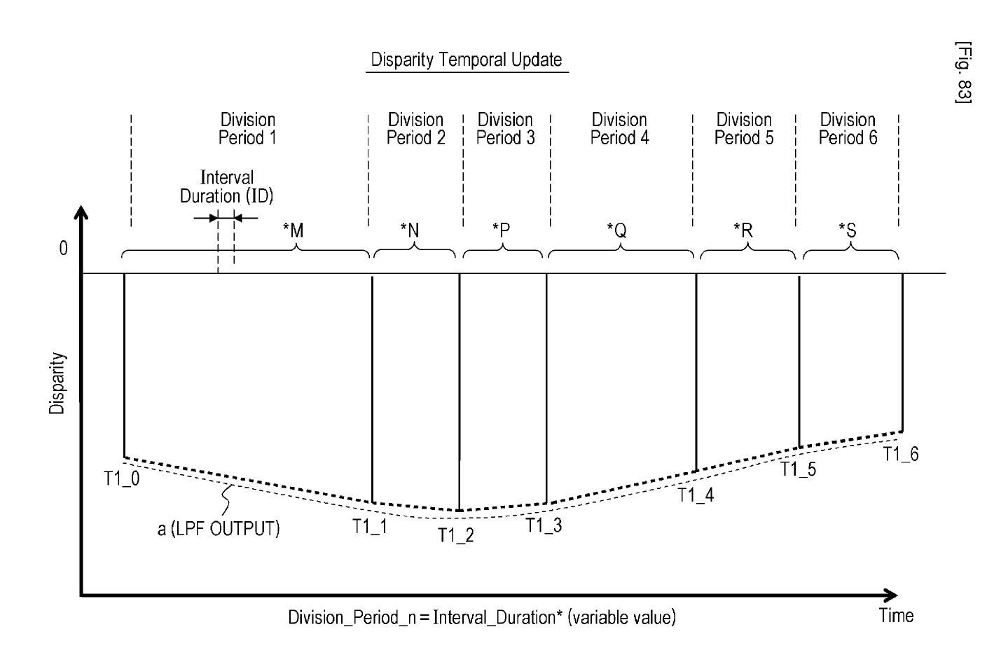

FIG. 83 illustrates an example of updating disparity information (disparity), the same as with FIG. 80 described above. The updating frame spacing is represented as a multiple of an interval period (ID: Interval Duration) serving as an increment period. For example, an updating frame spacing “Division Period 1” is represented as “ID*M”, an updating frame spacing “Division Period 2” is represented as “ID*N”, and so on for the subsequent updating frame spacings. With the updating example of disparity information shown in FIG. 83, the updating frame spacings are not fixed, and the updating frame spacings are set in accordance with the disparity information curve.

Also, in an example of updating this disparity information (disparity), at the reception side, a start frame of the caption display period (start point-in-time) T1_0 is provided as a PTS (Presentation Time Stamp) inserted in the header of a PES stream where this- disparity information is provided. At the reception side, each updating point-in-time of disparity information is obtained based on the interval period information which is information of each updating frame spacing (increment period information) and information of the number of the interval periods.

In this case, the updating points-in-time are sequentially obtained from the start frame of the caption display period (start point-in-time) T1_0, based on the following Expression (1). In this Expression (1), “interval_count” indicates the number of interval periods, which is a value equivalent to M, N, P, Q, and S in FIG. 83. Also, in this Expression (1), “interval_time” is a value equivalent to the interval period (ID) in FIG. 83.

Tm_{—}n=Tm_(n−1)+(interval_time*interval_count) (1)

For example, in the updating example shown in FIG. 83, the updating points-in-time are obtained as follows based on this Expression (1). That is to say, the updating point-in-time T1_1 is obtained as “T1_1=T1_0+(ID*M)”, using the startpoint-in-time (T1_0), interval period (ID), and number (M). Also, the updating point-in-time T1_2 is obtained as “T1_2=T1_{—}1+(ID*N)”, using the updating point-in-time (T1_1), interval period (ID), and number (N). The subsequent points-in-time are also obtained in the same way.

In the updating example shown in FIG. 83, at the reception side, interpolation-processing is performed regarding the disparity information sequentially updated during the caption display period, generating disparity information at arbitrary frame spacings during the caption display period, at one frame spacings for example. For this interpolation processing, interpolation processing involving low-pass filter (LPF) processing in the temporal direction (frame direction) is performed rather than linear interpolation processing, so as to smooth change in the disparity information in predetermined frame spacings following the interpolation processing in the temporal direction (frame direction). The dashed line a in FIG. 83 illustrates an example of LPF output.

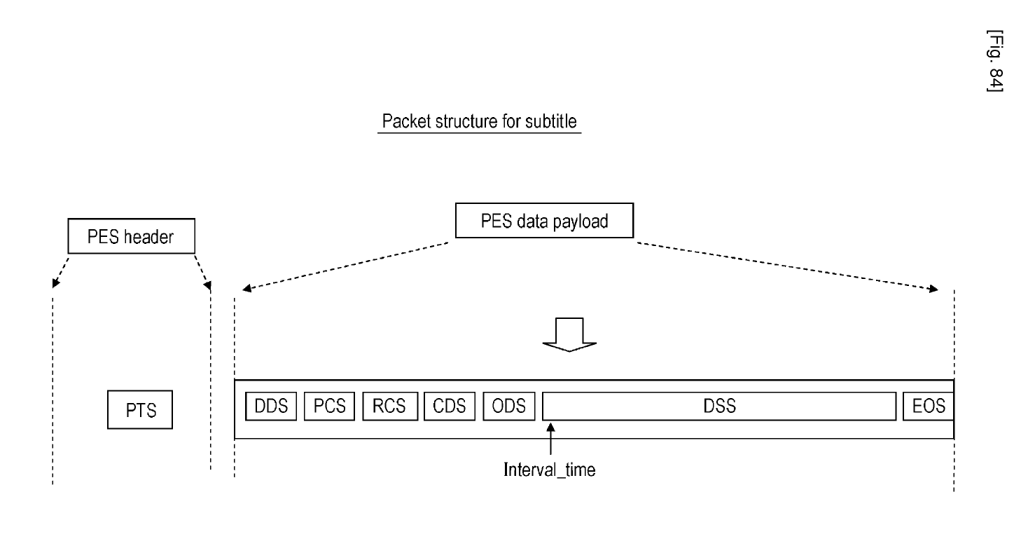

FIG. 84 illustrates a configuration example of a subtitle data stream. The PES header includes time information (PTS). Also, the segments of DDS, PCS, RCS, CDS, ODS, DSS (Disparity Signaling Segment), and EDS are included as PES payload data. These are transmitted in batch before the subtitle display period starts.

A DSS segment includes disparity information for realizing the disparity information updating such as shown in FIG. 83 described above. That is to say, this DSS includes disparity information of the start frame of the caption display period (startpoint-in-time) and disparity information of frames at each subsequent updating frame spacing. Also, this disparity information has appended thereto information of interval period (increment period information) and information of the number of interval periods, as updating frame spacing information. Accordingly, at the reception side, each updating frame spacing can be easily obtained by calculation of “increment period*number”.

Also, segments of a DSS selectively include one or both of disparity information in region increments or subregion increments included in the regions, and disparity information of page increments including all regions, as disparity information sequentially updated during the caption display period. Also, this DSS includes disparity information in region increments or subregion increments included in the regions, and disparity information of page increments including all regions, as fixed disparity information during the caption display period.

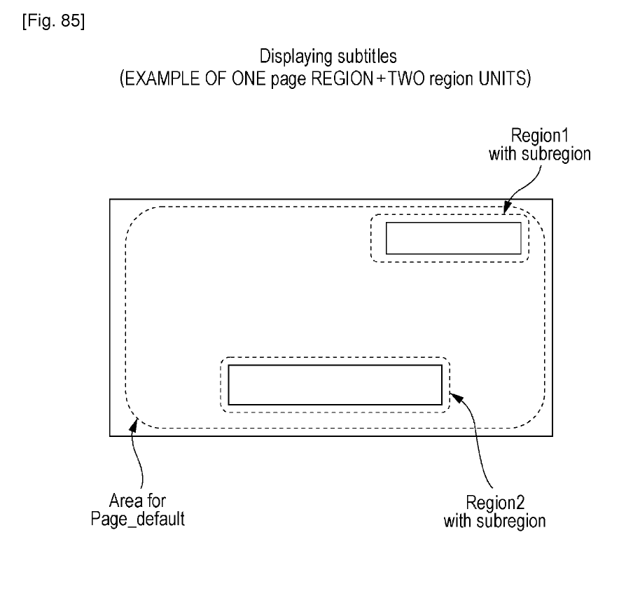

FIG. 85 illustrates a display example of subtitles as captions. With this display example, two regions (Region) are included in a page area (Area for Page_default) in the form of region 1 and region 2. One or multiple subregions are included in a region. Here, we will say that a region includes one subregion, so a region area and a subregion area are equal.

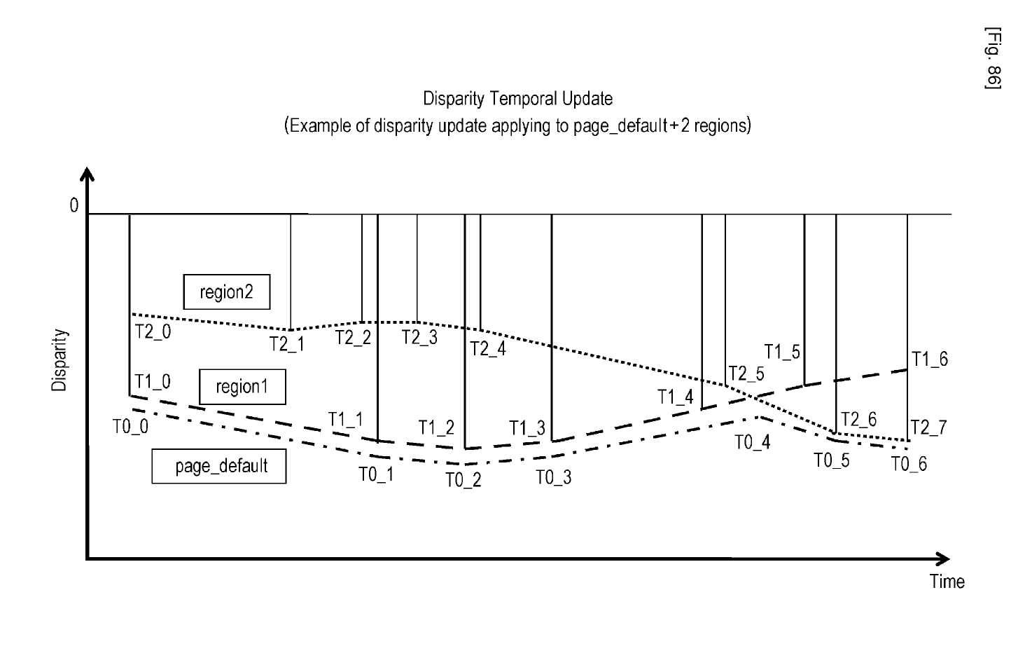

FIG. 86 illustrates an example of disparity information curves of the regions and the page, in a case where disparity information in region increments and disparity information in page increments are both included as disparity information (Disparity) sequentially updated during the caption display period. Here, the disparity information curve of the page is formed so as to take the smallest value of the disparity information curves of the two regions.

With regard to region 1 (Region1), there are seven sets of disparity information, which are the startpoint-in-time T1_0, and subsequent updating points-in-time T1_1, T1_2, T1_3, and so on through T1_6. Also, with regard to region 2 (Region2), there are eight sets of disparity information, which are the start point-in-time T2_0, and subsequent updating points-in-time T1_1, T2_2, T2_3, and so on through T2_7. Further, with regard to the page (Page_default), there are seven sets of disparity information, which are the start point-in-time T0_0, and subsequent updating points-in-time T0_1, T0_2, T0_3, and so on through T0_6.

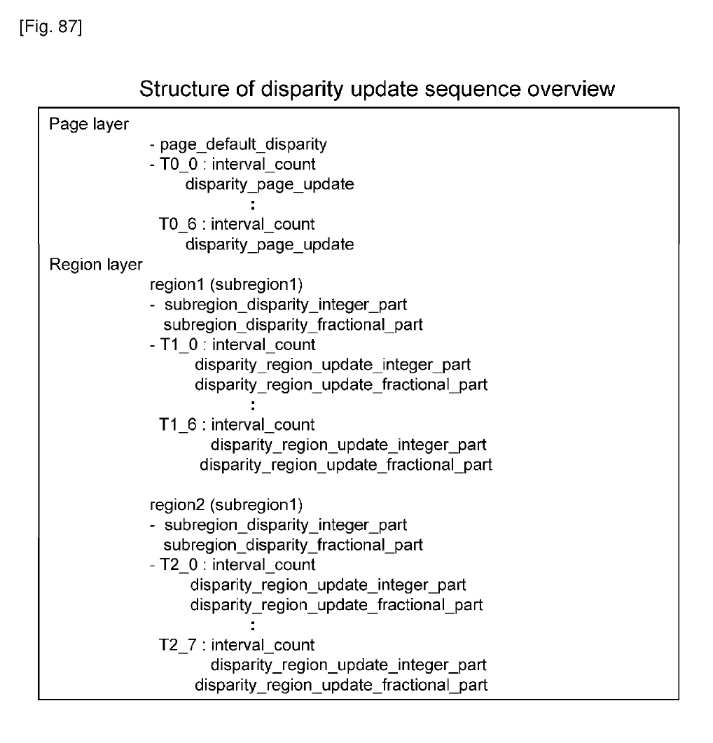

FIG. 87 illustrates what sort of structure the disparity information of the page and the regions shown in FIG. 86 is transmitted with. First, the page layer will be described. Situated in this page layer is “page_default_disparity”, which is a fixed value of disparity information. With regard to the disparity information stereoscopic image data sequentially updated during the caption display period, “interval_count” indicating the number of interval periods, and “disparity_page_update” indicating the disparity information thereof, are sequentially situated, corresponding to the start point-in-time and the subsequent points-in-time. Note that “interval_count” at the starting point-of-time is set to “0”.

Next, the region layer will be described. With regard to region 1 (subregion 1), there are disposed “subregion_disparity_integer_part” and “subregion_disparity_fractional_part” which are fixed values of disparity information. Here, “subregion_disparity_integer_part” indicates the integer portion of disparity information, and “subregion_disparity_fractional_part” indicates the fraction part of the disparity information. In this way, disparity information has not only integer parts but also fractional parts as well. That is to say, the disparity information has sub-pixel precision. Due to the disparity information having sub-pixel precision in this way, the reception side an perform suitable shift adjustment of the display positions of left eye subtitles and right eye subtitles, with sub-pixel precision.

With regard to the disparity information sequentially updated during the caption display period, the“interval_count” indicating the number of interval periods, and “disparity_region_update_integer_part” and “disparity_region_update_fractional_part” indicating the disparity information, are sequentially situated. Here, “disparity_region_update_integer_part” indicates the integer portion of disparity information, and“disparity_region_update_fractional_part” indicates the fraction part of the disparity information. Note that “interval_count” at the starting point-of-time is set to “0”.

With regard to region 2 (subregion2), this is the same as region 1 described above, and there are disposed “subregion_disparity_integer_part” and“subregion_disparity_fractional_part” which are fixed values of disparity information. With regard to the disparity information sequentially updated during the caption display period, the “interval_count” indicating the number of interval periods, and “disparity_region_update_integer_part” and “disparity_region_update_fractional_part” indicating the disparity information, are sequentially situated.

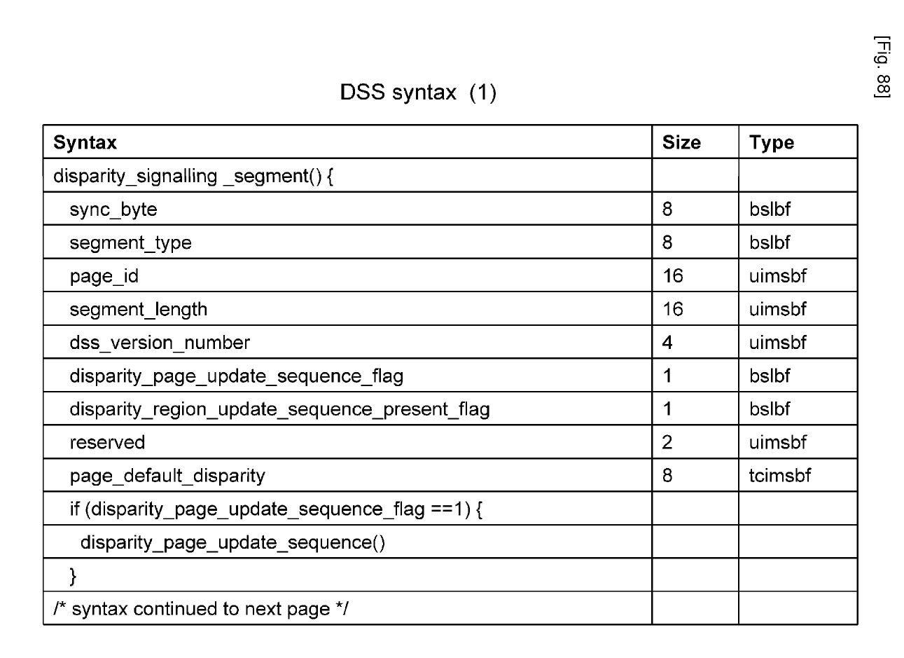

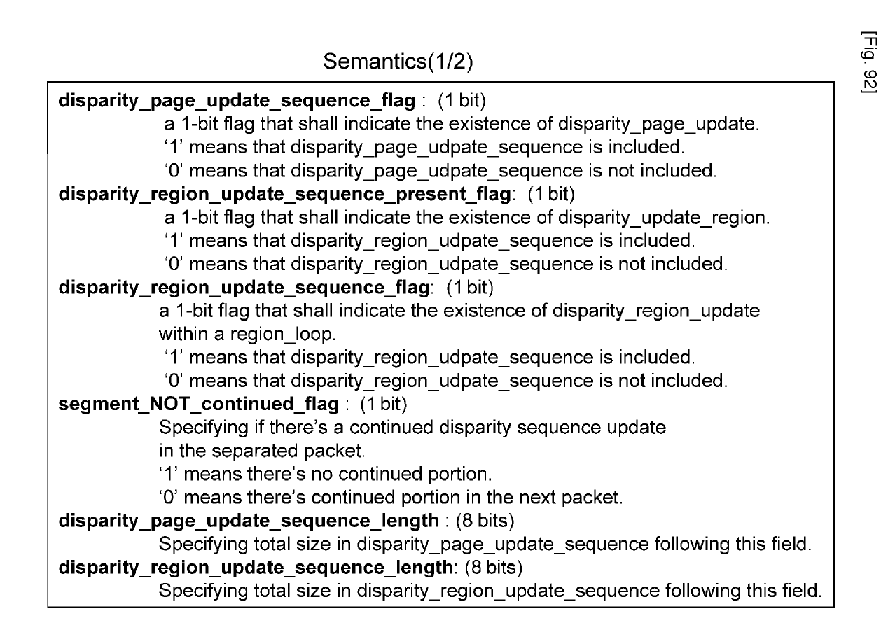

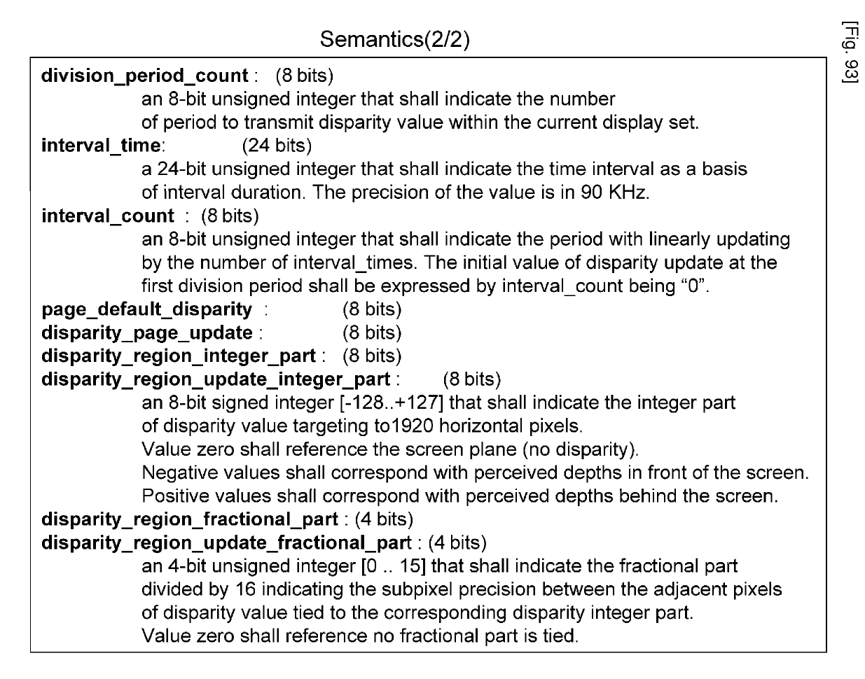

FIG. 88 through FIG. 91 illustrate a primary structure example (syntax) of a DSS (Disparity_Signaling_Segment). FIG. 92 and FIG. 93 illustrate principal data stipulations (semantics) of a DSS. This structure includes the various information of “Sync_byte”, “segment_type”, “page_id”, “segment_length”, and “dss_version_number”. “segment_type” is 8-bit data indicating the segment type, and is a value indicating a DSS here. “segment_length” is 8-bit data indicating the number of subsequent bytes.

The 1-bit flag of“disparity_page_update_sequence_flag” indicates whether or not there is disparity information sequentially updated during the caption display period as page increment disparity information. “1” indicates that there is, and “0” indicates that there is none. The 1-bit flag of “disparity_region_update_sequence_present_flag” indicates whether or not there is disparity information sequentially updated during the caption display period as region increment (subregion increment) disparity information. “1” indicates that there is, and “0” indicates that there is none. Note that the “disparity_region_update_sequence_present_flag” is outside of the while loop, and aims to facilitate comprehension of whether or not there is disparity update regarding at least one region. Whether or not to transmit the “disparity_region_update_sequence_present_flag” is left to the discretion of the transmission side.

The 8-bit field of “page_default_disparity” is page increment fixed disparity information, i.e., used in common during the caption display period. In the event that the above-described flag “disparity_page_update_sequence_flag” is “1”, the “disparity_page_update_sequence( )” is read out.

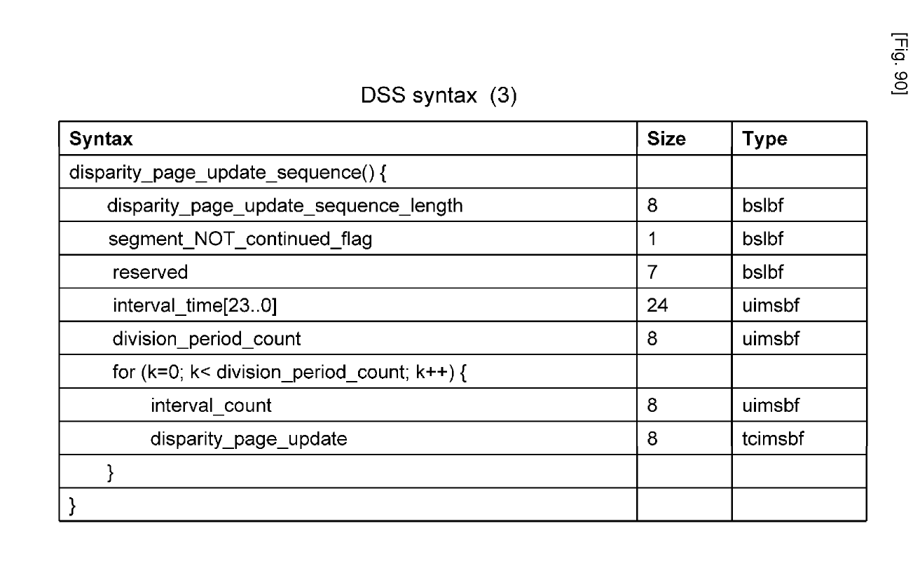

FIG. 90 illustrates a structure example (Syntax) of “disparity_page_update_sequence( )”. “disparity_page_update_sequence_length” is 8-bit data indicating the number of subsequent bytes. “segment_NOT_continued_flag” indicates whether completed within the current packet. “1” indicates being completed within the current packet. “0” indicates not being completed within the current packet, and that there is more in the following packet.

The 24-bit field “interval_time[23.0]” specifies the interval period (Interval Duration) in 90 KHz increments. That is to say, “interval_time[23.01]” represents a value where this interval period (Interval Duration) was measured with a 90-KHz clock, with a 24-bit length.

The reason why the PTS inserted in the PES header portion is 33 bits long but this is 24 bits long is as follows. That is to say, time exceeding 24 hours worth can be expressed with a 33-bit length, but this is an unnecessary length for this interval period (Interval Duration). Also, using 24 bits makes the data size smaller, enabling compact transmission. Further, 24 bits is 8*3 bits, facilitating byte alignment.

The 8-bit field of “division_period_count” indicates the number of periods for transmitting disparity information (Division Period). For example, in the case of the updating example shown in FIG. 83, this number is“7”, corresponding to the starting point-in-time T1_0 and the subsequent updating points-in-time T1_1 through T1_6. The following for loop is repeated by the number which this 8-bit field “division_period_count” indicates.

The 8-bit field of “interval_count” indicates the number of interval periods. For example, with the updating example shown in FIG. 83, M, N, P, Q, R, and S correspond. The 8-bit field of“disparity_page_update” indicates disparity information. “interval_count” is set to “0” corresponding to the disparity information at the starting point-in-time (initial value of disparity information). That is to say, in the event that “interval_count” is “0”, “disparity_page_update” indicates the disparity information at the starting point-in-time (initial value of disparity information).

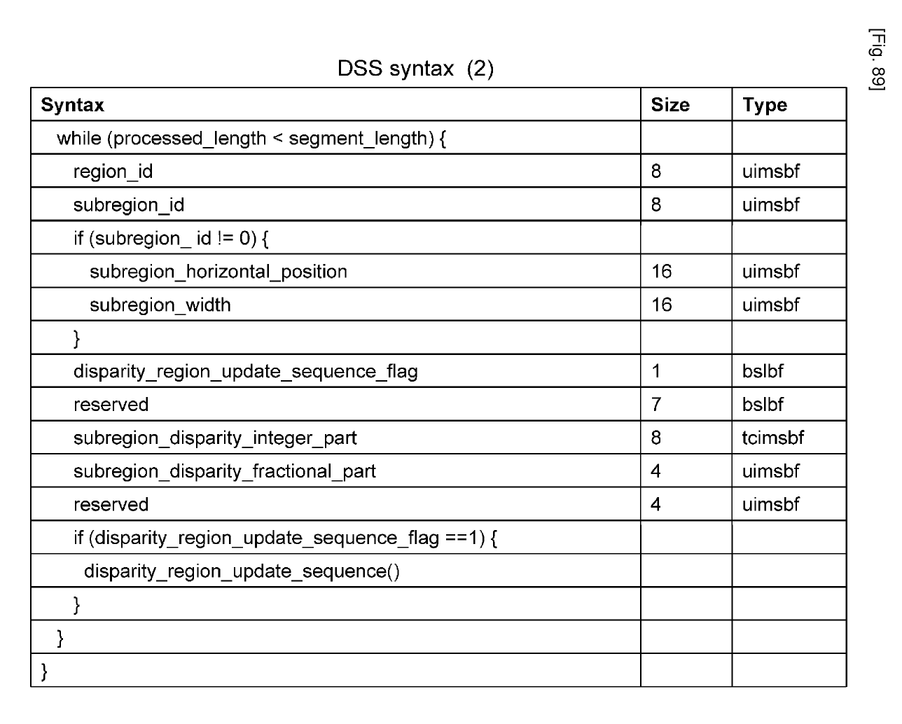

The while loop in FIG. 89 is repeated in the event that the data length processed so far (processed_length) has not yet reached the segment data length (segment_length). Disparity information in region increments or subregion increments within the region is situated in this while loop. Now, one or multiple subregions are included in a region, and there are cases where a subregion is the same as a region area.

Information of “region_id” and “subregion_id” are included in this while loop. In the event that the subregion is the same as the region area, “subregion_id” is set to “0”. Accordingly, in the event that“subregion_id” is not “0”, this while loop includes position information of “subregion_horizontal_position” which is position information and “subregion_width” which is width information, indicating the subregion area.

The 1-bit flag of“disparity_region_update_sequence_flag” indicates whether or not there is disparity information sequentially updated during the caption display period as region increment (subregion increment) disparity information. “1” indicates that there is, and “0” indicates that there is none. The 8-bit field of “subregion_disparity_integer_part” is fixed region increment (subregion increment) disparity information, i.e., used in common during the caption display period, indicating the integer portion of the disparity information. The 4-bit field of “subregion_disparity_fractional_part” is fixed region increment (subregion increment) disparity information, i.e., used in common during the caption display period, indicating the fraction portion of the disparity information.

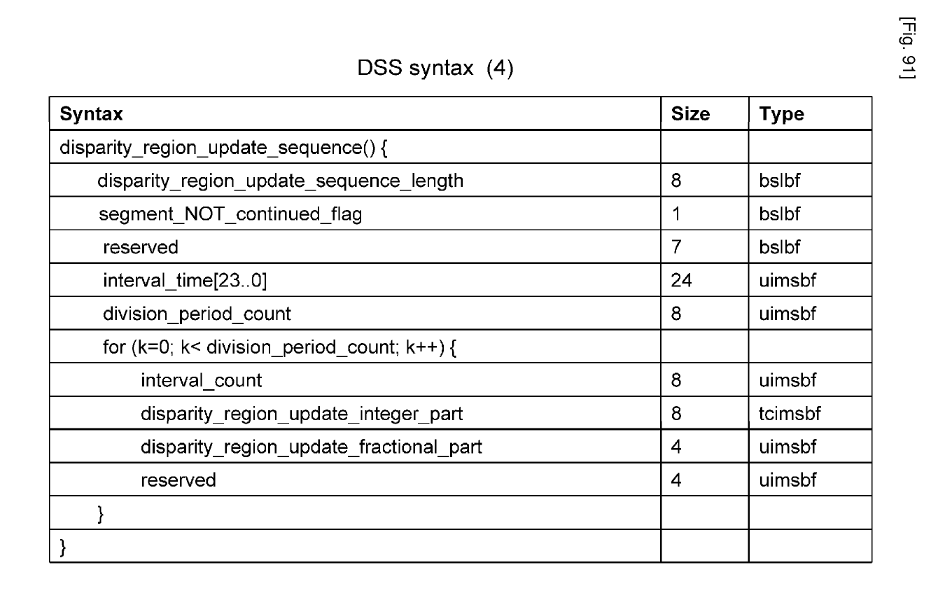

In the event that the above-described flag “disparity_region_update_sequence_flag” is“1”, the “disparity_region_update_sequence( )” is readout. FIG. 91 illustrates a structure example (Syntax) of “disparity_page_update_sequence( )”. “disparity_region_update_sequence_length” is 8-bit data indicating the number of following bytes. “segment_NOT_continued_flag” indicates whether completed within the current packet. “1” indicates being completed within the current packet. “0” indicates not being completed within the current packet, and that there is more in the following packet.

The 24-bit field “interval_time[23.0]” specifies the interval period (Interval Duration) as increment period in 90 KHz increments. That is to say, “interval_time[23.01]” represents a value where this interval period (Interval Duration) was measured with a 90-KHz clock, with a 24-bit length. The reason why this is 24 bits long is the same as with the description made regarding the structure example (Syntax) of “disparity_page_update_sequence( )” described above.

The 8-bit field of “division_period_count” indicates the number of periods for transmitting disparity information (Division Period). For example, in the case of the updating example shown in FIG. 83, this number is“7”, corresponding to the starting point-in-time T1_0 and the subsequent updating points-in-time T1_1 through T1_6. The following for loop is repeated by the number which this 8-bit field “division_period_count” indicates.

The 8-bit field of “interval_count” indicates the number of interval periods. For example, with the updating example shown in FIG. 83, M, N, P, Q, R, and S correspond. The 8-bit field of “disparity_region_update_integer_part” indicates the integer portion of the disparity information. The 4-bit field of “disparity_region_update_fractional_part” indicates the fraction portion of the disparity information. “interval_count” is set to “0” in accordance with the starting time disparity information (initial value of disparity information). That is to say, in the event that the “interval_count” is “0”, the“disparity_region_update_integer_part” and“disparity_region_update_fractional_part” indicate the starting time disparity information (initial value of disparity information).

Also, an example has been illustrated in the above description where information of the increment period (interval period) is information in which a value of the increment period measured with a 90 KHz clock is expressed with a 24-bit length. However, information of the increment period (interval period) is not restricted to this, and may be information where the increment period is expressed as a frame count number, for example.

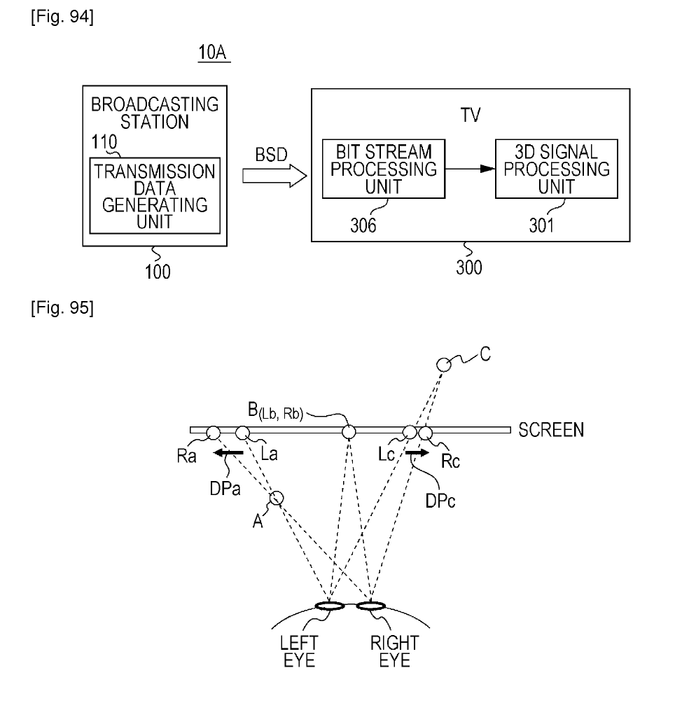

Also, with the above-described embodiment, the image transmission/reception system 10 has been illustrated as being configured of a broadcasting station 100, set to box 200, and television receiver 300. However, the television receiver 300 has a bit stream processing unit 306 functioning in the same way as the bit stream processing unit 201 (201A, 201B) within the set top box. Accordingly, an image transmission/reception system 10A configured of the broadcasting station 100 and television receiver 300 is also conceivable, as shown in FIG. 94.

Also, with the above-described embodiment, an example has been illustrated where a data stream including stereoscopic image data (bit stream data) is broadcast from the broadcasting station 100. However, this invention can be similarly applied to a system of a configuration where the data stream is transmitted to a reception terminal using a network such as the Internet or the like.

Also, with the above-described embodiment, an example has been illustrated where the set top box 200 and television receiver 300 are connected by an HDMI digital interface. However, the present invention can be similarly applied to a case where these are connected by a digital interface similar to an HDMI digital interface (including, in addition to cable connection, wireless connection).

Also, with the above-described embodiment, an example has been illustrated where subtitles (captions) are handled as superimposed information. However, the present invention can be similarly applied to arrangements where graphics information, text information, and so forth, are also handled.

It is a primary feature of present art to transmit a disparity information value of the first frame in a caption display period, and a disparity information value at a predetermined timing for each subsequent updating frame spacing (Division Period), thereby enabling reduction in the amount of transmitted data for disparity information. Another feature is enabling spacing of predetermined timing to be appropriately set to spacing according to a disparity information curve rather than fixed, by expressing each updating frame spacing with a multiple of an interval period (Interval Duration) serving as an increment period (see FIG. 83).

### INDUSTRIAL APPLICABILITY

This invention is applicable to an image transmission/reception system capable of displaying superimposed information such as subtitles (captions) on a stereoscopic image.

### REFERENCE SIGNS LIST

10, 10A image transmission/reception system
100 broadcasting station
110, 110A, 110B transmission data generating unit
111, 121, 131 data extracting unit
112, 122, 132 video encoder
132a stream formatter
113, 123, 133 audio decoder
114 subtitle generating unit
115, 125, 135 disparity information creating unit
116 subtitle processing unit
117 display control information generating unit
118 subtitle encoder
119, 127, 136 multiplexer
124 caption generating unit
126 caption encoder
134 CC encoder
126 multiplexer
200 set top box (STB)
201, 201A, 201B bit stream processing unit
202 HDMI terminal
203 antenna terminal
204 digital tuner
205 video signal processing circuit
206 HDMI transmission unit
207 audio signal processing unit
211 CPU
215 remote control reception unit
216 remote control transmission unit
221, 231, 241 demultiplexer
222, 232, 242 video decoder
223 subtitle decoder
224 stereoscopic image subtitle generating unit
225 display control unit
226 display control information obtaining unit
227, 236, 246 disparity information processing unit
228, 237, 247 video superimposing unit
229, 238, 248 audio decoder
233 caption decoder
234 stereoscopic image caption generating unit
235, 245 disparity information extracting unit
243 CC decoder
244 stereoscopic image CC generating unit
300 television receiver (TV)
301 3D signal processing unit
302 HDMI terminal
303 HDMI receiver
304 antenna terminal
305 digital tuner
306 bit stream processing unit
307 video graphics processing circuit
308 panel driving circuit
309 display panel
310 audio signal processing circuit
311 audio amplifying circuit
312 speaker
321 CPU
325 remote control reception unit
326 remote control transmission unit
400 HDMI cable

1. An image data transmission device comprising:
an image data output unit configured to output left eye image data and right eye image data;
a superimposing information data output unit configured to output data of superimposing information to be superimposed on said left eye image data and said right eye image data;
a disparity information output unit configured to output disparity information to be added to said superimposing information; and
a data transmission unit configured to transmit said left eye image data, said right eye image data, said superimposing information data, and said disparity information;
said image data transmission device further including a disparity information updating unit configured to update said disparity information, based on a disparity information initial value of a first frame where said superimposing information is displayed, and a disparity information value at a predetermined timing where an interval period has been-multiplied by a multiple value.

2. The image data transmission device according to claim 1, further comprising an adjusting unit configured to change the predetermined timing where an interval period has been multiplied by a multiple value.

3. The image data transmission device according to claim 1, wherein flag information indicating whether or not there is updating of said disparity information is added to said disparity information, with regard to each frame corresponding to the predetermined timing where an interval period has been multiplied by a multiple value.

4. The image data transmission device according to claim 1, wherein said disparity information has added thereto information of unit periods for calculating the predetermined timing where an interval period has been multiplied by a multiple value, and information of the number of said unit periods.

5. The image data transmission device according to claim 1, wherein said information of increment periods is information in which a value obtained by measuring said increment period with a 90 KHz clock is expressed in 24-bit length, or information where said increment period is expressed as a frame count number.

6. The image data transmission device according to claim 1, wherein said disparity information is disparity information corresponding to particular superimposing information displayed in the same screen, and/or disparity information corresponding in common to a plurality of superimposing information displayed in the same screen.

7. The image data transmission device according to claim 1, wherein said disparity information has sub-pixel precision.

8. The image data transmission device according to claim 1, wherein said disparity information includes multiple regions spatially independent.

9. The image data transmission device according to claim 1, wherein said disparity information has added thereto information for specifying frame cycle.

10. The image data transmission device according to claim 1, wherein said disparity information has added thereto information indicating a level of correspondence as to said disparity information, which is essential at the time of displaying said superimposing information.

11. The image data transmission device according to claim 1, wherein said data transmission unit transmits disparity information to be added to said superimposing information in the display period of said superimposing information, before said display period starts.

12. The image data transmission device according to claim 1, wherein said data of superimposing information is DVB format subtitle data;
and wherein said data transmission unit performs transmission of said disparity information included in a subtitle data stream in which said subtitle data is included.

13. The stereoscopic image data transmission device according to claim 12, wherein said disparity information is disparity information in increments of regions or increments of subregions included in said regions.

14. The image data transmission device according to claim 12, wherein said disparity information is disparity information in increments of pages including all regions.

15. The image data transmission device according to claim 1, wherein said data of superimposing information is ARIB format caption data;
and wherein said data transmission unit performs transmission with said disparity information included in a caption data stream in which said caption data is included.

16. The image data transmission device according to claim 1, wherein said data of superimposing information is CEA format closed caption data; and wherein said data transmission unit performs transmission with said disparity information included in a user data area of a video data stream in which said closed caption data is included.

17. The image data transmission device according to claim 16, wherein said data of superimposing information is inserted in an extended command based on a CEA table situated in said user data area.

18. The image data transmission device according to claim 16, wherein said data of superimposing information is inserted in said closed caption data situated in said user data area.

19. An image data transmission method comprising:
an image data output step to output left eye image data and right eye image data;
a superimposing information data output step to output data of superimposing information to be superimposed on said left eye image data and said right eye image data;
a disparity information output step to output disparity information to be added to said superimposing information; and
a data transmission step to transmit said left eye image data, said right eye image data, said superimposing information data, and said disparity information;
said method further including a disparity information updating step to update said disparity information, based on a disparity information initial value of a first frame where said superimposing information is displayed, and a disparity information value at a predetermined timing where an interval period has been multiplied by a multiple value.

20. An image data reception device comprising:
a data reception unit configured to receive left eye image data and right eye image data, superimposing information data to be superimposed on said left eye image data and said right eye image data, and disparity information to be added to said superimposing information,
said disparity information being updated based on a disparity information initial value of a first frame where said superimposing information is displayed, and a disparity information value at a predetermined timing where an interval period has been multiplied by a multiple value; and further including
an image data processing unit configured to obtain left eye image data upon which said superimposing information has been superimposed and right eye image data upon which said superimposing information has been superimposed, based on said left eye image data, said right eye image data, said superimposing information data, and said disparity information.

21. The image data reception device according to claim 20, wherein said image data processing unit subjects disparity information to interpolation processing, and generates and uses disparity information of an arbitrary frame spacing.

22. The image data reception device according to claim 21, wherein said interpolation processing involves low-bandfilter processing in the temporal direction.

23. The image data reception device according to claim 20, wherein said disparity information has added thereto information of increment periods to calculate a predetermined timing where an interval period has been multiplied by a multiple value and the number of said increment periods;
and wherein said image data processing unit obtains said predetermined timing based on said information of increment periods and information of said number, with a display startpoint-in-time of said superimposing information as a reference.

24. The stereoscopic image data reception device according to claim 23, wherein said display start point-in-time of said superimposing information is provided as a PTS (Presentation Time Stamp) inserted in a header portion of a PES stream including said disparity information.

25. An image data reception method comprising:
a data reception step to receive left eye image data and right eye image data, superimposing information data to be superimposed on said left eye image data and said right eye image data, and disparity information to be added to said superimposing information,
said disparity information being updated based on a disparity information initial value of a first frame where said superimposing information is displayed, and a disparity information value at a predetermined timing where an interval period has been multiplied by a multiple value; and further including
an image data processing step to obtain left eye image data upon which said superimposing information has been superimposed and right eye image data upon which said superimposing information has been superimposed, based on said left eye image data, said right eye image data, said superimposing information data, and said disparity information.
